(19) United States
(12) Patent Application Publication
(10) Pub. No.: US 2021/0346888 A1
(43) Pub. Date: Nov. 11, 2021

(54) Monodispersed Particle-Triggered Droplet Formation from Stable Jets

(71) Applicant: The Regents of the University of California, Oakland, CA (US)

(72) Inventors: Adam R. Abate, Daly City, CA (US); Iain Clark, San Francisco, CA (US)

(21) Appl. No.: 17/266,911

(22) PCT Filed: Aug. 15, 2019
(86) PCT No.: PCT/US2019/046632

§ 371 Date: Feb. 8, 2021

Related U.S. Application Data
(60) Provisional application No. 62/719,569, filed on Aug. 17, 2018.

(51) Int. Cl. B01L 3/00; B01F 13/00; B01F 3/08

(52) U.S. Cl. CPC B01L 3/502761; B01F 13/0062; B01F 3/0811; B01F 2003/0846; B01L 2300/12; B01F 2003/0842; B01L 2200/0652

(57) ABSTRACT

The methods described herein provide an improved approach for generating monodispersed droplets. Monodispersed droplets may be effectively obtained by using a plurality of particles to trigger the breakup of a jet, which can include, e.g., flowing in a channel of a microfluidic device a first fluid into a second fluid under stable jetting conditions to provide a jet of the first fluid in the second fluid, wherein the first fluid is immiscible with the second fluid; and introducing a plurality of particles into the jet of the first fluid triggering break-up of the jet of the first fluid and encapsulation of the plurality of particles in a plurality of monodispersed droplets of the first fluid in the second fluid.

### CROSS-REFERENCE TO RELATED APPLICATIONS

This application claims the benefit of U.S. Provisional Patent Application Ser. No. 62/719,569 filed Aug. 17, 2018; the disclosure of which application is herein incorporated by reference.

### STATEMENT REGARDING FEDERALLY SPONSORED RESEARCH

This invention was made with government support under grant no. R21 AI116218 awarded by the National Institutes of Health. The government has certain rights in the invention.

### INTRODUCTION

Particles, e.g., beads, are widely used in both commercial and academic droplet workflows because useful mechanical and chemical properties can be produced or purchased, enabling the chemical and enzymatic coupling of oligonucleotides, proteins, and antibodies. Droplet microfluidics leverages this concept for single-molecule or single-cell analysis, e.g., by pairing particles and targets in water-in-oil droplets. However, pairing is usually achieved with devices operating in the dripping regime with limiting throughput. Such workflows are subject to an upper limit on throughput, governed by the Capillary number (Ca) dependent transition from dripping to jetting. The present disclosure addresses the above issues and provides related advantages.

### SUMMARY

The methods and systems described herein provide an improved approach for generating monodispersed droplets by triggering break up of a stable jet using particles. Monodispersed droplets may be effectively obtained by using a plurality of particles to trigger the breakup of a jet, which can include, e.g., flowing in a channel of a microfluidic device a first fluid into a second fluid under stable jetting conditions to provide a jet of the first fluid in the second fluid, wherein the first fluid is immiscible with the second fluid; and introducing a plurality of particles into the jet of the first fluid triggering break-up of the jet of the first fluid and encapsulation of the plurality of particles in a plurality of monodispersed droplets of the first fluid in the second fluid.

Thus, in some embodiments, the present disclosure provides a method for generating monodispersed droplets, including flowing in a channel of a microfluidic device a first fluid into a second fluid under stable jetting conditions to provide a jet of the first fluid in the second fluid, wherein the first fluid is immiscible with the second fluid; and introducing a plurality of particles into the jet of the first fluid triggering break-up of the jet of the first fluid and encapsulation of the plurality of particles in a plurality of monodispersed droplets of the first fluid in the second fluid.

In some embodiments, the plurality of particles is introduced into the jet of the first fluid in an ordered configuration, triggering an ordered breakup of the jet and generation of a monodispersed emulsion, including monodispersed particle-containing droplets. In other embodiments the plurality of particles is introduced into the jet of the first fluid in a disordered configuration, triggering a disordered breakup of the jet and generation of a polydispersed emulsion containing a population of mono-disperse particle containing droplets, which can then be separated for further applications.

The present disclosure also provides a system for generating monodispersed droplets, including: a microfluidic device including a first channel, a second channel, a third channel and a fourth channel, wherein a first fluid is flowed from the first channel into the second channel through a junction of the first, second, third, and fourth channels, into a second fluid under stable jetting conditions to provide a jet of the first fluid in the second fluid, wherein the first fluid is immiscible with the second fluid, wherein the second fluid is introduced into the junction via the third and fourth channels, and wherein a plurality of particles is introduced into the jet of the first fluid thereby triggering break-up of the jet of the first fluid and encapsulation of the plurality of particles in a plurality of monodispersed droplets of the first fluid in the second fluid.

The present disclosure also provides a method for merging reagents with particle-containing droplets, including: flowing in a channel of a microfluidic device a first fluid into a second fluid under stable jetting conditions to provide a jet of the first fluid in the second fluid, wherein the first fluid is immiscible with the second fluid and comprises one or more reagents; merging a plurality of particle-containing droplets into the jet of the first fluid triggering break-up of the jet of the first fluid and encapsulation of the plurality of particles in a plurality of merged monodispersed particle-containing droplets of the first fluid in the second fluid.

The disclosed methods and systems may be utilized for a variety of applications and droplet workflows, including applications in which high-frequency droplet generation is desired, particle coating applications, high throughput cell analysis applications, and workflows utilizing reagent merger steps.

In some embodiments, a microfluidic system including an on-chip nucleic acid amplification region and a detection region may be used in connection with the processing/incubation and analysis of monodispersed droplets prepared as described herein. In some embodiments, the nucleic acid amplification region may include a thermal cycler. In some embodiments, the system includes a detection region, which detects the presence or absence of reaction products from the nucleic acid amplification region, and which may be fluidically connected to the nucleic acid amplification region. In some embodiments, the system includes means for adding a first reagent to a monodispersed droplet, and/or a heating element. In some embodiments, the system includes a sorting region or a combination detection/sorting region fluidically connected to the nucleic acid amplification region. In some embodiments, alternatively or in addition to an “on-chip” sorting region, sorting of the monodispersed droplets may occur “off-chip”.

### BRIEF DESCRIPTION OF THE DRAWINGS

The invention may be best understood from the following detailed description when read in conjunction with the accompanying drawings. Included in the drawings are the following figures:

FIGS. 1A-1E provide schematics showing droplet generation in the dripping and jetting flow regimes using particle-triggering according to embodiments of the present disclosure. FIG. 1A depicts drop formation in the dripping regime without particles. FIG. 1B depicts stable jet formation at a high Capillary number (Ca) without particles. FIG. 1C depicts drop formation using unpacked particles, e.g., rigid particles, at limiting dilution to trigger breakup of the dispersed phase. FIG. 1D depicts drop formation using packed particles, e.g., packed elastic particles, to trigger breakup without additional co-flow. FIG. 1E depicts drop formation using packed particles, e.g., packed elastic particles, to trigger breakup of a co-flowed dispersed phase.

FIGS. 2A-2E depict an embodiment of the schematics in FIGS. 1A-1E showing droplet generation in the dripping and jetting flow regimes using bead-triggering. FIG. 2A depicts drop formation in the dripping regime without beads. FIG. 2B depicts stable jet formation at a high Capillary number (Ca) without beads. FIG. 2C depicts drop formation using unpacked beads, e.g., rigid beads, at limiting dilution to trigger breakup of the dispersed phase. FIG. 2D depicts drop formation using packed beads, e.g., packed elastic beads, to trigger breakup without additional co-flow. FIG. 2E depicts drop formation using packed beads, e.g., packed elastic beads, to trigger breakup of a co-flowed dispersed phase.

FIGS. 3A-3D depict an embodiment of the workflow depicted in FIGS. 2A-2E, where a stable jet breakup is depicted using unpacked rigid particles. FIG. 3A depicts frames from a video of device operation showing stable jet formation and particle-induced jet breakup. FIG. 3B is a schematic showing of the experimental setup used to measure drop size and the presence of particle containing drops. FIG. 3C depicts droplet cytometry analysis of drop formation. FIG. 3D depicts a histogram of drop size.

FIG. 4A-4C provide schematics and images of particle-dependent drop formation in the jetting regime with an aqueous co-flow according to embodiments of the present disclosure. FIG. 4A is a schematic showing the device with fluid inlets and outlets. FIG. 4B depicts the device operation in the dripping and jetting regimes with and without particles. FIG. 4C depicts frames from a video of device operation in the dripping and jetting regimes.

FIGS. 5A-5B provide graphs and images of particle-dependent drop formation in the jetting regime without an aqueous co-flow according to embodiments of the present disclosure. FIG. 5A shows microscope images of single-particle and multi-particle containing drops and FIG. 5B shows phase diagrams of the transition from single- to multi-particle drops as a function of Ca and flow rate ratio.

FIGS. 6A-6D show pairing cells with particles at 23 kHz. FIG. 6A depicts operation of a microfluidic device according to embodiments of the present disclosure and resultant droplets in the outlet. Dropmaking frequency is calculated in FIG. 6B. FIG. 6C depicts fluorescence microscopy of FAM-stained particles and Calcein Red cells. FIG. 6D depicts the high throughput analysis of millions of particle-containing droplets and hundreds of thousands of particle-cell pairings using a droplet cytometer.

FIG. 7 provides images showing high speed bead coating using bead-triggering.

### DETAILED DESCRIPTION

The methods described herein provide an improved approach for generating monodispersed droplets. Monodispersed droplets may be effectively obtained by using a plurality of particles to trigger the breakup of a jet, which can include, e.g., flowing in a channel of a microfluidic device a first fluid into a second fluid under stable jetting conditions to provide a jet of the first fluid in the second fluid, wherein the first fluid is immiscible with the second fluid; and introducing a plurality of particles into the jet of the first fluid triggering break-up of the jet of the first fluid and encapsulation of the plurality of particles in a plurality of monodispersed droplets of the first fluid in the second fluid.

The disclosed methods facilitate the pairing of particles to targets, e.g., cells, nucleic acids, etc., which can then be detected, quantitated and/or sorted, e.g., based on their sequence as detected with nucleic acid amplification techniques, e.g., RT-PCR, PCR and/or MDA.

Before the present invention is further described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and exemplary methods and materials are now described. Any and all publications mentioned herein are incorporated herein by reference to disclose and describe the methods and/or materials in connection with which the publications are cited. It is understood that the present disclosure supersedes any disclosure of an incorporated publication to the extent there is a contradiction.

It must be noted that as used herein and in the appended claims, the singular forms “a,” “an,” and “the” include plural referents unless the context clearly dictates otherwise. Thus, for example, reference to “a droplet” includes a plurality of such droplets and reference to “the particle” includes reference to one or more particles and equivalents thereof known to those skilled in the art, and so forth.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Further, the dates of publication provided may be different from the actual publication dates which may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible. For example, described herein are a variety of additional methods and applications, which may be performed in connection with the methods described herein relating to the generation of monodispersed droplets. In this regard it is considered that any of the non-limiting aspects of the disclosure numbered 1-98 herein may be modified as appropriate with one or more steps of such methods and applications, and/or that such methods and applications may utilize monodispersed droplets prepared according to one or more of the non-limiting aspects of the disclosure numbered 1-98herein. Such methods and applications include, without limitation, those described in the sections herein, entitled: Methods; Particles; Monodispersed Droplets and Generation Thereof; Double Emulsions; Stable Jetting Conditions; Fluids Involved in the Generation of Monodispersed Droplets; Surfactants; Adding Reagents to Monodispersed Droplets, Tethering Moieties; Reactions in Monodispersed Droplets; Detecting PCR Products; Detecting Cells (e.g., Tumor Cells) in Monodispersed Droplets; Nucleic Acid Detection in Monodispersed Droplets; Multiple Displacement Amplification; PCR; Double PCR; Digital PCR; RNA sequencing (RNAseq); Measuring Lengths of Nucleic Acids; Microfluidic Enrichment for Sequence Analysis (MESA) in Monodispersed Droplets; PCR Activated Cell Sorting (PACS) in Monodispersed Droplets; Live-cell PCR Activated Cell Sorting (PACS); Mass Spectrometry Activated Cell Sorting (MS-ACS); Colony Growth and Lysis; Multiplexing; Digital Enzyme-linked Immunosorbent Assay (ELISA); Digital Oligo-linked Immunosorbent Assay (dOLISA); Sorting; Suitable Subjects and/or Samples; Detecting Proteins or DNA with Enzyme-Linked Probes; Detecting Cancer; and Systems.

Methods

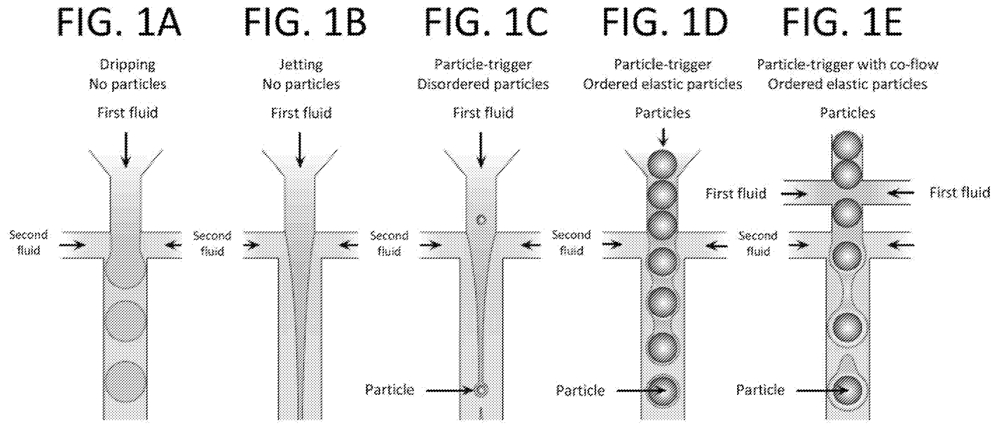

As summarized above, the present disclosure provides an improved method for generating monodispersed droplets, e.g., to facilitate a variety of droplet-based work-flows. The disclosed methods facilitate the pairing of particles to and optionally the subsequent analysis of a variety of targets of interest, e.g., cells, nucleic acids, etc., with the use of a microfluidic device. In particular, the disclosed methods involve flowing in a channel of a microfluidic device a first fluid into a second fluid under stable jetting conditions to provide a jet of the first fluid in the second fluid, wherein the first fluid is immiscible with the second fluid; and introducing a plurality of particles into the jet of the first fluid triggering break-up of the jet of the first fluid and encapsulation of the plurality of particles in a plurality of monodispersed droplets of the first fluid in the second fluid. Exemplary embodiments are depicted in FIGS. 1D, 1E, 2D, 2E, 4A and 4B.

As used herein, the terms “drop” and “droplet” are used interchangeably to refer to tiny, generally spherical, microcompartments containing at least a first fluid, e.g., an aqueous phase (e.g., water), bounded by a second fluid (e.g., oil) which is immiscible with the first fluid. Droplets can also be formed in aqueous two-phase systems (ATPS), wherein two aqueous phases are utilized. Droplets generally range from about 0.1 to about 1000 μm in diameter or largest dimension, and may be used to encapsulate cells, DNA, enzymes, and other components. In some embodiments, droplets have a diameter or largest dimension of about 1.0 μm to 1000 μm, inclusive, such as about 1.0 μm to about 750 μm, about 1.0 μm to about 500 μm, about 1.0 μm to about 250 μm, about 1.0 μm to about 200 μm, about 1.0 μm to about 150 μm, about 1.0 μm to about 100 μm, about 1.0 μm to about 10 μm, or about 1.0 μm to about 5 μm, inclusive. In some embodiments, droplets have a diameter or largest dimension of about 10 μm to about 200 μm, e.g., about 10 μm to about 150 μm, about 10 μm to about 125 μm, or about 10 μm to about 100 μm.

The droplets, themselves may vary, including in size, composition, contents, and the like. Monodispersed droplets may generally have an internal volume of from about 0.001 to about 10,000 picoliters or more, e.g., from about 0.001 picoliters to about 0.01 picoliters, from about 0.01 picoliters to about 0.1 picoliters, from about 0.1 picoliters to about 1 picoliter, from about 1 picoliter to about 10 picoliters, from about 10 picoliters to about 100 picoliters, from about 100 picoliters to about 1000 picoliters, or from about 1000 picoliters to about 10,000 picoliters or more. Further, droplets may or may not be stabilized by surfactants and/or particles.

As used herein, the term “biological sample” encompasses a variety of sample types obtained from a variety of sources, which sample types contain biological material. For example, the term includes biological samples obtained from a mammalian subject, e.g., a human subject, and biological samples obtained from a food, water, or other environmental source, etc. The definition encompasses blood and other liquid samples of biological origin, as well as solid tissue samples such as a biopsy specimen or tissue cultures or cells derived therefrom and the progeny thereof. The definition also includes samples that have been manipulated in any way after their procurement, such as by treatment with reagents, solubilization, or enrichment for certain components, such as polynucleotides. The term “biological sample” encompasses a clinical sample, and also includes cells in culture, cell supernatants, cell lysates, cells, serum, plasma, biological fluid, and tissue samples. “Biological sample” includes cells, e.g., bacterial cells or eukaryotic cells; biological fluids such as blood, cerebrospinal fluid, semen, saliva, and the like; bile; bone marrow; skin (e.g., skin biopsy); and antibodies obtained from an individual.

As described more fully herein, in various aspects the subject methods may be used to detect a variety of components from such biological samples. Components of interest include, but are not necessarily limited to, cells (e.g., circulating cells and/or circulating tumor cells), viruses, polynucleotides (e.g., DNA and/or RNA), polypeptides (e.g., peptides and/or proteins), and many other components that may be present in a biological sample.

“Polynucleotides” or “oligonucleotides” as used herein refer to linear polymers of nucleotide monomers, and may be used interchangeably. Polynucleotides and oligonucleotides can have any of a variety of structural configurations, e.g., be single stranded, double stranded, or a combination of both, as well as having higher order intra- or intermolecular secondary/tertiary structures, e.g., hairpins, loops, triple stranded regions, etc. Polynucleotides typically range in size from a few monomeric units, e.g. 5-40, when they are usually referred to as “oligonucleotides,” to several thousand monomeric units. Whenever a polynucleotide or oligonucleotide is represented by a sequence of letters (upper or lower case), such as “ATGCCTG,” it will be understood that the nucleotides are in 5′→3′ order from left to right and that “A” denotes deoxyadenosine, “C” denotes deoxycytidine, “G” denotes deoxyguanosine, and “T” denotes thymidine, “I” denotes deoxyinosine, “U” denotes uridine, unless otherwise indicated or obvious from context. Unless otherwise noted the terminology and atom numbering conventions will follow those disclosed in Strachan and Read, Human Molecular Genetics 2 (Wiley-Liss, New York, 1999).

The terms “polypeptide,” “peptide,” and “protein,” used interchangeably herein, refer to a polymeric form of amino acids of any length. NH₂ refers to the free amino group present at the amino terminus of a polypeptide. COOH refers to the free carboxyl group present at the carboxyl terminus of a polypeptide. In keeping with standard polypeptide nomenclature, J. Biol. Chem., 243 (1969), 3552-3559 is used.

As described herein, the term “next-generation sequencing” generally refers to advancements over standard DNA sequencing (e.g., Sanger sequencing). Although standard DNA sequencing enables the practitioner to determine the precise order of nucleotides in the DNA sequence, next-generation sequencing also provides parallel sequencing, during which millions of base pair fragments of DNA can be sequenced in unison. Standard DNA sequencing generally requires a single-stranded DNA template molecule, a DNA primer, and a DNA polymerase in order to amplify the DNA template molecule. Next-generation sequencing facilitates high-throughput sequencing, which allows for an entire genome to be sequenced in a significantly shorter period of time relative to standard DNA sequencing. Next-generation sequencing may also facilitate in identification of disease-causing mutations for diagnosis of pathological conditions. Next-generation sequencing may also provide information on the entire transcriptome of a sample in a single analysis without requiring prior knowledge of the genetic sequence.

Any suitable non-specific nucleic acid amplification methods and reagents, e.g., MDA methods and reagents, may be utilized in connection with the disclosed methods provided that such methods and reagents are compatible with any additional, e.g., subsequent, amplification steps and or reagents of the method, e.g., PCR amplification steps and reagents. An example of a suitable MDA polymerase, which may be used in combination with a Taq DNA polymerase is a Bst polymerase. Bst polymerase may have advantages over other MDA polymerases, such as phi29 polymerase, since Bst polymerase is efficient over a wider temperature range and is active under similar buffer conditions to Taq DNA polymerase.

In practicing the subject methods, a wide range of different PCR-based assays may be employed, such as quantitative PCR (qPCR) and digital droplet PCR. The number and nature of primers used in such assays may vary, based at least in part on the type of assay being performed, the nature of the biological sample, and/or other factors. In certain aspects, the number of primers that may be added to a monodispersed droplet, e.g., a monodispersed single-emulsion droplet, a multiple-emulsion droplet, or a Giant Unilamellar Vesicle GUV may be 1 to 100 or more, and/or may include primers to detect from about 1 to 100 or more different genes (e.g., oncogenes). In addition to, or instead of, such primers, one or more probes (e.g., TaqMan® probes) may be employed in practicing the subject methods.

In certain aspects, methods are provided for counting and/or genotyping cells, including normal cells or tumor cells, such as circulating tumor cells (CTCs). A feature of such methods is the use of microfluidics.

Following the generation of the monodispersed droplets, such droplets may be subject to any of a variety of suitable work-flows, techniques and/or reactions as described herein or as otherwise known in the art in connection with droplet-based analysis of targets such as cells, virus, and components thereof, such as nucleic acids, e.g., DNA and RNA. Additional droplet-based analysis methods, which may be used in connection with monodispersed droplets prepared according to the methods as described herein, may be found for example in the following publications, which are incorporated by reference herein: U.S. Patent Application Publication No. 2015/0232942, U.S. Patent Application Publication No. 2017/0121756, U.S. Patent Application Publication No. 2017/0022538, U.S. Patent Application Publication No. 2017/0009274, U.S. patent application Ser. No. 15/753,132.

A feature of certain methods as described herein is the use of a polymerase chain reaction (PCR)-based assay to detect the presence of certain oligonucleotides and/or genes, e.g., oncogene(s) present in cells. Examples of PCR-based assays of interest include, but are not limited to, quantitative PCR (qPCR), quantitative fluorescent PCR (QF-PCR), multiplex fluorescent PCR (MF-PCR), digital droplet PCR (ddPCR) single cell PCR, PCR-RFLP/real time-PCR-RFLP, hot start PCR, nested PCR, in situ polony PCR, in situ rolling circle amplification (RCA), bridge PCR, picotiter PCR, emulsion PCR and reverse transcriptase PCR (RT-PCR). Other suitable amplification methods include the ligase chain reaction (LCR), transcription amplification, self-sustained sequence replication, selective amplification of target polynucleotide sequences, consensus sequence primed polymerase chain reaction (CP-PCR), arbitrarily primed polymerase chain reaction (AP-PCR), degenerate oligonucleotide-primed PCR (DOP-PCR) and nucleic acid based sequence amplification (NABSA).

A PCR-based assay may be used to detect the presence of certain gene(s), such as certain oncogene(s). In such assays, one or more primers specific to each gene of interest are reacted with the genome of each cell. These primers have sequences specific to the particular gene, so that they will only hybridize and initiate PCR when they are complementary to the genome of the cell. If the gene of interest is present and the primer is a match, many copies of the gene are created. To determine whether a particular gene is present, the PCR products may be detected through an assay probing the liquid of the monodispersed droplet, such as by staining the solution with an intercalating dye, like SybrGreen or ethidium bromide, hybridizing the PCR products to a solid substrate, such as a particle, e.g., a bead, (e.g., magnetic or fluorescent beads, such as Luminex beads), or detecting them through an intermolecular reaction, such as FRET. These dyes, beads, and the like are each examples of a “detection component,” a term that is used broadly and generically herein to refer to any component that is used to detect the presence or absence of nucleic acid amplification products, e.g., PCR products.

A number of variations of these basic approaches, and components of the disclosed methods and systems, will now be outlined in greater detail below.

### Particles

As used herein, the term “particles” and “particle” are used interchangeably to refer to structures, which in the context of the disclosed methods, are capable of triggering breakup of a stable jet to form droplets containing the structures. In any suitable embodiment herein, the particles may be beads. Particles may be porous or nonporous. In any suitable embodiment herein, particles may include microcompartments, which may contain additional components and/or reagents, e.g., additional components and/or reagents that may be releasable into monodispersed droplets as described herein. In any suitable embodiment herein, particles may include a polymer, e.g., a hydrogel. In other suitable embodiments herein, particles may include rigid particles. In some embodiments, e.g., embodiments as described herein in which the first fluid is an aqueous fluid, the polymer is a hydrophilic polymer. In some embodiments, e.g., embodiments as described herein in which the first fluid is a non-aqueous fluid, e.g., an oil, the polymer is a lipophilic polymer. In other embodiments in which the first fluid is an aqueous phase fluid, the polymer is a hydroxylethyl methacrylate (HEMA) polymer. In any suitable embodiment herein, a particle may be a cell, e.g., a mammalian cell, yeast cell or bacterial cell. Particles generally range from about 0.1 to about 1000 μm in diameter or largest dimension. In some embodiments, particles have a diameter or largest dimension of about 1.0 μm to 1000 μm, inclusive, such as 1.0 μm to 750 μm, 1.0 μm to 500 μm, 1.0 μm to 250 μm, 1.0 μm to 200 μm, 1.0 μm to 150 μm 1.0 μm to 100 μm, 1.0 μm to 10 μm, or 1.0 μm to 5 μm, inclusive. In some embodiments, particles have a diameter or largest dimension of about 10 μm to about 200 μm, e.g., about 10 μm to about 150 μm, about 10 μm to about 125 μm, or about 10 μm to about 100 μm. In exemplary embodiments, each droplet of the plurality of monodispersed droplets include one, and not more than one, particle.

In practicing the methods as described herein, the composition and nature of the particles may vary. For instance, in certain aspects, the particles may be microgel particles that are micron-scale spheres of gel matrix. In some embodiments, the microgels are composed of a hydrophilic polymer that is soluble in water, including alginate or agarose. In other embodiments, the microgels are composed of a lipophilic microgel.

In other aspects, the particles may be comprised of a hydrogel. In certain embodiments, the hydrogel is selected from naturally derived materials, synthetically derived materials and combinations thereof. Examples of hydrogels include, but are not limited to, collagen, hyaluronan, chitosan, fibrin, gelatin, alginate, agarose, chondroitin sulfate, cellulose acetate, polyacrylamide, polyethylene glycol (PEG), polyvinyl alcohol (PVA), polyacrylamide /poly(acrylic acid) (PAA), hydroxyethyl methacrylate (HEMA), poly N-isopropylacrylamide (NIPAM), and polyanhydrides, poly(propylene fumarate) (PPF), poly(methyl methacrylate), polypropylene, polyethylene, any other 3D-crosslinked polymer, and combinations thereof.

In some aspects, the particles may be rigid particles. In certain embodiments, rigid particles may be made from naturally derived materials, synthetically derived materials and combinations thereof. In some embodiments, the materials of rigid particles include glass, silica, metal, and combinations thereof.

In other aspects, the particles may be elastic particles. In certain embodiments, elastic particles may be made from naturally derived materials, synthetically derived materials and combinations thereof. Examples of materials include, but are not limited to, collagen, hyaluronan, chitosan, fibrin, gelatin, alginate, agarose, chondroitin sulfate, cellulose acetate, polyacrylamide, PEG, PVA, PAA, HEMA, NIPAM, and polyanhydrides, PPF, poly(methyl methacrylate), polypropylene, polyethylene, any other 3D-crosslinked polymer, and combinations thereof. Particles as described herein may be spherical or any other suitable shape.

Depending on their desired end use, the particles may be coated, e.g. with uniform hydrogel, polymer shells, or metallic coatings; they may have materials, e.g. magnetic crystals, specific binding partners, e.g. antibodies, avidin or streptavidin, etc.; or catalysts bound to their surface or deposited in pores or on the surface; or they may be expanded, e.g. using blowing agents. For example, a microfluidic device according to the present disclosure may be operated such that the monodispersed droplets are uniform in size, and the remaining emulsion may vary in size, thus enabling coated particles to be removed from the fluid, e.g. by filtration or centrifugation. In some embodiments, particles are co-flowed with a solution that can be polymerized or hardened. In such embodiments, particles trigger stable jet breakup, creating a uniform coating on the particle.

In some embodiments, coated particles enable a packed configuration and an increase in subsequent encapsulation in droplet workflows, e.g. at least a 3 fold increase, at least 5 fold, at least 7 fold, at least 8 fold, at least 9 fold, or at least 10 fold. In some embodiments, the particles may include reagents for biochemical functionalization of particles and high-throughput pairing of particles with analytes, e.g. reagents or cells. For example, cells may be paired with particles functionalized with barcodes and/or nucleic acid synthesis reagents.

In some embodiments, the particles may be introduced into a jet as described herein in an ordered or a disordered configuration. As used herein, the degree of ordering may be classified by the time at which a particle crosses a plane perpendicular to the flow path. The difference between times of neighboring particles follows a distribution, and the spread of this distribution defines the degree of ordering. For example, the wider the distribution spread, the more disordered the particles. Completely disordered particles that enter randomly will follow a Poisson distribution. Nearly perfectly ordered particles will follow a symmetric distribution. As used herein, particles are “ordered” if they have a distribution defined by a small coefficient of variation, e.g., less than 20%, less than 10%, or less than 5%. As used herein, particles are “disordered” if they have a distribution defined by a large coefficient of variation, e.g. more than 20%, more than 30%, more than 50%. Disordered particles may generate a monodispersed population of particle-containing droplets within a population of polydispersed droplets.

In some embodiments where the particles are elastic, such particles may be close packed (Abate et al., 2009). An example of particles that can be close packed are hydrogel-based particles. In other embodiments, particles may be ordered based on inertial ordering (Edd et al., 2008; Hur et al., 2010). In certain aspects, generating monodispersed droplets using the methods described herein with particles that are in an ordered configuration when entering a microfluidic device, results in monodispersed droplets each containing a single particle.

In some embodiments, in the context of the methods disclosed herein, the particles may be introduced from a channel that has a cross-sectional area that is within a defined percentage of that of a particle of the plurality of particles, e.g. within 1%, within 2%, within 3%, within 4%, within 5%, within 6%, within 7%, within 8%, within 9%, or within 10% of that of a particle of the plurality of particles. In other embodiments, a particle of the plurality of particles may have a diameter or largest dimension that is less than 1% of the channel width or height. In certain aspects, the particles may be introduced from a channel that has a cross-sectional area that is within 10% of that of a particle of the plurality of particles. In some embodiments, the plurality of particles is introduced into the jet of the first fluid in an un-packed configuration. In other embodiments, the plurality of particles is introduced into the jet of the first fluid in a packed configuration.

In some embodiments, the particles have an average volume, and a method as described herein includes shrinking the particles to decrease the average volume. The shrinking may occur upon the application of an external stimulus, e.g., heat. For instance, the particles may be encapsulated in a fluid, followed by the application of heat, causing the particles to shrink in size. The monodispersed droplets will not shrink because the droplet volume is constant, but the particle within the droplet will shrink away from the surface of the droplet.

In any suitable embodiment herein, the particles may include therein or thereon, or associated therewith at least one of cells, genes, barcodes, drug molecules, therapeutic agents, particles, bioactive agents, osteogenic agents, osteoconductive agents, osteoinductive agents, anti-inflammatory agents, growth factors, fibroin derived polypeptide particles, nucleic acid synthesis reagents, nucleic acid detection reagents, DNA molecules, RNA molecules, genomic DNA molecules, and combinations of the same. In embodiments that involve the combination of multiple reagents within a monodispersed droplet, the particles may contain multiple compartments. The particles may be used to pair with reagents that can be triggered to release a desired compound, e.g., a substrate for an enzymatic reaction. For instance, a particle triggered to rupture upon the application of a stimulus, e.g., heat, can be encapsulated in the monodispersed droplets. The stimulus initiates a reaction after the particles have been encapsulated in an immiscible carrier phase fluid.

Particles, e.g., beads, may be generated under microfluidic control, e.g., using methods described in U.S. Patent Application Publication No. 2015/0232942, the disclosure of which is incorporated by reference herein. Microfluidic devices can form emulsions consisting of droplets that are extremely uniform in size. The particle generation process may be accomplished by pumping two immiscible fluids, such as oil and water, into a junction. The junction shape, fluid properties (viscosity, interfacial tension, etc.), and flow rates influence the properties of the particles generated but, for a relatively wide range of properties, particles of controlled, uniform size can be generated using methods like T-junctions and flow focusing. To vary particle size, the flow rates of the immiscible liquids may be varied since, for T-junction and flow focus methodologies over a certain range of properties, particle size depends on total flow rate and the ratio of the two fluid flow rates. To generate a particle with microfluidic methods, the two fluids are normally loaded into two inlet reservoirs (e.g., syringes, pressure tubes) and then pressurized as needed to generate the desired flow rates (e.g., using syringe pumps, pressure regulators, gravity, etc.). This pumps the fluids through the device at the desired flow rates, thus generating droplet of the desired size and rate.

In some embodiments, particles may be generated using parallel droplet generation techniques, including, but not limited to, serial splitting and distribution plates. Parallel droplet generation techniques of interest further include those described by Abate and Weitz, Lab Chip 2011, Jun. 7; 11(11):1911-5; and Huang et al., RSC Advances 2017, 7, 14932-14938; the disclosure of each of which is incorporated by reference herein.

In some embodiments, the particles are allowed to solidify by triggering a gelation mechanism, including, but not limited to, the polymerization or crosslinking of a gel matrix. For instance, polyacrylamide gels are formed by copolymerization of acrylamide and bis-acrylamide. The reaction is a vinyl addition polymerization initiated by a free radical-generating system. In certain aspects, agarose hydrogels undergo gelation by cooling the hydrogels below the gelation temperature.

In some embodiments, the particles may be removed from the fluid, dried, and stored in a stable form for a period of time. Examples of drying approaches include, but are not limited to, heating, drying under vacuum, freeze drying, and supercritical drying. In some embodiments, the dried particles may be combined with a fluid, but still retain the shape and structure as independent, often spherical, gel particles. In some embodiments, the dried particles are combined with an appropriate fluid, causing a portion of the fluid to be absorbed by the particles. In some embodiments, the porosity of the particles may vary, to allow at least one of a plurality of targets to be absorbed into the particles when combined with the appropriate fluid. Any convenient fluid that allows for the desired absorption to be performed in the particles may be used.

As used herein, the terms “absorb,” “swell,” and “expand” as applied to particles may be used interchangeably to refer to the process in which a fluid permeates a substance, or in which a substance incorporates a fluid. In some embodiments, the substance being absorbed may retain at least a portion of its shape and structure. In some embodiments, the substance being absorbed may become incorporated into a fluid so as to form a solution.

### Monodispersed Droplets and Generation Thereof

As used herein, the term “monodispersed,” as applied to droplets refers to a variation in diameter or largest dimension of particle-containing droplets produced by particle-triggered breakup of a stable jet as described herein. Generally, monodispersed droplets can have more variation in diameter or largest dimension as compared to the particles from which they are generated, while still functioning in the various methods described herein. Monodispersed droplets generally range from about 0.1 to about 1000 μm in diameter or largest dimension, and may have a variation in diameter or largest dimension of less than a factor of 10, e.g., less than a factor of 5, less than a factor of 4, less than a factor of 3, less than a factor of 2, less than a factor of 1.5, less than a factor of 1.4, less than a factor of 1.3, less than a factor of 1.2, less than a factor of 1.1, less than a factor of 1.05, or less than a factor of 1.01, in diameter or the largest dimension. In some embodiments, monodispersed droplets have a variation in diameter or largest dimension such that at least 50% or more, e.g., 60% or more, 70% or more, 80% or more, 90% or more, 95% or more, or 99% or more of the monodispersed droplets, vary in diameter or largest dimension by less than a factor of 10, e.g., less than a factor of 5, less than a factor of 4, less than a factor of 3, less than a factor of 2, less than a factor of 1.5, less than a factor of 1.4, less than a factor of 1.3, less than a factor of 1.2, less than a factor of 1.1, less than a factor of 1.05, or less than a factor of 1.01. In some embodiments, monodispersed droplets have a diameter of about 1.0 μm to 1000 μm, inclusive, such as about 1.0 μm to about 750 μm, about 1.0 μm to about 500 μm, about 1.0 μm to about 250 μm, about 1.0 μm to about 200 μm, about 1.0 μm to about 150 μm, about 1.0 μm to about 100 μm, about 1.0 μm to about 10 μm, or about 1.0 μm to about 5 μm, inclusive. In some embodiments, the internal volume of the monodispersed droplets may be about 0.01 pL or less, about 0.1 pL or less, 1 pL or less, about 5 pL or less, 10 pL or less, 100 pL or less, or 1000 pL or less. In some embodiments, the internal volume of the monodispersed droplets may be about 1 fL or less, about 10 fL or less, or 100 fL or less. In some embodiments, the internal volume of the monodispersed droplets may encompass a liquid volume which ranges between picoliters and femotliters (e.g., about 0.001 pL to about 1000 pL). In some embodiments, the internal volume of the monodispersed droplets extends strictly below the nanoliter level (e.g., strictly picoliter, strictly femtoliter, or combination thereof).

In practicing the methods as described herein, the composition and nature of the monodispersed droplets may vary. For instance, in certain aspects, a surfactant may be used to stabilize the droplets. Accordingly, a droplet may involve a surfactant stabilized emulsion, e.g., a surfactant stabilized single emulsion or a surfactant stabilized double emulsion. Any convenient surfactant that allows for the desired reactions to be performed in the droplets may be used. In other aspects, monodispersed droplets are not stabilized by surfactants or particles, e.g. stabilizers or organic solvents.

In some embodiments, the methods described herein enable the creation of many parallel reactions chambers that have similar conditions. In some embodiments, small compartments of uniform size are created. For example, in some embodiments, the plurality of particles is introduced into the jet of the first fluid in an ordered configuration as described herein, resulting in a monodispersed emulsion made up of monodispersed particle-containing droplets. In other embodiments, the plurality of particles is introduced into the jet of the first fluid in a disordered configuration as described herein, resulting in a polydispersed emulsion including a population of monodispersed-particle containing droplets and a population of polydispersed droplets that do not contain particles. The monodispersed-particle containing droplets may then be sorted to separate them from other droplets in the polydispersed emulsion. Despite the bulk population being polydispersed, reactions containing beads are still substantially uniform with respect to volume (and therefore reagents and products).

In some embodiments, the resulting emulsions include populations of monodispersed droplets that are present in a polydispersed emulsion. In certain aspects, generating monodispersed droplets using the methods described herein reduces the number of non-particle-containing satellite droplets that may be produced using other methods. As used herein, the term “satellite” as applied to droplets refers to a population of droplets smaller in diameter than that of the monodispersed droplets, which are distributed around a monodispersed droplet and are generated after particle-triggering. In some embodiments, the number of satellite droplets is reduced by a factor of at least 2 fold or more, e.g., at least 3 fold, at least 5 fold, at least 10 fold, at least 20 fold, at least 30 fold, at least 40 fold, at least 50 fold, or at least 100 fold, or more.

The droplets described herein may be prepared as emulsions, e.g., as an aqueous phase fluid dispersed in an immiscible phase carrier fluid (e.g., a fluorocarbon oil or a hydrocarbon oil) or vice versa.

Monodispersed single emulsions may be generated with the use of microfluidic devices using the methods described herein. Producing a monodispersed emulsion using particle-triggered breakup of a stable jet can provide emulsions including droplets that are extremely uniform in size. The droplet generation process may be accomplished by flowing in a channel of a microfluidic device a first fluid into a second fluid under stable jetting conditions to provide a jet of the first fluid in the second fluid, wherein the first fluid is immiscible with the second fluid; and introducing a plurality of particles into the jet of the first fluid triggering break-up of the jet of the first fluid and encapsulation of the plurality of particles in a plurality of monodispersed droplets of the first fluid in the second fluid. To vary droplet size, the stable jetting conditions, co-flow, and/or particle sizes may be varied. For agarose gel-based particles, the particles can be liquefied using an external stimulus (e.g., heat) to generate a liquid monodispersed emulsion.

The percentage of monodispersed droplets prepared according to the disclosed methods containing one, and not more than one, particle may be about 70% or more; about 75% or more; about 80% or more; about 85% or more; about 90% or more; about 95% or more, or about 99% or more. For example, the percentage of monodispersed droplets containing one, and not more than one, particle may be from about 70% to about 100%, e.g., from about 75% to about 100%, from about 80% to about 100%, from about 85% to about 100%, from about 90% to about 100%, or from about 95% to about 100%. As a further example, the percentage of monodispersed droplets with one, and not more than one, particle may be from about 70% to about 95%, e.g., from about 75% to about 90%, or from about 80% to about 85%. The percentage of particles that are encapsulated in monodispersed droplets in the second fluid may be about 70% or more; about 75% or; about 80% or more; about 85% or more; or about 90% or more. For example, the percentage of particles that are encapsulated in monodispersed droplets in the second fluid may be from about 70% to about 100%, e.g., from about 75% to about 100%, from about 80% to about 100%, from about 85% to about 100%, from about 90% to about 100%, or from about 95% to about 100%. As a further example, the percentage of particles that are encapsulated in monodispersed droplets in the second fluid may be from about 70% to about 95%, e.g., from about 75% to about 90%, or from about 80% to about 85%.

In some embodiments, the monodispersed droplets produced according to the disclosed methods may provide the basis for the generation of double or multiple emulsions using known methods. A double emulsion includes droplets contained within droplets, e.g., an aqueous phase fluid surrounded by an immiscible phase shell in an aqueous phase carrier fluid (e.g., water-in oil-in water) or a immiscible phase fluid surrounded by an aqueous phase shell in an immiscible phase carrier fluid (e.g., oil-in water-in oil). A particularly useful kind of double emulsion includes an aqueous droplet encapsulated within a slightly larger oil droplet, itself dispersed in a carrier aqueous phase fluid. Double emulsions are valuable because the inner “core” of the structure can be used to provide active compounds, like dissolved solutes or biological materials, where they are shielded from the external environment by the surrounding oil shell. A benefit of generating double emulsions using particles is similar to that for the generation of single emulsions, in that the double emulsion dimensions (inner and outer droplet sizes) can be controlled over a wide range and the droplets can be formed with a high degree of uniformity. As discussed herein, in suitable embodiments the particles can be dissolved and/or melted within the monodispersed droplets. Accordingly, in some embodiments multiple emulsions, e.g., double emulsions, may be prepared from monodispersed droplets which no longer contain an intact particle yet retain their original size. In this manner, such monodispersed droplets may serve as templates for the preparation of multiple emulsions, e.g., double emulsions.

The methods as described herein may include combining a plurality of particles with a third fluid, wherein the third fluid includes a plurality of targets, e.g., reagents, nucleic acids or cells, etc. See, e.g., FIG. 1E, wherein H₂O is an exemplary third fluid. In some embodiments, combining the plurality of particles with the third fluid includes causing a portion of the third fluid, and the targets and/or reagents contained therein, to be absorbed by the particles. In some embodiments, combining the plurality of particles with a third fluid includes flowing a third fluid into the first fluid prior to flowing the first fluid into the second fluid, wherein the third fluid is miscible with the first fluid. In certain aspects, the methods as described herein may include combining a plurality of particles with a first fluid, wherein the first fluid includes a plurality of targets, e.g., reagents, nucleic acids or cells, etc.

By introducing a plurality of particles into a stable jet of the first fluid, the plurality of particles triggers break-up of the jet of the first fluid and encapsulation of the plurality of particles in a plurality of monodispersed droplets of the first fluid in the second fluid.

In some embodiments, the target molecules are cells. In such embodiments, the monodispersed droplets may contain one or more cells per droplet. Alternatively, the monodispersed droplets do not contain more than one cell per droplet or substantially all of the monodispersed droplets do not contain more than one cell per droplet, e.g. 80% or more, 90% or more, 95% or more, or 99% or more of the monodispersed droplets do not contain more than one cell per droplet. In some embodiments, after particle-triggered breakup of the stable jet, some droplets in the resulting emulsion do not contain any of the plurality of particles and/or targets.

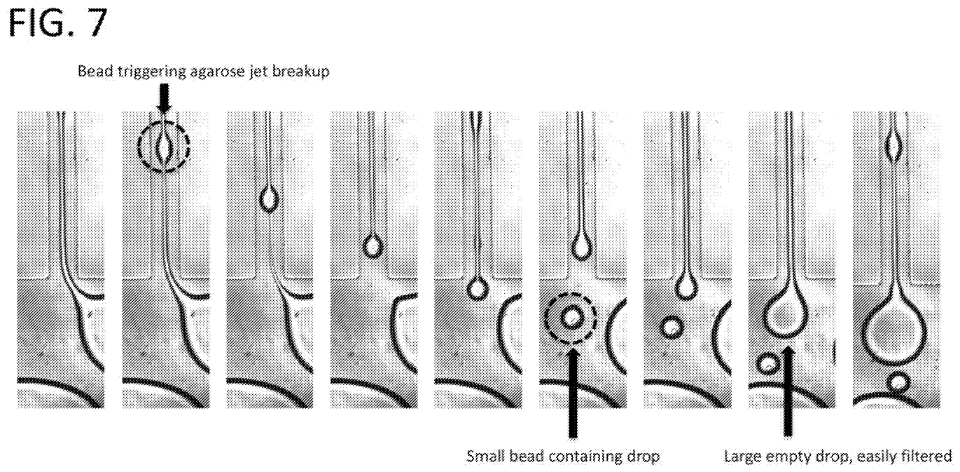

The droplets that do not contain one of the particles may be removed from the monodispersed emulsion by a suitable separation technique, e.g., a size-based separation technique, such as filtration or centrifugation. Those droplets that do not contain one of the particles may be smaller or larger in diameter than those droplets that do contain one of the particles. The monodispersed droplets containing particles may also be enriched relative to droplets that do not contain one of the particles. Filtration may be utilized, for example, in an embodiment such as that generally shown in FIG. 7, where a substantial size difference may be created. In this case, the particles are provided in relatively small polymer containing drops and the empty (of particles) polymer containing drops are relatively large. Filtration may also be utilized after oil is removed from an emulsion, for example, if the coating is a hydrogel like polyacrylamide or agarose.

As used herein, the terms “enriched” and “enrichment” may be used interchangeably to refer to the process of increasing the ratio of target entities (e.g., monodispersed droplets containing particles) to non-target entities (e.g., droplets not containing particles) in the emulsion compared to the ratio in the original emulsion. Using the method disclosed herein, monodispersed droplets containing particles may be enriched relative to droplets that do not contain one of the particles, e.g., at least 2 fold, at least 3 fold, at least 5 fold, at least 10 fold, at least 20 fold, at least 30 fold, at least 40 fold, at least 50 fold, at least 100 fold, or more.

### Double Emulsions

Double emulsions generally refer to emulsions within emulsions—i.e., liquid droplets that are contained within liquid droplets of a second immiscible phase. They can be stabilized by surfactant but, importantly, the middle phase “shell” includes a liquid phase in addition to the optional surfactant. As the volume of the shell is reduced, double emulsions resemble less droplets-within-droplets than vesicle-like structures, with a core fluid encapsulated in a thin membrane of surfactant molecules. Double emulsions can be used to form such “vesicles” by allowing them to undergo a de-wetting transition, in which the middle liquid phase fluid is expunged from the shell but a surfactant layer is maintained, generating a vesicle including the aqueous core with a thin layer of surfactant molecules surrounding it, and a small oil droplet that was originally the shell adhering to it.

The tendency of a double emulsion to de-wet depends on the properties of the different solutions and surfactants, especially the interfacial tensions of the different phases with respect to one another. An aqueous formulation including fluorinated oil, PEG-Krytox® surfactant, Jeffamine®(polyetheramine)-Krytox® surfactant, and pluronic, when added to the carrier phase, appears capable of forming double emulsions and vesicles, both of which are thermostable to above 95° C. Krytox® fluids are fluorinated synthetic oils based on hexfluoropropylene oxide combined with a functional end-group. Other surfactants such as Tween® 20 (Polysorbate 20) and Span® 80 (Sorbitane monooleate) may be utilized with or without thickening agents such as PEG, alginate, glycerol, etc., to induce GUV formation from double emulsions. Additional disclosure of double emulsions and methods of generation thereof are provided in U.S. Patent Application Publication No. 2017/0022538.

### Stable Jetting Conditions

Droplets can form when immiscible fluids are flowed together in microfluidic channels.

Methods described herein are based at least in part on the observation that monodisperse droplets can be effectively generated by triggering breakup of a stable jet via the introduction of particles. Thus, methods of the present disclosure include flowing in a channel of a microfluidic device a first fluid into a second fluid under stable jetting conditions to provide a jet of the first fluid in the second fluid, wherein the first fluid is immiscible with the second fluid.

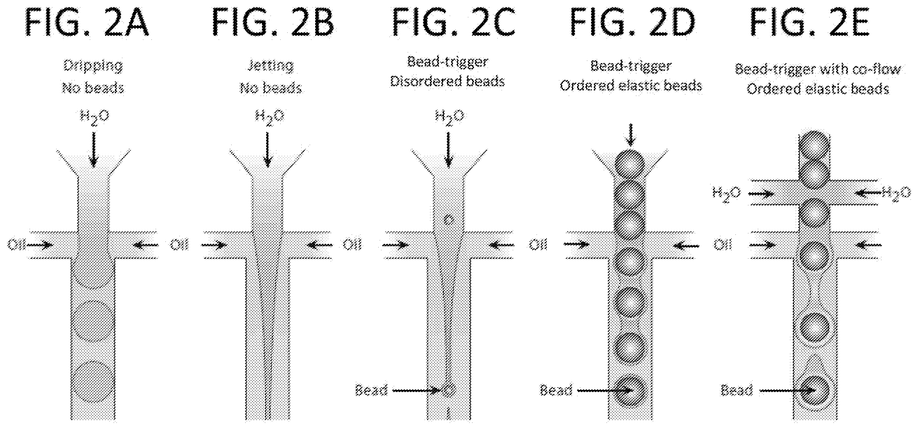

“Dripping”, as illustrated in FIG. 1A and FIG. 2A, refers to conditions where drops pinch off periodically in the region of the channel downstream of a junction of two immiscible fluids, e.g., first and second fluids as described herein. This region may be referred to herein as the “nozzle”. “Jetting” refers to conditions where a thin stream of inner phase (e.g., an aqueous first fluid) extends beyond the nozzle. This thin jet generally breaks into drops that can be larger or smaller than the nozzle. At moderate to low Reynolds numbers, the transition from dripping to jetting has been examined and is largely determined by two dimensionless numbers—the Weber number (We) and Capillary number (Ca) (Utada et al., 2007). The Weber number is the ratio between inertial and surface tension forces. The Capillary number is the ratio between viscous and surface tension forces. Utada (2007) provide a phase diagram that summarizes the conditions under which this transition occurs. Jetting occurs at high Ca or We, or at a high combination of Ca and We (Utada 2007). Above a certain Ca and We, the jet no longer breaks into droplets spontaneously. This is referred to herein as a “stable jetting regime”. In this regime, particles can be used to effectively trigger monodisperse droplet formation. This stable jetting regime is expected at We>1 or Ca>0.1. The terms “stable jet”, “stable jetting regime”, “stable jetting conditions”, and the like as used herein refer to jetting conditions in the microfluidic device (and jets produced under such conditions), wherein the two phases do not break into droplets without an applied perturbation, e.g., as provided by the introduction of one or more particles into the jet. Such conditions may be present, for example at We>1 or Ca>0.1. Embodiments of stable jetting regimes are illustrated in FIGS. 1B-1E. The conditions characterized by the terms “stable jet”, “stable jetting regime”, “stable jetting conditions”, and the like can also be contrasted with “unstable jetting conditions” in which droplets are formed at the tip of the jet in the nozzle, even in the absence of a particle.

One of ordinary skill in the art will understand that specific microfluidic parameters may be varied to reach the stable jetting conditions described herein. For example, one or more of dynamic viscosity (η), velocity (υ), interfacial tension (γ), inertial forces, wettability and degree of confinement of the unperturbed jet may be varied to achieve We>1 or Ca>0.1.

While not limiting, typical parameter ranges are as follows: Weber # greater or equal to 1, Ca=10⁻³ to 10⁻²; Weber # greater or equal to 1, Ca=10⁻² to 10⁻¹; and Weber # greater great or equal to 1, Ca=10⁻¹ to 1; Weber # less than or equal to 1, Ca>10⁻¹.

Microfluidic devices used to produce a jet, include, but are not limited to, those described in U.S. Patent Application Publication No. 2009/0209039, the disclosure of which is incorporated by reference herein.

In some embodiments under a jetting regime, the plurality of particles is encapsulated at a rate of 1 Hz to 100 kHz, e.g., at a rate of about 5,000/sec or more, e.g. about 10,000/sec or more, about 15,000/sec or more, about 20,000/sec or more, or about 25,000/sec or more. In certain embodiments, the plurality of particles is encapsulated at a rate of about 10,000/sec or more. In some embodiments under a jetting regime, the speed at which a plurality of particles is encapsulated is increased by at least 5 fold, e.g. at least 10 fold or 15 fold, as compared to droplet formation in a dripping regime.

### Fluids Involved in the Generation of Monodispersed Droplets

As discussed herein, the disclosed methods generally involve flowing in a channel of a microfluidic device a first fluid into a second fluid under stable jetting conditions to provide a jet of the first fluid in the second fluid, wherein the first fluid is immiscible with the second fluid; and introducing a plurality of particles into the jet of the first fluid triggering break-up of the jet of the first fluid and encapsulation of the plurality of particles in a plurality of monodispersed droplets of the first fluid in the second fluid. In some embodiments, the methods include the further step of flowing a third fluid into the first fluid prior to flowing the first fluid into the second fluid, wherein the third fluid is miscible with the first fluid. The first fluid is generally selected to be immiscible with the second fluid and share a common hydrophilicity/hydrophobicity with the material which constitutes the particles. The third fluid is generally selected to be immiscible with the second fluid, and may be miscible or immiscible with the first fluid. Accordingly, in some embodiments, the first fluid is an aqueous phase fluid; the second fluid is a fluid which is immiscible with the first fluid, such as a non-aqueous phase, e.g., a fluorocarbon oil, a hydrocarbon oil, or a combination thereof; and the third fluid is an aqueous phase fluid. Alternatively, is some embodiments the first fluid is a non-aqueous phase, e.g., a fluorocarbon oil, a hydrocarbon oil, or a combination thereof; the second fluid is a fluid which is immiscible with the first fluid, e.g., an aqueous phase fluid; and the third fluid is a fluorocarbon oil, a hydrocarbon oil or a combination thereof.

As discussed above, methods of the present disclosure include flowing in a channel of a microfluidic device a first fluid into a second fluid under stable jetting conditions to provide a jet of the first fluid in the second fluid, wherein the first fluid is immiscible with the second fluid. While embodiments are described herein in which the first fluid is an aqueous phase fluid and the second fluid is a non-aqueous phase fluid (or vice versa), it should be noted that stable jets may also be produced using an aqueous two-phase system (ATPS), in which the first and second fluids are immiscible water-based phases.

The flow rates of the various fluids may be adjusted as appropriate in connection with the provision of the stable jetting conditions described herein. For example, suitable flow rates may range from about 20 μl/hr to about 40 mL/hr, such as from about 50 μl/hr to about 20 mL/hr, about 100 μl/hr to about 10 mL/hr, or about 500 μl/hr to about 5 mL/hr. In non-limiting exemplary embodiments, the flow rate of the first fluid may be about 1000 μl/hr or more, e.g. about 1500 μl/hr, about 2000 μl/hr or more, about 2500 μl/hr or more, about 3000 μl/hr or more, about 3500 μl/hr or more, or about 4000 μl/hr or more. In certain aspects, the flow rate of the first fluid is about 2000 μl/hr. The flow rate of the second fluid may be about 2000 μl/hr or more, e.g. about 2000 μl/hr, about 2500 μl/hr or more, about 3000 μl/hr or more, about 3500 μl/hr or more, about 4000 μl/hr or more, about 4500 μl/hr or more. In certain aspects, the flow rate of the second fluid is about 4000 μl/hr. The flow rate of the third fluid may be about 1000 μl/hr or more, e.g. about 1500 μl/hr, about 2000 μl/hr or more, about 2500 μl/hr or more, about 3000 μl/hr or more, about 3500 μl/hr or more, or about 4000 μl/hr or more. In certain aspects, the flow rate of the first fluid is about 2000 μl/hr.

In some embodiments, the viscosities of the first fluid, second fluid, and/or third fluid have a minimal variation in value, e.g. less than a factor of 100, less than a factor of 50, less than a factor of 10, less than a factor of 5, less than a factor of 4, less than a factor of 3, less than a factor of 2, less than a factor of 1.01, in value.

The non-aqueous phase may serve as a carrier fluid forming a continuous phase that is immiscible with water, or the non-aqueous phase may be a dispersed phase. The non-aqueous phase may be referred to as an oil phase including at least one oil, but may include any liquid (or liquefiable) compound or mixture of liquid compounds that is immiscible with water. The oil may be synthetic or naturally occurring. The oil may or may not include carbon and/or silicon, and may or may not include hydrogen and/or fluorine. The oil may be lipophilic or lipophobic. In other words, the oil may be generally miscible or immiscible with organic solvents. Exemplary oils may include at least one of silicone oil, mineral oil, fluorocarbon oil, vegetable oil, or a combination thereof, among others.

In exemplary embodiments, the oil is a fluorinated oil, such as a fluorocarbon oil, which may be a perfluorinated organic solvent. Examples of a suitable fluorocarbon oils include, but are not limited to, C₉H₅OF₁₅ (HFE-7500), C₂₁F₄₈N₂ (FC-40), and perfluoromethyldecalin (PFMD).

As discussed herein, in some embodiments, the first or third fluid may contain a plurality of targets (e.g. DNA molecules such as genomic DNA molecules, RNA molecules, and/or nucleic acid synthesis reagents such as nucleic acid amplification reagents including, RT-PCT, PCR and/or isothermal amplification reagents).

In some embodiments, gelling agents may be added to one or more fluids, e.g., a third fluid as described herein, to solidify the outer layer of the droplets, e.g., to provided coated particles.

### Surfactants

In certain aspects, a surfactant may be included in the first fluid, second fluid, and/or third fluid. Accordingly, a droplet, e.g., a particle-containing droplet, may involve a surfactant stabilized emulsion, e.g., a surfactant stabilized single emulsion or a surfactant stabilized double emulsion, where the surfactant is soluble in the first fluid, second fluid, and/or third fluid. Any convenient surfactant that allows for the desired reactions to be performed in the droplets may be used, including, but not limited to, octylphenol ethoxylate (Triton X-100), polyethylene glycol (PEG), (Tween 20) and/or octylphenoxypolyethoxyethanol (IGEPAL). In other aspects, a droplet is not stabilized by surfactants.

The surfactant used depends on a number of factors such as the oil and aqueous phases (or other suitable immiscible phases, e.g., any suitable hydrophobic and hydrophilic phases) used for the emulsions. For example, when using aqueous droplets in a fluorocarbon oil, the surfactant may have a hydrophilic block (PEG-PPO) and a hydrophobic fluorinated block (Krytox® FSH). If, however, the oil was switched to a hydrocarbon oil, for example, the surfactant may instead be chosen such that it had a hydrophobic hydrocarbon block, like the surfactant ABIL EM90.

Other surfactants can also be envisioned, including ionic surfactants. Other additives can also be included in the oil to stabilize the droplets, including polymers that increase droplet stability at temperatures above 35° C.

Without intending to be bound by any particular theory, it is proposed that the preparation of a thermostable emulsions relies on the use of a surfactant that is able to form membranes or double emulsion interfaces that can withstand high temperatures, such as those associated with standard PCR reactions. One way to accomplish this may be to use a surfactant with a relatively high molecular weight so that when assembled at the interface of a droplet or in a membrane configuration, the energy required to remove the surfactant from the interface (or break the membrane) is higher than can be provided by kT, where k=Boltzmann constant and T is temperature.

Exemplary surfactants which may be utilized to provide thermostable emulsions are the “biocompatible” surfactants that include PEG-PFPE (polyethyleneglycol-perflouropolyether) block copolymers, e.g., PEG-Krytox® (see, e.g., Holtze et al., “Biocompatible surfactants for water-in-fluorocarbon emulsions,” Lab Chip, 2008, 8, 1632-1639, the disclosure of which is incorporated by reference herein), and surfactants that include ionic Krytox® in the oil phase and Jeffamine® (polyetheramine) in the aqueous phase (see, e.g., DeJournette et al., “Creating Biocompatible Oil-Water Interfaces without Synthesis: Direct Interactions between Primary Amines and Carboxylated Perfluorocarbon Surfactants”, Anal. Chem. 2013, 85(21):10556-10564, the disclosure of which is incorporated by reference herein). Additional and/or alternative surfactants may be used provided they form stable interfaces. Many suitable surfactants will thus be block copolymer surfactants (like PEG-Krytox®) that have a high molecular weight. These examples include fluorinated molecules and solvents, but it is likely that non-fluorinated molecules can be utilized as well.

Accordingly, in some embodiments, the present disclosure provides thermostable emulsions. These emulsions are suitable for use in performing biological reactions, such as PCR, RT-PCR, protein-protein interaction studies, etc.

### Adding Reagents to Monodispersed Droplets

Droplets can be used as independent microreactors for a number of chemical and biological applications, e.g., chemical synthesis, kinetics studies, the screening of biological contents and bio-medical diagnostics. In practicing the subject methods, a number of reagents may need to be added to the droplets, in one or more steps (e.g., about 2, about 3, about 4, or about 5 or more steps). The means of adding reagents to the droplets may vary in a number of ways depending for example, on the emulsification stage of the droplets, e.g., different approaches may be applicable to the addition of reagents to monodispersed single-emulsion droplets relative to multiple-emulsion droplets, such as double emulsion droplets. Approaches of interest include, but are not limited to, those described by Ahn, et al., Appl. Phys. Lett. 88, 264105 (2006); Priest, et al., Appl. Phys. Lett. 89, 134101 (2006); Abate, et al., PNAS, Nov. 9, 2010 vol. 107 no. 45 19163-19166; and Song, et al., Anal. Chem., 2006, 78 (14), pp 4839-4849; the disclosures of which are incorporated herein by reference. In some embodiments, reagents may be added to droplets during the emulsification process as described herein, e.g., as components of the first fluid, e.g., without the use of a microfluidic device or system. In other embodiments, microfluidic techniques, devices and/or systems may be utilized to add reagents and/or modify monodispersed droplets once prepared as otherwise described herein.

For instance, a reagent may be added to a monodispersed single-emulsion droplet as described herein by a method involving merging a droplet with a second droplet that contains the reagent(s), e.g. prior to break-up of the jet. The reagent(s) that are contained in the second droplet may be added by any convenient means, specifically including those described herein. This droplet may be merged with the first droplet to create a droplet that includes the contents of both the first droplet and the second droplet. In some embodiments, the first droplet is substantially larger than the second droplet and outnumbers the second droplet. In some embodiments, the one or more droplets include one or more cells.

In some embodiments, the merging of two droplets triggers the start of the chemical reaction(s). Practical prerequisites for merging are that the droplets touch each other and overcome the stabilizing forces caused by surface tension and lubrication. In certain aspects, a surfactant may be used to stabilize the droplets against coalescence. Accordingly, droplets may involve a surfactant stabilized emulsion, e.g., a surfactant stabilized single emulsion. Any convenient surfactant that allows for the desired reactions to be performed in the droplets may be used.

In some embodiments, particle-triggered stable jet breakup can be used to merge reagents with particle-containing drops. Such particle-containing drops may be coalesced with a stable jet, which, upon triggering, breaks into larger drops containing jet reagents and single particles. Thus, for example, the present disclosure provides a method for generating monodispersed droplets, including: flowing in a channel of a microfluidic device a first fluid into a second fluid under stable jetting conditions to provide a jet of the first fluid in the second fluid, wherein the first fluid is immiscible with the second fluid; and merging one or more droplets with the jet prior to break-up of the jet. The droplets to be merged with the jet may include targets and/or reagents, e.g., cells, nucleic acid amplification reagents, and the like. In some embodiments, the droplets may be merged with the first fluid either upstream or downstream of jet formation.

In some embodiments, particle-triggered stable jet breakup can be used to merge reagents with drops. Thus, for example, the present disclosure provides a method for generating monodispersed droplets, including: flowing in a channel of a microfluidic device a first fluid into a second fluid under stable jetting conditions to provide a jet of the first fluid in the second fluid, wherein the jet includes a plurality of particles, wherein the first fluid is immiscible with the second fluid; and merging one or more droplets with the jet prior to particle-induced break-up of the jet. The droplets to be merged with the jet may include targets and/or reagents, e.g., cells, nucleic acid amplification reagents, and the like. In some embodiments, the droplets may be merged with the first fluid either upstream or downstream of jet formation.

One or more reagents may also, or instead, be added to monodispersed single-emulsion droplets as described herein using techniques such as droplet coalescence, electrocoalescence, use of a merger device, and/or picoinjection. In droplet coalescence, a target droplet may be flowed alongside a droplet containing the reagent(s) to be added to the target droplet. The two droplets may be flowed such that they are in contact with each other, but not touching other droplets. These droplets may then be passed through electrodes or other means of applying an electrical field, wherein the electric field may destabilize the droplets such that they are merged together.

In picoinjection, a target droplet may be flowed past a channel containing the reagent(s) to be added, wherein the reagent(s) are at an elevated pressure. Due to the presence of the surfactants, however, in the absence of an electric field, the droplet will flow past without being injected, because surfactants coating the droplet may prevent the fluid(s) from entering. However, if an electric field is applied to the droplet as it passes the injector, fluid containing the reagent(s) will be injected into the droplet. The amount of reagent added to the droplet may be controlled by several different parameters, such as by adjusting the injection pressure and the velocity of the flowing drops, by switching the electric field on and off, and the like. In some aspects, droplets may be injected for merging. Such droplets may merge with the charged, stable jet upon contact but will not break the stable jet. The particle will then cause breakup of the merged stable jet and generate a new monodispersed droplet.

In other aspects, one or more reagents may also, or instead, be added to a monodispersed single-emulsion droplet as described herein by a method that does not rely on merging two droplets together or on injecting liquid into a droplet. Rather, one or more reagents may be added to a droplet by a method involving the steps of emulsifying a reagent into a stream of very small drops, and merging these small drops with a target droplet. Such methods are referred to herein as “reagent addition through multiple-drop coalescence.” These methods take advantage of the fact that due to the small size of the drops to be added compared to that of the target droplet, the small drops will flow faster than the target droplets and collect behind them. The collection can then be merged by, for example, applying an electric field. This approach can also, or instead, be used to add multiple reagents to a droplet by using several co-flowing streams of small drops of different fluids. To enable effective merger of the tiny and target droplets, it is important to make the tiny drops smaller than the channel containing the target droplets, and also to make the distance between the channel injecting the target droplets from the electrodes applying the electric field sufficiently long so as to give the tiny drops time to “catch up” to the target droplets. If this channel is too short, not all tiny drops will merge with the target droplet and less than the desired amount of reagent may be added. To a certain degree, this can be compensated for by increasing the magnitude of the electric field, which tends to allow drops that are farther apart to merge. In addition to making the tiny drops on the same microfluidic device, they can also, or instead, be made offline using another microfluidic drop maker or through homogenization and then injecting them into the device containing the target droplets.

Accordingly, in certain aspects a reagent is added to a droplet prepared as described herein by a method involving emulsifying the reagent into a stream of droplets, wherein the droplets are smaller than the size of the target droplets (e.g., monodispersed single-emulsion droplets or multiple-emulsion droplets); flowing the droplets together with the target droplets; and merging a droplet with the target droplet. The diameter of the droplets contained in the stream of droplets may vary ranging from about 75% or less than that of the diameter of the target droplet, e.g., the diameter of the flowing droplets is about 75% or less than that of the diameter of the target droplet, about 50% or less than that of the diameter of the target droplet, about 25% or less than that of the diameter of the target droplet, about 15% or less than that of the diameter of the target droplet, about 10% or less than that of the diameter of the target droplet, about 5% or less than that of the diameter of the target droplet, or about 2% or less than that of the diameter of the target droplet. In certain aspects, a plurality of flowing droplets may be merged with the target droplet, such as 2 or more droplets, 3 or more, 4 or more, or 5 or more. Such merging may be achieved by any convenient means, including but not limited to by applying an electric field, wherein the electric field is effective to merge the flowing droplet with the target droplet.

As a variation of the above-described methods, the fluids may be jetting. That is, rather than emulsifying the fluid to be added into flowing droplets, a long jet of this fluid can be formed and flowed alongside the target droplet. These two fluids can then be merged by, for example, applying an electric field. The result is a jet with bulges where the droplets are, which may naturally break apart into droplets of roughly the size of the target droplets before the merger, due to the Rayleigh plateau instability. A number of variants are contemplated. For instance, one or more agents may be added to the jetting fluid to make it easier to jet, such as gelling agents and/or surfactants. Moreover, the viscosity of the continuous fluid could also be adjusted to enable jetting, such as that described by Utada, et al., Phys. Rev. Lett. 99, 094502 (2007), the disclosure of which is incorporated herein by reference.

In other aspects, one or more reagents may be added using a method that uses the injection fluid itself as an electrode, by exploiting dissolved electrolytes in solution.

In another aspect, a reagent is added to a droplet formed at an earlier time by enveloping the droplet to which the reagent is to be added (i.e., the “target droplet”) inside a drop containing the reagent to be added (the “target reagent”). In certain embodiments such a method is carried out by first encapsulating the target droplet in a shell of a suitable hydrophobic phase, e.g., oil, to form a double emulsion. The double emulsion is then encapsulated by a droplet containing the target reagent to form a triple emulsion. To combine the target drop with the drop containing the target reagent, the double emulsion is then burst open using any suitable method, including, but not limited to, applying an electric field, adding chemicals that destabilizes the droplet interface, flowing the triple emulsion through constrictions and other microfluidic geometries, applying shearing or ultrasound, increasing or reducing temperature, or by encapsulating magnetic particles in the droplet that can rupture the double emulsion interface when pulled by a magnetic field.

Aspects of the above-described methods of adding reagents to droplets are described in more detail in U.S. Patent Application Publication No. 2015/0232942, the disclosure of which is incorporated by reference herein in its entirety and for all purposes.

While the above methods of adding reagents to droplets may be suitable for the addition of reagents to monodispersed single-emulsion droplets, one or more of the above methods may not be suitable for the addition of reagents directly to multiple-emulsion droplets, such as double emulsion droplets, This may be the case, for example, where such methods would disrupt the structure of the multiple-emulsion droplets. The above methods may find use, however, in adding reagents to monodispersed single-emulsion droplets which are then encapsulated to form multiple-emulsion droplets. Accordingly, additional methods of adding reagents to multiple-emulsion droplets are described below. For example, in some embodiments, reagents, such as detectable labels designed to detectably label a nucleic acid amplification product and/or nucleic acid synthesis reagents designed to produce a nucleic acid synthesis product, may be added to a multiple-emulsion droplet by adding the reagents to a miscible phase carrier fluid, e.g. the third fluid, wherein the reagents diffuse from the miscible phase carrier fluid, through the immiscible shell of the multiple-emulsion droplet, e.g. the second fluid, and into the first miscible phase fluid of the multiple-emulsion droplet, e.g. the first fluid.

In some embodiments, a multiple-emulsion droplet is a second multiple-emulsion droplet and a method of adding nucleic acid synthesis reagents to the second multiple-emulsion droplet includes encapsulating a nucleic acid, e.g., a target nucleic acid, in a first multiple-emulsion droplet, encapsulating synthesis reagents and the first multiple-emulsion droplet in the second-multiple emulsion droplet, and rupturing the first multiple-emulsion droplet thereby bringing the nucleic acid into contact with the synthesis reagents.

In some embodiments, a multiple-emulsion droplet is a second multiple-emulsion droplet and a method of adding nucleic acid synthesis reagents to the second multiple-emulsion droplet includes encapsulating nucleic acid synthesis reagents in a first multiple-emulsion droplet, encapsulating a nucleic acid, e.g., a target nucleic acid, and the first multiple-emulsion droplet in the second-multiple emulsion droplet, and rupturing the first multiple-emulsion droplet thereby bringing the nucleic acid into contact with the synthesis reagents.

In some embodiments, a multiple-emulsion droplet is a first multiple-emulsion droplet, and a suitable method includes adding a reagent to the first multiple-emulsion droplet by encapsulating the first multiple-emulsion droplet in a second multiple-emulsion droplet including the reagent and rupturing the first multiple-emulsion droplet within the second multiple-emulsion droplet to bring the reagent into contact with the contents of the first multiple-emulsion droplet.

In some embodiments, a multiple-emulsion droplet is a second multiple-emulsion droplet, and a suitable method includes adding a reagent to the second multiple-emulsion droplet by encapsulating a first multiple-emulsion droplet including the reagents in the second multiple-emulsion droplet and rupturing the first multiple-emulsion droplet within the second multiple-emulsion droplet to bring the reagent into contact with the contents of the second multiple-emulsion droplet.

### Tethering Moieties

In some embodiments, targets e.g., nucleic acid target molecules; nucleic acid synthesis reagents; and/or nucleic acid detection reagents are attached to the particles via one or more tethering moieties positioned on or in the particles. The tethering moieties can interact with the targets to be tethered. For example, the tethering moieties may be oligonucleotides with specific sequences which are bound on or in the particles. The specific oligonucleotides can hybridize to the targets in the fluids, e.g., through base-pairing and cross-linking.

In some embodiments, certain targets may be too large in size to move through the particles that contain functional groups for capturing the targets. In such cases, the tethering moieties may be functional particles that are encapsulated in the particles. For example, as the targets diffuse through the particles, they will come into contact with the functional particles, providing an opportunity to be captured. Even if the particles were absorbed in a miscible carrier fluid, the targets would remain tethered because they would be tethered to the particles trapped in or on the particles.

### Reactions in Monodispersed Droplets

The methods disclosed herein generally facilitate the performance of a large numbers of compartmentalized reactions and the subsequent reading and sorting of those reactions using a variety of detection methods, such as spectroscopy, chemical techniques, biological techniques, sequencing, etc. Reactions can include organic or inorganic reactions performed without biomolecules, or reactions involving biomolecules and/or cells, such as enzymatic reactions, for example, PCR. Reactions may also involve cellular materials or cell-based extracts, including transcription and translation extracts that can express DNA, RNA, and protein without the use of living cells. This can be used for synthetic biologic applications including, for example, screening a pathway for activity.

For example, a pathway implemented by one or more proteins can be encoded by nucleic acids encapsulated in monodispersed single-emulsion droplets or multiple-emulsion droplets, e.g., double emulsions with cell-free extracts capable of expressing the one or more pathway proteins. Assay components can also be included, allowing testing of the pathway. Based on the pathway activity and measurements of the assay, the reactors can be sorted to recover monodispersed single-emulsion droplets or multiple-emulsion droplets that happened to encapsulate particularly desirable pathways. After sorting they can be analyzed, amplified, etc., to continue the process, either to perform screens or, alternatively, to perform directed evolution and generate enhanced pathway sequences.

Reactions in the monodispersed single-emulsion droplets or multiple-emulsion droplets can also be used for applications, such as nucleic acid manipulations, including the generation of sequencing libraries with less bias or to combine molecules with specific features. For example, cells expressing specific gene sequences or nucleic acid synthesis and/or amplification products can be encapsulated in the monodispersed single-emulsion droplets or multiple-emulsion droplets and then subjected to the methods as described herein to isolate, amplify and link the sequences, generating a single molecule that can be analyzed or used in additional applications. For example, if the cells include human antibody generating cells, then the genes corresponding to the heavy and light chains of the cells can be linked together to create a single molecule that can be analyzed to detect the heavy and light chain pairing or to generate an antibody like molecule, such as an scFv or Fab.

### Detecting PCR Products

In practicing the subject methods, the manner in which nucleic acid synthesis and/or amplification products, e.g., isothermal nucleic acid amplification products or PCR products, can be detected may vary. For example, if the goal is simply to count the number of a particular cell type, e.g., tumor cells, present in a population, this may be achieved by using a simple binary assay in which SybrGreen, or any other stain and/or intercalating stain, is added to each monodispersed single-emulsion droplet or multiple-emulsion droplet so that in the event a characterizing gene, e.g., an oncogene, is present and PCR products are produced, the monodispersed single-emulsion droplet or multiple-emulsion droplet will become fluorescent. The change in fluorescence may be due to fluorescence polarization. The detection component may include the use of an intercalating stain (e.g., SybrGreen).

A variety of different detection components may be used in practicing the subject methods, including using fluorescent dyes known in the art. Fluorescent dyes may typically be divided into families, such as fluorescein and its derivatives; rhodamine and its derivatives; cyanine and its derivatives; coumarin and its derivatives; Cascade Blue and its derivatives; Lucifer Yellow and its derivatives; BODIPY and its derivatives; and the like. Exemplary fluorophores include indocarbocyanine (C3), indodicarbocyanine (C5), Cy3, Cy3.5, Cy5, Cy5.5, Cy7, Texas Red, Pacific Blue, Oregon Green 488, Alexa fluor-355, Alexa Fluor 488, Alexa Fluor 532, Alexa Fluor 546, Alexa Fluor-555, Alexa Fluor 568, Alexa Fluor 594, Alexa Fluor 647, Alexa Fluor 660, Alexa Fluor 680, JOE, Lissamine, Rhodamine Green, BODIPY, fluorescein isothiocyanate (FITC), carboxy-fluorescein (FAM), phycoerythrin, rhodamine, dichlororhodamine (dRhodamine), carboxy tetramethylrhodamine (TAMRA), carboxy-X-rhodamine (ROX), LIZ, VIC, NED, PET, SYBR, PicoGreen, RiboGreen, and the like. Descriptions of fluorophores and their use, can be found in, among other places, R. Haugland, Handbook of Fluorescent Probes and Research Products, 9th ed. (2002), Molecular Probes, Eugene, Oreg.; M. Schena, Microarray Analysis (2003), John Wiley & Sons, Hoboken, N.J.; Synthetic Medicinal Chemistry 2003/2004 Catalog, Berry and Associates, Ann Arbor, Mich.; G. Hermanson, Bioconjugate Techniques, Academic Press (1996); and Glen Research 2002 Catalog, Sterling, Va.

In other aspects, particularly if a goal is to further characterize the nucleic acids present, e.g., oncogenes, additional testing may be needed. For instance, in the case of the multiplex assays this may be achieved by having optical outputs that relate which of the gene(s) are amplified in the monodispersed single-emulsion droplet or multiple-emulsion droplet. An alternative approach would be to use a binary output, for example, with an intercalated stain, to determine which monodispersed single-emulsion droplets or multiple-emulsion droplets have any oncogenes. These can then be sorted to recover these droplets so that they could be analyzed in greater detail to determine which oncogenes they contain. To determine the oncogenes present in such a droplet, microfluidic techniques or nonmicrofluidic techniques could be used. Using non-microfluidic techniques, a droplet identified as containing an oncogene can be placed into a well on a well plate where it is diluted into a larger volume, releasing all of the PCR products that were created during the multiplexed PCR reaction. Samples from this well can then be transferred into other wells, into each of which would be added primers for one of the oncogenes. These wells would then be temperature-cycled to initiate PCR, at which point an intercalating stain would be added to cause wells that have matching oncogenes and primers to light up.

In practicing the subject methods, therefore, a component may be detected based upon, for example, a change in fluorescence. In certain aspects, the change in fluorescence is due to fluorescence resonance energy transfer (FRET). In this approach, a special set of primers may be used in which the 5′ primer has a quencher dye and the 3′ primer has a fluorescent dye. These dyes can be arranged anywhere on the primers, either on the ends or in the middles. Because the primers are complementary, they will exist as duplexes in solution, so that the emission of the fluorescent dye will be quenched by the quencher dye, since they will be in close proximity to one another, causing the solution to appear dark. After PCR, these primers will be incorporated into the long PCR products, and will therefore be far apart from one another. This will allow the fluorescent dye to emit light, causing the solution to become fluorescent. Hence, to detect if a particular oncogene is present, one may measure the intensity of the droplet at the wavelength of the fluorescent dye. To detect if different oncogenes are present, this would be done with different colored dyes for the different primers. This would cause the droplet to become fluorescent at all wavelengths corresponding to the primers of the oncogenes present in the cell.

### Detecting Cells (e.g., Tumor Cells) in Monodispersed Droplets

Aspects of the subject methods involve detecting the presence of one or more cells or subsets of cells (e.g., tumor cells) in a biological sample. Such methods may include, for example, steps of encapsulating and/or binding a cell in a monodispersed single-emulsion droplet or multiple-emulsion droplet; subjecting the monodispersed single-emulsion droplet or multiple-emulsion droplet to conditions sufficient to effect lysis of the cell in the monodispersed single-emulsion droplet or multiple-emulsion droplet; subjecting the monodispersed single-emulsion droplet or multiple-emulsion droplet to conditions sufficient to deactivate or remove one or more materials which have an inhibitory effect on nucleic acid amplification; introducing nucleic acid synthesis reagents, e.g., nucleic acid amplification reagents, into the monodispersed single-emulsion droplet or multiple-emulsion droplet; subjecting the monodispersed single-emulsion droplet or multiple-emulsion droplet to nucleic acid synthesis conditions, e.g., nucleic acid amplification conditions, sufficient to result in synthesis, e.g., amplification, of a target nucleic acid when present; and detecting an amplification or synthesis product resulting from the synthesis, e.g., amplification, of the target nucleic acid when present.

A biological sample (e.g., whole blood) may be recovered from a subject using any convenient means. The biological sample may be processed to remove components other than cells using, for example, processing steps such as centrifugation, filtration, and the like. Where desired, the cells may be stained with one or more antibodies and/or probes prior to encapsulating them into monodispersed single-emulsion droplets or multiple-emulsion droplets.

One or more lysing agents may also be added to the monodispersed single-emulsion droplets or multiple-emulsion droplets containing a cell, under conditions in which the cell(s) may be caused to burst, thereby releasing their genomes. The lysing agents may be added after the cells are encapsulated into monodispersed single-emulsion droplets or multiple-emulsion droplets. Any convenient lysing agent may be employed, such as proteinase K or cytotoxins. In particular embodiments, cells may be co-encapsulated in monodispersed single-emulsion droplets or multiple-emulsion droplets with lysis buffer containing detergents such as Triton X-100 and/or proteinase K. The specific conditions in which the cell(s) may be caused to burst will vary depending on the specific lysing agent used. For example, if proteinase K is incorporated as a lysing agent, the monodispersed single-emulsion droplets or multiple-emulsion droplets may be heated to about 37-60° C. for about 20 min to lyse the cells and to allow the proteinase K to digest cellular proteins, after which they may be heated to about 95° C. for about 5-10 min to deactivate the proteinase K.

In certain aspects, cell lysis may also, or instead, rely on techniques that do not involve addition of lysing agent. For example, lysis may be achieved by mechanical techniques that may employ various geometric features to effect piercing, shearing, abrading, etc. of cells. Other types of mechanical breakage such as acoustic techniques may also be used. Further, thermal energy can also be used to lyse cells. Any convenient means of effecting cell lysis may be employed in the methods described herein.

Primers may be introduced into the monodispersed single-emulsion droplets or multiple-emulsion droplets for each of the genes and/or genetic markers, e.g., oncogenes, to be detected. Hence, in certain aspects, primers for a variety of genes and/or genetic markers, e.g., all oncogenes may be present in the monodispersed single-emulsion droplets or multiple-emulsion droplets at the same time, thereby providing a multiplexed assay. The droplets may be temperature-cycled so that the droplets containing target cells, e.g., cancerous cells, will undergo PCR. Alternatively, or in addition, MDA or other isothermal nucleic acid amplification methods may be utilized, e.g., loop-mediated isothermal nucleic acid amplification (LAMP), strand displacement amplification (SDA), helicase-dependent amplification (HDA), and nicking enzyme amplification reaction (NEAR). Only the primers corresponding to oncogenes and/or genetic markers present in the genome will induce amplification, creating many copies of these oncogenes and/or genetic markers in the droplets. Detecting the presence of these amplification products may be achieved by a variety of ways, such as by using FRET, staining with an intercalating dye, or attaching them to a particle. The droplets may be optically probed to detect the amplification products. In some embodiments, optically probing the droplets may involve counting the number of tumor cells present in the initial population, and/or allowing for the identification of the oncogenes present in each tumor cell.

The subject methods may be used to determine whether a biological sample contains particular cells of interest, e.g., tumor cells, or not. In certain aspects, the subject methods may include quantifying the number of cells of interest, e.g., tumor cells, present in a biological sample. Quantifying the number of cells of interest, e.g., tumor cells, present in a biological sample may be based at least in part on the number of droplets in which amplification products were detected. For example, droplets may be produced under conditions in which the majority of droplets are expected to contain zero or one cell. Those droplets that do not contain any cells may be removed, using techniques described more fully herein. After performing the PCR steps outlined above, the total number of droplets that are detected to contain amplification products may be counted, so as to quantify the number of cells of interest, e.g., tumor cells, in the biological sample. In certain aspects, the methods may also include counting the total number of droplets so as to determine the fraction or percentage of cells from the biological sample that are cells of interest, e.g., tumor cells.

In some embodiments, the introduction of synthesis reagents into multiple-emulsion droplets, prepared from monodispersed droplets as described herein includes introducing the synthesis reagents into the third fluid, wherein the synthesis reagents diffuse from the third fluid, through the immiscible shell, and into the first fluid of the multiple-emulsion droplets.

The cells and/or cellular material of interest may be recovered by sorting the monodispersed single-emulsion droplets or multiple-emulsion droplets and recovering their contents via droplet rupture, e.g., through chemical, electrical, or mechanical means as described in greater detail herein. A variety of suitable sorting techniques and related devices may be utilized to sort and separate the monodispersed single-emulsion droplets or multiple-emulsion droplets containing amplification and/or synthesis products including those described herein.

### Nucleic Acid Detection in Monodispersed Droplets

As discussed herein, the disclosed methods find use in the detection of nucleic acids, e.g., DNA or RNA, of interest from a variety of biological samples. Such methods may include, for example, steps of encapsulating a nucleic acid and synthesis reagents in a monodispersed single-emulsion droplet or multiple-emulsion droplet; subjecting the monodispersed single-emulsion droplet or multiple-emulsion droplet to amplification conditions sufficient to result in amplification of the nucleic acid; and detecting an amplification product resulting from the amplification of the nucleic acid. The amplification conditions may be MDA conditions and/or PCR conditions e.g., RT-PCR conditions, and/or additional isothermal nucleic acid amplification conditions, e.g., loop-mediated isothermal nucleic acid amplification (LAMP), strand displacement amplification (SDA), helicase-dependent amplification (HDA), and nicking enzyme amplification reaction (NEAR).

The nucleic acids of interest may be recovered by sorting the monodispersed single-emulsion droplets or multiple-emulsion droplets and recovering their contents via droplet rupture, e.g., through chemical, electrical, or mechanical means as described in greater detail herein. A variety of suitable sorting techniques and related devices may be utilized to sort and separate the monodispersed single-emulsion droplets or multiple-emulsion droplets containing amplification products including those described herein. In one aspect, a method for enriching for a target nucleic acid sequence is provided, wherein the method includes encapsulating a sample including nucleic acids in a plurality of monodispersed single-emulsion droplets or multiple-emulsion droplets; introducing MDA reagents and polymerase chain reaction (PCR) reagents and a plurality of suitable primers into the monodispersed single-emulsion droplets or multiple-emulsion droplets; incubating the monodispersed single-emulsion droplets or multiple-emulsion droplets under conditions sufficient for MDA amplification and conditions sufficient for PCR amplification to produce MDA amplification products and PCR amplification products, respectively, wherein suitable PCR primers may include one or more primers that each hybridize to one or more oligonucleotides incorporating the target nucleic acid sequence, and wherein the PCR amplification products do not include the entire target nucleic acid sequence; introducing a detection component into the monodispersed single-emulsion droplets or multiple-emulsion droplets either before or after the incubating; detecting the presence or absence of the PCR amplification products by detection of the detection component, wherein detection of the detection component indicates the presence of PCR amplification products and the target nucleic acid sequence; and sorting the monodispersed single-emulsion droplets or multiple-emulsion droplets based on detection of the detection component, wherein the sorting separates monodispersed single-emulsion droplets or multiple-emulsion droplets including the PCR amplification products and the target nucleic acid sequence, when present, from monodispersed single-emulsion droplets or multiple-emulsion droplets which do not include the PCR amplification products and the target nucleic acid sequence; and pooling the nucleic acid sequences from the sorted monodispersed single-emulsion droplets or multiple-emulsion droplets to provide an enriched pool of target nucleic acid sequences, when present. One or more of these steps may be performed under microfluidic control.

The above method allows, for example, for the enrichment of DNA molecules out of a heterogeneous system based on the presence of PCR-detectable subsequences. The DNA molecules can be short (e.g., hundreds of bases) or long (e.g., megabases or longer). The sample may be encapsulated in monodispersed droplets such that target molecules are detected in the droplets digitally—i.e., each droplet contains 0 or 1 target molecule. The monodispersed droplets may then be sorted based on, e.g., fluorescence, to recover the target molecules. This method can be used to enrich for a large genomic region, e.g., on the order of megabases in length, in a heterogeneous sample of DNA fragments.

The above method enables a sufficient amount of DNA to be recovered without the need to perform PCR to amplify the DNA for sequencing. Amplification-free DNA sample prep is valuable, for example, where PCR does not preserve the sequences or epigenetic factors of interest, or cannot recover sequences that are of the needed length (e.g., greater than about 10 kb, the practical limit of long-range PCR).

Another application of the above method is to enrich DNA for epigenetic sequencing. Epigenetic marks on DNA are not preserved by PCR, so sequencing them requires unamplified DNA from the host nucleic acids. With the above method, a sufficient amount of DNA can be obtained for sequencing without needing to perform PCR, and thus preserving the epigenetic marks.

The above methods have particular utility where the length of the target nucleic acid exceeds the practical limits of long-range PCR, e.g., where the nucleic acid is greater than about 10 kb, and/or where it is desirable to preserve epigenetic marks on the DNA. In some embodiments, the target nucleic acid to be enriched is greater than about 100 kb in length, e.g., greater than about 1 megabase in length. In some embodiments, the target nucleic acid to be enriched is from about 10 kb to about 100 kb, from about 100 kb to about 500 kb, or from about 500 kb to about lmegabase in length.

Post-amplification and/or purification, emulsions can be broken using both chemical and osmotic means for future analysis. For example, an equal volume of 1H, 1H, 2H, 2H-Perfluoro-1-octanol can be added to a purified sample and mixed either through pipetting or vortexing. The resulting mixture can then be allowed to equilibrate, and the aqueous layer can be eluted off for further analysis. Similarly, a large excess of purified water can be added to the sample post-sort, mixed, and allowed to incubate at room temperature for several hours. The resulting mixture can then be analyzed directly for purified sample of interest.

### Multiple Displacement Amplification

As summarized above, in practicing methods of the invention MDA may be used to amplify nucleic acids, e.g., genomic DNA, in a generally unbiased and non-specific manner for downstream analysis, e.g., via next generation sequencing.

An exemplary embodiment of a method as described herein includes encapsulating in a monodispersed droplet (e.g., monodispersed single-emulsion droplet or multiple emulsion monodispersed droplet) a nucleic acid template molecule obtained from a biological sample, introducing MDA reagents and a plurality of MDA primers into the monodispersed droplet, and incubating the monodispersed droplet under conditions effective for the production of MDA amplification products, wherein the incubating is effective to produce MDA amplification products from the nucleic acid template molecule. In some embodiments the encapsulating and introducing steps occur as a single step, e.g., where the nucleic acid template molecule is mixed with MDA reagents and a plurality of MDA primers, and emulsified, e.g., using a flow focusing element of a microfluidic device.

The conditions of MDA-based assays described herein may vary in one or more ways. For instance, the number of MDA primers that may be added to (or encapsulated in) a monodispersed droplet may vary. The term “primer” refers to one or more primers and refers to an oligonucleotide, whether occurring naturally, as in a purified restriction digest, or produced synthetically, which is capable of acting as a point of initiation of synthesis along a complementary strand when placed under conditions in which synthesis of a primer extension product which is complementary to a nucleic acid strand is catalyzed. Such conditions include the presence of four different deoxyribonucleoside triphosphates and a polymerization-inducing agent such as a suitable DNA polymerase (e.g., Φ29 DNA polymerase or Bst DNA polymerase), in a suitable buffer (“buffer” includes substituents which are cofactors, or which affect pH, ionic strength, etc.), and at a suitable temperature. The primer is preferably single-stranded for maximum efficiency in amplification. In the context of MDA, random hexamer primers are regularly utilized.

The complement of a nucleic acid sequence as used herein refers to an oligonucleotide which, when aligned with the nucleic acid sequence such that the 5′ end of one sequence is paired with the 3′ end of the other, is in “antiparallel association.” Complementarity need not be perfect; stable duplexes may contain mismatched base pairs or unmatched bases. Those skilled in the art of nucleic acid technology can determine duplex stability empirically considering a number of variables including, for example, the length of the oligonucleotide, percent concentration of cytosine and guanine bases in the oligonucleotide, ionic strength, and incidence of mismatched base pairs.

The number of MDA primers that may be added to (or encapsulated in) a monodispersed droplet may range from about 1 to about 500 or more, e.g., about 2 to 100 primers, about 2 to 10 primers, about 10 to 20 primers, about 20 to 30 primers, about 30 to 40 primers, about 40 to 50 primers, about 50 to 60 primers, about 60 to 70 primers, about 70 to 80 primers, about 80 to 90 primers, about 90 to 100 primers, about 100 to 150 primers, about 150 to 200 primers, about 200 to 250 primers, about 250 to 300 primers, about 300 to 350 primers, about 350 to 400 primers, about 400 to 450 primers, about 450 to 500 primers, or about 500 primers or more.

Such primers and/or reagents may be added to a monodispersed droplet in one step, or in more than one step. For instance, the primers may be added in two or more steps, three or more steps, four or more steps, or five or more steps. Where a lysing agent is utilized, regardless of whether the primers are added in one step or in more than one step, they may be added after the addition of a lysing agent, prior to the addition of a lysing agent, or concomitantly with the addition of a lysing agent. When added before or after the addition of a lysing agent, the MDA primers may be added in a separate step from the addition of a lysing agent.

Once primers have been added to a monodispersed droplet, the monodispersed droplet may be incubated under conditions sufficient for MDA. The monodispersed droplet may be incubated on the same microfluidic device as was used to add the primer(s), or may be incubated on a separate device. In certain embodiments, incubating the monodispersed droplet under conditions sufficient for MDA amplification is performed on the same microfluidic device used for cell lysis. Incubating the monodispersed droplets may take a variety of forms, for example monodispersed droplets may be incubated at a constant temperature, e.g., 30° C., e.g., for about 8 to about 16 hours. Alternatively, cycles of 25° C. for 5 minutes followed by 42° C. for 25 minutes may be utilized.

Although the methods described herein for producing MDA amplification products do not require the use of specific probes, the methods of the invention may also include introducing one or more probes to the monodispersed droplet. As used herein with respect to nucleic acids, the term “probe” generally refers to a labeled oligonucleotide which forms a duplex structure with a sequence in the target nucleic acid, due to complementarity of at least one sequence in the probe with a sequence in the target region. The probe, preferably, does not contain a sequence complementary to sequence(s) used to prime the MDA reaction. The number of probes that are added may be from about one to 500, e.g., about 1 to 10 probes, about 10 to 20 probes, about 20 to 30 probes, about 30 to 40 probes, about 40 to 50 probes, about 50 to 60 probes, about 60 to 70 probes, about 70 to 80 probes, about 80 to 90 probes, about 90 to 100 probes, about 100 to 150 probes, about 150 to 200 probes, about 200 to 250 probes, about 250 to 300 probes, about 300 to 350 probes, about 350 to 400 probes, about 400 to 450 probes, about 450 to 500 probes, or about 500 probes or more. The probe(s) may be introduced into the monodispersed droplet prior to, subsequent with, or after the addition of the one or more primer(s).

In certain embodiments, an MDA based assay may be used to detect the presence of certain RNA transcripts present in cells or to sequence the genome of one or more RNA viruses. In such embodiments, MDA reagents may be added to the monodispersed droplet using any of the methods described herein. Prior to or after addition (or encapsulation) of the MDA reagents, the monodispersed droplet may be incubated under conditions allowing for reverse transcription followed by conditions allowing for MDA as described herein. The monodispersed droplet may be incubated on the same microfluidic device as is used to add the MDA reagents, or may be incubated on a separate device. In certain embodiments, incubating the monodispersed droplet under conditions allowing for MDA is performed on the same microfluidic device used to encapsulate and/or lyse one or more cells.

In certain embodiments, the reagents added to the monodispersed droplet for MDA further includes a fluorescent DNA probe capable of detecting MDA amplification products. Any suitable fluorescent DNA probe can be used including, but not limited to SYBR Green, TaqMan®, Molecular Beacons and Scorpion probes. In certain embodiments, the reagents added to the monodispersed droplet include more than one DNA probe, e.g., two fluorescent DNA probes, three fluorescent DNA probes, or four fluorescent DNA probes. The use of multiple fluorescent DNA probes allows for the concurrent measurement of MDA amplification products in a single reaction.

### PCR

As summarized above, in practicing methods of the invention a PCR-based assay may be used to detect the presence of certain nucleic acids of interest, e.g., genes of interest and/or genetic markers, e.g., oncogene(s), present in cells or a heterogeneous sample of nucleic acids. Such PCR based assays may be performed in the same monodispersed droplet, e.g., monodispersed single-emulsion droplet or multiple emulsion monodispersed droplet as a previous or subsequent MDA amplification step. In other embodiments, PCR reactions may be conducted in monodispersed droplets independently. The conditions of such PCR-based assays may vary in one or more ways.

For instance, the number of PCR primers that may be added to a monodispersed single-emulsion droplet or multiple-emulsion droplet may vary. The term “primer” may refer to more than one primer and refers to an oligonucleotide, whether occurring naturally, as in a purified restriction digest, or produced synthetically, which is capable of acting as a point of initiation of synthesis along a complementary strand when placed under conditions in which synthesis of a primer extension product which is complementary to a nucleic acid strand is catalyzed. Such conditions include the presence of four different deoxyribonucleoside triphosphates and a polymerization-inducing agent such as DNA polymerase or reverse transcriptase, in a suitable buffer (“buffer” includes substituents which are cofactors, or which affect pH, ionic strength, etc.), and at a suitable temperature. The primer is preferably single-stranded for maximum efficiency in amplification.

The complement of a nucleic acid sequence as used herein refers to an oligonucleotide which, when aligned with the nucleic acid sequence such that the 5′ end of one sequence is paired with the 3′ end of the other, is in “antiparallel association.” Complementarity need not be perfect; stable duplexes may contain mismatched base pairs or unmatched bases. Those skilled in the art of nucleic acid technology can determine duplex stability empirically considering a number of variables including, for example, the length of the oligonucleotide, percent concentration of cytosine and guanine bases in the oligonucleotide, ionic strength, and incidence of mismatched base pairs.

The number of PCR primers that may be added to a monodispersed single-emulsion droplet or multiple-emulsion droplet may range from about 1 to about 500 or more, e.g., about 2 to 100 primers, about 2 to 10 primers, about 10 to 20 primers, about 20 to 30 primers, about 30 to 40 primers, about 40 to 50 primers, about 50 to 60 primers, about 60 to 70 primers, about 70 to 80 primers, about 80 to 90 primers, about 90 to 100 primers, about 100 to 150 primers, about 150 to 200 primers, about 200 to 250 primers, about 250 to 300 primers, about 300 to 350 primers, about 350 to 400 primers, about 400 to 450 primers, about 450 to 500 primers, or about 500 primers or more.

These primers may contain primers for one or more gene of interest, e.g. oncogenes. The number of primers for genes of interest that are added may be from about one to 500, e.g., about 1 to 10 primers, about 10 to 20 primers, about 20 to 30 primers, about 30 to 40 primers, about 40 to 50 primers, about 50 to 60 primers, about 60 to 70 primers, about 70 to 80 primers, about 80 to 90 primers, about 90 to 100 primers, about 100 to 150 primers, about 150 to 200 primers, about 200 to 250 primers, about 250 to 300 primers, about 300 to 350 primers, about 350 to 400 primers, about 400 to 450 primers, about 450 to 500 primers, or about 500 primers or more. Genes and oncogenes of interest include, but are not limited to, BAX, BCL2L1, CASP8, CDK4, ELK1, ETS1, HGF, JAK2, JUNB, JUND, KIT, KITLG, MCL1, MET, MOS, MYB, NFKBIA, EGFR, Myc, EpCAM, NRAS, PIK3CA, PML, PRKCA, RAF1, RARA, REL, ROS1, RUNX1, SRC, STAT3, CD45, cytokeratins, CEA, CD133, HER2, CD44, CD49f, CD146, MUC1/2, and ZHX2.

Such primers and/or reagents may be added to a monodispersed single-emulsion droplet or multiple-emulsion droplet in one step, or in more than one step. For instance, the primers may be added in two or more steps, three or more steps, four or more steps, or five or more steps. Regardless of whether the primers are added in one step or in more than one step, they may be added after the addition of a lysing agent, prior to the addition of a lysing agent, or concomitantly with the addition of a lysing agent. When added before or after the addition of a lysing agent, the PCR primers may be added in a separate step from the addition of a lysing agent.

Once primers have been added to a monodispersed single-emulsion droplet or multiple-emulsion droplet the monodispersed single-emulsion droplet or multiple-emulsion monodispersed droplet may be incubated under conditions allowing for PCR. The monodispersed single-emulsion droplet or multiple-emulsion droplet may be incubated on the same microfluidic device as was used to add the primer(s), or may be incubated on a separate device. In certain embodiments, incubating the monodispersed single-emulsion droplet or multiple-emulsion droplet under conditions allowing for PCR amplification is performed on the same microfluidic device used to encapsulate and lyse cells. Incubating the monodispersed single-emulsion droplet or multiple-emulsion droplet may take a variety of forms. In certain aspects, the monodispersed single-emulsion droplet or multiple-emulsion droplet containing the PCR mix may be flowed through a channel that incubates the monodispersed droplets under conditions effective for PCR. In some embodiments, PCR reactions are performed without the use of microfluidic devices and/or systems. Flowing the monodispersed single-emulsion droplet or multiple-emulsion droplet through a channel may involve a channel that snakes over various temperature zones maintained at temperatures effective for PCR. Such channels may, for example, cycle over two or more temperature zones, wherein at least one zone is maintained at about 65° C. and at least one zone is maintained at about 95° C. Alternatively, zones for 86° C., 60° C. and 20° C. may be utilized. As the monodispersed single-emulsion droplets or multiple-emulsion move through such zones, their temperature cycles, as needed for PCR. The precise number of zones, and the respective temperature of each zone, may be readily determined by those of skill in the art to achieve the desired PCR amplification.

In other embodiments, incubating the monodispersed single-emulsion droplets or multiple-emulsion droplets may involve the use of a Megadroplet Array. In such a device, an array of hundreds, thousands, or millions of traps indented into a channel (e.g., a PDMS channel) sit above a thermal system. The channel may be pressurized, thereby preventing gas from escaping. The height of the microfluidic channel is smaller than the diameter of the monodispersed single-emulsion droplets or multiple-emulsion droplets, causing monodispersed single-emulsion droplets or multiple-emulsion droplets to adopt a flattened pancake shape. When a monodispersed single-emulsion droplet or multiple-emulsion droplet flows over an unoccupied indentation, it adopts a lower, more energetically favorable, radius of curvature, leading to a force that pulls the monodispersed single-emulsion droplets or multiple-emulsion droplet entirely into the trap. By flowing monodispersed single-emulsion droplets or multiple-emulsion droplets as a close pack, it is ensured that all traps on the array are occupied. The entire device may be thermal cycled using a heater.

In certain aspects, the heater includes a Peltier plate, heat sink, and control computer. The Peltier plate allows for the heating or cooling of the chip above or below room temperature by controlling the applied current. To ensure controlled and reproducible temperature, a computer may monitor the temperature of the array using integrated temperature probes, and may adjust the applied current to heat and cool as needed. A metallic (e.g. copper) plate allows for uniform application of heat and dissipation of excess heat during cooling cycles, enabling cooling from about 95° C. to about 60° C. in under about one minute.

Methods of the invention may also include introducing one or more probes to the monodispersed single-emulsion droplets or multiple-emulsion droplets. As used herein with respect to nucleic acids, the term “probe” refers to a labeled oligonucleotide which forms a duplex structure with a sequence in the target nucleic acid, due to complementarity of at least one sequence in the probe with a sequence in the target region. In some embodiments, the probe does not contain a sequence complementary to sequence(s) used to prime the polymerase chain reaction. The number of probes that are added may be from about one to 500, e.g., about 1 to 10 probes, about 10 to 20 probes, about 20 to 30 probes, about 30 to 40 probes, about 40 to 50 probes, about 50 to 60 probes, about 60 to 70 probes, about 70 to 80 probes, about 80 to 90 probes, about 90 to 100 probes, about 100 to 150 probes, about 150 to 200 probes, about 200 to 250 probes, about 250 to 300 probes, about 300 to 350 probes, about 350 to 400 probes, about 400 to 450 probes, about 450 to 500 probes, or about 500 probes or more. The probe(s) may be introduced into the monodispersed single-emulsion droplets or multiple-emulsion droplets prior to, subsequent with, or after the addition of the one or more primer(s). Probes of interest include, but are not limited to, TaqMan® probes (e.g., as described in Holland, P. M.; Abramson, R. D.; Watson, R.; Gelfand, D. H. (1991), “Detection of specific polymerase chain reaction product by utilizing the 5′—3′ exonuclease activity of Thermus aquaticus DNA polymerase”, PNAS, 88(16): 7276-7280).

In certain embodiments, an RT-PCR based assay may be used to detect the presence of certain transcripts of interest, e.g., oncogene(s), present in cells. In such embodiments, reverse transcriptase and any other reagents necessary for cDNA synthesis are added to the monodispersed single-emulsion droplets or multiple-emulsion droplets in addition to the reagents used to carry out PCR described herein (collectively referred to as the “RT-PCR reagents”). The RT-PCR reagents are added to the monodispersed single-emulsion droplets or multiple-emulsion droplets using any of the suitable methods described herein. Once reagents for RT-PCR have been added to a monodispersed single-emulsion droplet or multiple-emulsion droplet, the monodispersed single-emulsion droplet or multiple-emulsion droplet may be incubated under conditions allowing for reverse transcription followed by conditions allowing for PCR as described herein. The monodispersed single-emulsion droplet or multiple-emulsion droplet may be incubated on the same microfluidic device as was used to add the RT-PCR reagents, or may be incubated on a separate device. In certain embodiments, incubating the monodispersed single-emulsion droplet or multiple-emulsion droplet under conditions allowing for RT-PCR is performed on the same microfluidic device used to encapsulate and lyse cells.

In certain embodiments, the reagents added to the monodispersed single-emulsion droplet or multiple-emulsion droplet for RT-PCR or PCR further includes a fluorescent DNA probe capable of detecting RT-PCR or PCR products. Any suitable fluorescent DNA probe can be used including, but not limited to SYBR Green, TaqMan®, Molecular Beacons and Scorpion probes. In certain embodiments, the reagents added to the monodispersed single-emulsion droplets or multiple-emulsion droplet include more than one DNA probe, e.g., two fluorescent DNA probes, three fluorescent DNA probes, or four fluorescent DNA probes. The use of multiple fluorescent DNA probes allows for the concurrent measurement of RT-PCR or PCR products in a single reaction.

### Double PCR

To amplify rare transcripts, a monodispersed single-emulsion droplet, a multiple-emulsion droplet that has undergone a first-step RT-PCR or PCR reaction as described herein may be further subjected to a second step PCR reaction. In some embodiments, a first monodispersed single-emulsion droplet or multiple-emulsion droplet that has undergone a first-step RT-PCR or PCR reaction is encapsulated in a second single-emulsion droplet or multiple-emulsion droplet containing additional PCR reagents, including, but not limited to enzymes (e.g. DNA polymerase), DNA probes (e.g. fluorescent DNA probes) and primers, followed by rupture of the first monodispersed single-emulsion droplet or multiple-emulsion droplet. In certain embodiments, the second single-emulsion droplet or multiple-emulsion droplet containing the additional PCR reagents is larger than the monodispersed droplet that has undergone the first step RT-PCR or PCR reaction. This may be beneficial, for example, because it allows for the dilution of cellular components that may be inhibitory to the second step PCR. The second step PCR reaction may be carried out on the same microfluidic device used to carry out the first-step reaction, on a different microfluidic device, or without the use of a microfluidic device.

In some embodiments, the primers used in the second step PCR reaction are the same primers used in the first step RT-PCR or PCR reaction. In other embodiments, the primers used in the second step PCR reaction are different than the primers used in the first step reaction.

### Digital PCR

The methods described herein can be used to quantitate nucleic acids using, for example, digital PCR. In digital PCR, target nucleic acids from a solution are diluted such that, when the sample is isolated in droplets, most droplets encapsulate either zero or one target molecule, although higher loading rates can often be used, provided they can be modeled. Reagents sufficient for amplification of the target nucleic acids are also included in the droplets, and the droplets subjected to conditions suitable for amplification. In some embodiments, the sample is compartmentalized in monodispersed single-emulsion droplets or multiple-emulsion monodispersed droplets, e.g., double emulsions, and the monodispersed single-emulsion droplets or multiple-emulsion monodispersed droplets, e.g., double emulsions, are subjected to amplification conditions. Droplets that contain a target undergo amplification, while those that do not, do not undergo amplification, and therefore do not yield nucleic acid amplification products. If a detection component is included, single or multiple emulsions that include the target may fill with a detectable signal, allowing them to be identified by, for example, imaging or flow dropometry. A powerful advantage of using double emulsions to perform such digital PCR is that the double emulsions can be suspended in an aqueous carrier phase that is miscible with the partitioned sample, and can therefore readily be detected and/or sorted using commercially available flow cytometers and fluorescence activated cell sorters (FACS). This allows for enrichments of target entities out of a sample that is not possible with other methods in which sorting is not easily accomplished.

In some embodiments, the disclosed methods can be used to quantitate nucleic acids in solution by counting the fraction of single or multiple emulsions that are fluorescent and undergo amplification and thus contain at least a single target nucleic acid, in most instances; false amplification may occur for stochastic reasons or, for example, the encapsulation of dust or other contaminants that interfere with the specificity of the amplification reaction. TaqMan® probes, molecular beacons, SYBR, and other kinds of detection components can also be included, allowing the use of multiple optical spectra for simultaneously detecting the amplification of different nucleic acid sequences in the target or due to multiple targets being encapsulated in the same monodispersed single-emulsion droplets or multiple-emulsion monodispersed droplets, e.g., double emulsions, which may be advantageous in some instances.

Like other PCR analysis methods, dPCR can be multiplexed using probes labeled with different fluorescent dyes. Since dPCR acts on molecules in droplets, this provides unique measurement opportunities not possible with common methods, like the physical association of distinct sequences. This is valuable for a variety of important applications in genomic biology, including characterizing virus diversity, phasing microbial genomes, haplotyping cancer genomes, measuring mRNA splice forms, and characterizing length distributions of target molecules in solution.

### RNA Sequencing (RNAseq)

The methods disclosed herein can be used for single cell encapsulation and RNAseq. RNAseq utilizes the massive parallel sequencing made possible by next generation sequencing (NGS) technologies, another way to approach the enumeration of RNA transcripts in a tissue sample. Specifically, RNAseq can be used to study phenomena such as gene expression changes, alternative splicing events, allele-specific gene expression, and chimeric transcripts, including gene fusion events, novel transcripts and RNA editing. Complementary DNA (cDNA) may be recovered from the monodispersed emulsions and standard in vitro transcription and library preparation for NGS performed to collect the data of single cell gene expression profile analysis.

### Measuring Lengths of Nucleic Acids

The methods described herein can be used to measure the length distributions of nucleic acids in solution. This may be accomplished by designing probe sequences that anneal to the target nucleic acids at different regions of known distance along their lengths. The probes can then be mixed with the target nucleic acids and compartmentalized in monodispersed single-emulsion droplets or multiple-emulsion droplets. Each monodispersed single-emulsion droplet or multiple-emulsion droplets, may contain, for example, two primer and probe sets that signal the presence of two different regions on the target a known distance apart. This can be repeated for different combinations of probes such that different pairs probe different distances and different regions of the target. The samples can be subjected to amplification, analysis, and sorting, if desired. In the analysis, one will find that some monodispersed single-emulsion droplets or multiple-emulsion droplets undergo amplification only with one of the probes while others, for example, amplify with only the other probe. This suggests that in these single-emulsion droplets or multiple-emulsion droplets, one type contains the region just for one of the probes, while the other type contains the region of the other probe. In this population, there may also be single-emulsion droplets or multiple-emulsion droplets, that undergo amplification with both probes, indicating that the target nucleic acid therein contained both regions. In this same suspension will be a large number of single-emulsion droplets or multiple-emulsion droplets including a measurable fraction of each of the three types of droplets—in addition to ones that, of course, undergo no amplification and, thus, presumably, do not contain the targeted regions. This data can be used to infer the lengths of the nucleic acids in solution.

For example, if the nucleic acids in solution are largely intact as whole molecules, than the majority of droplets undergoing amplification will exhibit amplification with both probe and primer sets and will thus show a mixed signal. By contrast, if the nucleic acid targets are highly fragmented, most of the detection events will be one or the other probe, with only rare instances of both probes. Since the distances between the probes may be known, this allows one to estimate the lengths and fragmentation of the molecules in the solution. This process can be repeated with different probe sets targeting different regions and/or having different distances between them, to more fully characterize the fragmentation of the target nucleic acids.

### Microfluidic Enrichment for Sequence Analysis (MESA) in Monodispersed Droplets

The methods described herein can be used to perform microfluidic enrichment for sequence analysis (MESA) of target nucleic acids. This is accomplished by using the method to encapsulate target nucleic acids in monodispersed single-emulsion droplets or multiple-emulsion droplets and perform amplification in those droplets, yielding fluorescent signals when the droplets contain a target sequence. These droplets can then be sorted, thereby enriching the nucleic acids in the sorted pool. The reaction may also be multiplexed, if desired, to differentiate between molecules that contain multiple, distinct subsequences. Amplification may also be used to amplify the sorted nucleic acids either prior to, simultaneous with, or post sorting, so as to enable sequencing.

A key advantage of this approach is that the region that is amplified in the droplets can be used simply as a “detection region”—the amplicons need not include the molecules that are subjected to sequencing. Instead, they signal when a target molecule is present in a droplet so that the whole molecule can be recovered for downstream analysis. This is powerful because it allows a large nucleic acid, even one that is far too large to be efficiently amplified, to be recovered for downstream analysis. For example, suppose that there exists a gene that is thought to be part of an important biological pathway, e.g., signaling cascade, in a microorganism that is as yet still undiscovered. The goal is to recover the genes encoding the proteins involved in this pathway so that they can be sequenced and studied. This cannot easily be accomplished using existing enrichment methods since the microbe, being unknown may not be specifically cultivable and, in addition, the pathway, being largely of unknown sequence, cannot be purified using hybridization probes, since sequences for the probes to hybridize to are not known aside from the individual gene, which may be too small to pull out the entire pathway. However, this can be accomplished using the MESA method as described herein.

In some embodiments, the nucleic acids from the target may be fragmented to a size large enough to encapsulate the entire pathway, such as, for example tens or hundreds of kilobases, or even megabases or longer fragments. If the pathway exists within a fragment, it may contain the known gene. The fragmented nucleic acids, most of which do not contain the target, are subjected to the techniques described herein resulting in monodispersed single-emulsion droplets, that, for the most part, do not contain a pathway and thus exhibit no amplification, while rare drops that do contain the pathway, undergo amplification. The positive droplets can then be recovered by, for example, FACS sorting double emulsions that are fluorescently bright. These can then be subjected to further manipulations such as, if necessary, specific and non-specific amplification, quantitation through digital or quantitative PCR, and DNA sequencing. A powerful advantage of MESA over other enrichment strategies is that it allows very large nucleic acids, even up to the size of an entire genome, to be detected and recovered based on a short, known sequence of only tens of hundreds of base pairs. Few other enrichment methodologies have the ability to enrich such large nucleic acid sequences out of a heterogeneous pool using such limited amounts of information about the sequence.

The method can also be used to identify the DNA sequences of individual genomes. In this embodiment, nucleic acids from a target can be fragmented and encapsulated in monodispersed single-emulsion droplets or multiple-emulsion droplets with PCR reagents and primers specific to the DNA sequence of interest. After amplification, the positive monodispersed single-emulsion droplets or multiple-emulsion droplets can be sorted into individual compartments, such as well plate arrays, using FACS or MACS. Individual compartments can then be subjected to further manipulation, such as either specific or non-specific amplification. The resulting amplicons can then be used to make libraries for next generation sequencing techniques, or as material used directly in Sanger sequencing. This technique would be useful, for example, in a method designed to identify genetic differences in a retroviral population, such as HIV, found in an individual patient.

As discussed above, methods described herein can be used for digital PCR and, related, microfluidic enrichment for sequencing analysis (MESA). In some embodiments, a sample including nucleic acids, viruses, cells, particles, etc., is partitioned in single or multiple emulsions as described herein. The droplets are collected into a reservoir, such as a PCR tube, and incubated under conditions suitable for amplification such as thermal cycling. Isothermal methods can also be used, such as MDA, MALBAC, LAMP, etc. A fluorescent reporter can be included in the droplets or added to the carrier phase to induce a difference in fluorescence between droplets containing the target nucleic acids and droplets which do not contain the target nucleic acids.

For example Sybr green can be added to the carrier phase such that it partitions into the single or multiple emulsion. Since Sybr becomes much more fluorescent in the presence of double stranded DNA, droplets that undergo amplification will be fluorescently brighter than those that do not. To quantitate the number of target molecules in the sample, the droplets can be subjected to flow cytometric analysis, or even fluorescence activated cell sorting (FACS).

As the droplets flow through the flow cytometer, information about their size and fluorescence can be recorded. In the instance that the target molecules are loaded at limiting dilution, some droplets will be detected as fluorescent, because they contained a target molecule, and others will be detected as dim, because they do not. The fraction of bright-to-dim droplets can be used, in accordance with a Poisson distribution to estimate the starting concentration of the target molecule in the original sample. By using a FACS to sort the droplets based on fluorescence, it is possible to recover the double emulsions that contain target molecules and, by breaking the double emulsions, to retrieve the target molecules. This can be used to screen large, heterogeneous populations of nucleic acids to selectively recover target sequences.

### PCR Activated Cell Sorting (PACS) in Monodispersed Droplets

The MESA technology enables the enrichment of naked nucleic acids out of a solution, but a similar approach can be applied to nucleic acids contained within entities, such as within cells, viruses, spores, particles etc., wherein the process is largely the same. For example, the entities including the target nucleic acids can be encapsulated in monodispersed single-emulsion droplets or multiple-emulsion droplets, and subjected to conditions sufficient to amplify the target nucleic acids, as described above. The monodispersed single-emulsion droplets or multiple-emulsion droplets can then be sorted based on amplification, to recover entities that have the target.

An important consideration when applying this technique to biological entities, especially ones that have a membrane or protective shell, e.g., cells, is that the nucleic acids must be accessible to amplification reagents for specific detection to occur, which may necessitate specialized procedures. For example the entities can be encapsulated in the monodispersed single-emulsion droplets or multiple-emulsion droplets with agents that release nucleic acids, such as proteases, lysozyme, detergents, strong bases, etc. They may also be encapsulated in monodispersed single-emulsion droplets or multiple-emulsion droplets and then soaked in solution that contain the lysing agent, which may partition through the monodispersed single-emulsion droplets', multiple-emulsion droplets', s' shell to induce lysis. They may also be encapsulated for example in gel particles that can be soaked in lysing agent. Then, these gel particles which will contain the nucleic acids of the entities, can be encapsulated in the monodispersed single-emulsion droplets or multiple-emulsion droplets for the detection via amplification procedure. The gel can be selected such that, it does not inhibit the lysis or amplification reaction such as, for example, by ensuring that its pore size is sufficiently large so as to enable a reagent to diffuse through the gel while trapping nucleic acids, or by enabling it to melt upon heating of the monodispersed single-emulsion droplets or multiple-emulsion droplets, as when using agarose. The gel may also be functionalized, if desired, to attach desired cell compounds, such as RNA molecules that may otherwise leak out of the gels and be undetectable. Yet another procedure that can be implemented to enable access of synthesis reagents to target nucleic acids is to use electric current to lyse cells, viruses, particles, etc., as they are being encapsulated into the monodispersed single-emulsion droplets or multiple-emulsion droplets. This can be achieved by, for instance, flowing the cells through a channel in which an electric current flows, which can create pores in a cell membrane, for example, and facilitate cell lysis.

### Live-Cell PCR Activated Cell Sorting (PACS)

The application of emulsion PCR and sorting to cells as described herein has included the lysis and, in most instances, death of the organism. However, by modifying the approach and using the methods described herein, it is also possible to recover live, intact cells. This can be accomplished by, for example, encapsulating living cells in monodispersed single-emulsion droplets or multiple-emulsion droplets under conditions such that cell contents leak into the encapsulating monodispersed single-emulsion droplet or multiple-emulsion monodispersed droplet while maintaining the viability of the cell. This is possible by, for instance, flowing the cell through a channel in which an electric current also flows, which can induce pore formation in the cell membrane and allow cell lysate to leak out. When the cell passes out of this channel, its membrane may seal back up, while the lysate that leaked out still exists around the cell. For laminar flow conditions, this can be performed such that the lysate around the cell flows with the cell and is encapsulated in the same compartment, such as a monodispersed single-emulsion droplet or multiple-emulsion droplet. Reagents suitable for amplification of the cell nucleic acids or detection of other cellular components can also be included such that the lysate around the cell can interact with the reagents when in the droplet. The reaction can be designed such that a fluorescent signal is produced, enabling droplets that contain the target cell to be recovered via sorting, and allowing live recovery of the cells. This is a powerful use of the technology because it provides the benefits of PACS—the ability to differentiate between cells based on sequence biomarkers, such as molecules and RNA—while preserving cell life so that other reactions and analyses can be performed.

### Mass Spectrometry Activated Cell Sorting (MS-ACS)

The methods described herein rely, in some embodiments, on the ability to compartmentalize reactions in monodispersed single-emulsion droplets or multiple-emulsion droplets, e.g., double emulsions, detect reaction products within the monodispersed single-emulsion droplets or multiple-emulsion droplets, and sort the droplets to recover specific entities based on those products and perform suitable analyses. Many types of assays can be performed, such as enzymatic assays, e.g., PCR, to differentiate between different entities, such as cells and viruses. However, in some cases, enzymatic techniques may not be able to detect the analyte of interest. In these instances, other methods can be implemented, such as spectrographic methods. A very powerful detection method is mass spectrometry, because it is sensitive and general. However, a limitation of mass spectrometry is that it is a destructive technology, destroying the sample that it analyzes. If the goal is the recovery of information only, this may be acceptable, but in some instances it is desirable to additionally recover material from the system which, normally, would be destroyed by the mass spectrometer.

Using the methods described herein, mass spectrometry can be used to analyze a sample while still allowing recovery of the sample. For example, suppose that the objective is to identify cells expressing proteins involved in a pathway. The cells can be loaded into monodispersed single-emulsion droplets or multiple-emulsion droplets, e.g., double emulsions, and cultured, so that there are many in each monodispersed single-emulsion droplet or multiple-emulsion droplet, and/or so that they are allowed to produce the products of the pathways, e.g., molecules, compounds, etc., which will fill the monodispersed single-emulsion droplet or multiple-emulsion droplet. The monodispersed single-emulsion droplets or multiple-emulsion droplets can then be flowed into a device that will split off a portion of the monodispersed single-emulsion droplets or multiple-emulsion droplets, capturing some of the material from the cells or cell secretions, which can be subjected to destructive mass spectrometry. The other portion can then be sorted. The mass spectrometer can be used to analyze the compounds in the sampled portion and this information can be used to determine how to sort the sister portion of the droplet. Using this method, it is possible to use very sensitive and general mass spectrometry to specifically sort cells, while allowing recover of whole cells or cell lysates.

### Colony Growth and Lysis

The ability to encapsulate cells in monodispersed single-emulsion droplets or multiple-emulsion droplets, e.g., double emulsions, is valuable for culturing organisms, such as cells and viruses. For example, if cells are grown in a single, shared volume, competition between cells may result in certain cells taking over the population, such that they include the majority of cells after some culture time. By compartmentalizing the cells in monodispersed single-emulsion droplets or multiple-emulsion droplets and culturing them, competition can be controlled and/or mitigated. Moreover, the permeability of the monodispersed single-emulsion droplets or multiple-emulsion droplets can be set such that certain molecules are able to pass through while others are not. This allows, for example, signaling molecules or other molecules important for growth to pass freely through the monodispersed single-emulsion droplets or multiple-emulsion droplet shells, to better control culture conditions.

### Multiplexing

In certain embodiments of the subject methods, multiple biomarkers may be detected and analyzed for a particular cell. Biomarkers detected may include, but are not limited to, one or more proteins, transcripts and/or genetic signatures in the cell's genome or combinations thereof. With standard fluorescence based detection, the number of biomarkers that can be simultaneously interrogated may be limited to the number of fluorescent dyes that can be independently visualized within each monodispersed single-emulsion droplet or multiple-emulsion droplet. In certain embodiments, the number of biomarkers that can be individually detected within a particular monodispersed single-emulsion droplet or multiple-emulsion droplet can be increased. For example, this may be accomplished by segregation of dyes to different parts of a monodispersed single-emulsion droplet or multiple-emulsion droplet. In particular embodiments, particles (e.g. LUMINEX® particles) conjugated with dyes and probes (e.g., nucleic acid or antibody probes) may be encapsulated in a monodispersed single-emulsion droplet or multiple-emulsion droplet to increase the number of biomarkers analyzed. In another embodiment, fluorescence polarization may be used to achieve a greater number of detectable signals for different biomarkers for a single cell. For example, fluorescent dyes may be attached to various probes and a monodispersed single-emulsion droplet or multiple-emulsion droplet may be visualized under different polarization conditions. In this way, the same colored dye can be utilized to provide a signal for different probe targets for a single cell. The use of fixed and/or permeabilized cells (as discussed in greater detail below) also allows for increased levels of multiplexing. For example, labeled antibodies may be used to target protein targets localized to cellular components while labeled PCR and/or RT-PCR products are free within a monodispersed single-emulsion droplet or multiple-emulsion droplet. This allows for dyes of the same color to be used for antibodies and for amplicons produced by RT-PCR.

### Digital Enzyme-Linked Immunosorbent Assay (ELISA)

In some embodiments, the disclosed methods and devices can be used to quantitate epitopes in a sample using a digital ELISA procedure. In some embodiments, for example, epitopes bound to a solid substrate, such as a planer substrate surface or the surfaces of particles, can be additionally bound with an affinity reagent labeled with an enzyme catalyst. The sample can be washed to remove unbound affinity reagents and enzymes. The labeled epitopes or a portion thereof can then be released in solution in a variety of ways. For ease, the enzyme catalyst may be bound to the affinity reagent through a bond that can be degraded chemically or with the application, for example, of heat or light. Alternatively, the interaction between the affinity reagent and the epitope can be broken, or the interaction between the epitope and the substrate can be broken. If the binding occurs on particles, then the particles can be suspended in solution after the washing step, thereby suspending the enzyme catalysts. The suspended enzyme catalysts can then be encapsulated in monodispersed single-emulsion droplets or multiple-emulsion droplets, e.g., double emulsions, with reagents sufficient to detect the enzyme catalyst, such as a substrate that the enzyme catalyst can convert into a fluorescent product. The monodispersed single-emulsion droplets or multiple-emulsion droplets can then be incubated under conditions suitable for catalysis, resulting in monodispersed single-emulsion droplets or multiple-emulsion droplets containing a large amount of reaction product when the catalyst is present and a low amount when it is not. The number of fluorescent monodispersed single-emulsion droplets or multiple-emulsion droplets can then be quantitated compared to the dim monodispersed single-emulsion droplets or multiple-emulsion droplets, providing a measure of the number of catalyst molecules present in the sample. This information can then be used to infer the concentration of epitopes in the original sample.

Using the multiplexing methods described herein, this can also be accomplished without the need to wash the sample after binding. For example, two antibodies detecting the same target can be introduced into the sample, each labeled with a different catalyst. The sample can then be encapsulated in monodispersed single-emulsion droplets or multiple-emulsion droplets, e.g., double emulsions. In the event that a target is present, it should be bound, in many instances, by both antibodies, as occurs in a typical “sandwich” ELISA, except in this case the molecules are free to diffuse in solution rather than being bound to a substrate. The results will be monodispersed single-emulsion droplets or multiple-emulsion droplets that, sometimes, contain just one of the antibodies or that contain both antibodies, which can be detected by monitoring the presence of the catalyst reactions in the droplets. Provided the dilutions are properly controlled so that most droplets are empty, it should be possible to ascribe the presence of both catalyst products to a target being present in the droplet, while the presence of just one of the catalyst products likely corresponds to an unbound antibody. By quantitating the fraction of double-positive droplets, it is possible to estimate the fraction of targets in solution without having to perform washing procedures.

Digital Oligo-linked Immunosorbent Assay (dOLISA)

The methods described herein can be used for sensitive detection and absolute quantification of RNA molecules. Assay approaches of interest also include, but are not limited to, those described by Chang, et al., J. Immuno. Methods. 378(1-2), 102-15 (2012), the disclosure of which is incorporated herein by reference. This application is applied to extremely low concentrations of analytes and the binding characteristics can deviate from typical immunoassay or ELISA platforms. Theoretical analysis clarifies what performance metrics (detection sensitivity, assay speed, etc.) can be expected from a set of experimental parameters.

The method involves binding of target protein molecules to antibodies conjugated to a particle surface. The amount of bound proteins (capture efficiency) in equilibrium state is determined by the dissociation constant K_{D}, setting the upper bound for capture efficiency. The binding reaction is a dynamic process governed by the on and off rates (kₒₙ and k_{off}) and the time-dependent evolution of the system can be simulated by numerically solving the differential equation that describes the kinetics. Without the intention of being bound by any theory, the binding kinetics depends primarily on kₒₙ value while K_{D} value has a negligible effect on it. The slow kinetics can be rescued if a higher concentration of antibodies can be provided for binding.

In some embodiments, kₒₙ rate dictates the required duration of incubation to achieve desired detection efficiency. In the case of dOLISA, the secondary antibody is conjugated with a DNA oligo. The ternary complex (Ab-Ligand-oligoAb) is encapsulated into 0.1-10 million droplets, e.g., monodispersed single-emulsion droplets, (5-50 pL each in volume) such that there are single DNA molecules per droplet, droplet PCR amplification in the presence of a fluorogenic reagent is performed, and the fluorescent droplets are counted.

### Sorting

In practicing the methods as described herein, one or more sorting steps may be employed, including the sorting of the monodispersed droplets. For example, in the context of the disclosed methods, where the plurality of particles is introduced into the jet of the first fluid in a disordered configuration, resulting in a polydispersed emulsion comprising a population of monodispersed-particle containing droplets, the method can include a step of sorting the monodispersed-particle containing droplets to separate them from other droplets in the polydispersed emulsion, e.g., based on a size difference of the monodispersed-particle containing droplets relative to non-particle containing droplets.

Sorting approaches of interest include, but are not necessarily limited to, approaches that involve the use of membrane valves, bifurcating channels, surface acoustic waves, selective coalescence, dielectrophoretic deflection, flow control, and/or other stimulus used to selectively deflect monodispersed droplets. Sorting approaches of interest further include those described by Agresti, et al., PNAS vol. 107, no 9, 4004-4009; the disclosure of which is incorporated herein by reference. A population may be enriched by sorting, in that a population containing a mix of members having or not having a desired property may be enriched by removing those members that do not have the desired property, thereby producing an enriched population having the desired property. In some embodiments, the sorting is performed by size-based sorting, dielectrophoretic deflection, selective coalescence, fluorescence activated cell sorting (FACS), electrophoresis, acoustic separation, magnetic activated cell sorting (MACS), flow control, or other stimulus used to selectively deflect monodispersed droplets.

Sorting may be applied before or after any of the steps described herein as suitable. Moreover, two or more sorting steps may be applied to droplets, e.g., monodispersed droplets e.g., about 2 or more sorting steps, about 3 or more, about 4 or more, or about 5 or more, etc. When a plurality of sorting steps is applied, the steps may be substantially identical or different in one or more ways (e.g., sorting based upon a different property, sorting using a different technique, and the like).

Droplets, including monodispersed droplets prepared as described herein, may be sorted based on one or more properties. Properties of interest include, but are not limited to, the size, viscosity, mass, buoyancy, surface tension, electrical conductivity, charge, magnetism, fluorescence, and/or presence or absence of one or more components. In certain aspects, sorting may be based at least in part upon the presence or absence of a cell in the monodispersed droplet. In certain aspects, sorting may be based at least in part based upon the detection of the presence or absence of nucleic acid amplification products such as amplification or synthesis products, e.g., as indicated by the detection of a fluorescent amplification product; or indicated by the detection of a surface antigen of an amplification product.

Monodispersed droplet sorting may be employed, for example, to remove monodispersed droplets in which no cells are present. Encapsulation may result in one or more monodispersed droplets, including a majority of the monodispersed droplets, in which no cell is present. If such empty monodispersed droplets were left in the system, they would be processed as any other monodispersed droplet, during which reagents and time would be wasted. To achieve the highest speed and efficiency, these empty monodispersed droplets may be removed with monodispersed droplets sorting.

Passive sorters of interest include hydrodynamic sorters, which sort monodispersed droplets into different channels according to size, based on the different ways in which small and large monodispersed droplets travel through the microfluidic channels. Also of interest are bulk sorters, a simple example of which is a tube containing monodispersed droplets of different mass in a gravitational field. By centrifuging, agitating, and/or shaking the tube, lighter monodispersed droplets that are more buoyant will naturally migrate to the top of the container. Monodispersed droplets that have magnetic properties could be sorted in a similar process, except by applying a magnetic field to the container, towards which monodispersed droplets with magnetic properties will naturally migrate according to the magnitude of those properties. A passive sorter as used in the subject methods may also involve relatively large channels that will sort large numbers of monodispersed droplets simultaneously based on their flow properties.

Picoinjection can also be used to change the electrical properties of monodispersed droplets. This could be used, for example, to change the conductivity of the monodispersed droplets by adding ions, which could then be used to sort them, for example, using dielectrophoresis. Alternatively, picoinjection can also be used to charge the monodispersed droplets. This could be achieved by injecting a fluid into the monodispersed droplets that is charged, so that after injection, the monodispersed droplets would be charged. This would produce a collection of monodispersed droplets in which some were charged and others not, and the charged monodispersed droplets could then be extracted by flowing them through a region of electric field, which will deflect them based on their charge amount. By injecting different amounts of liquid by modulating the piocoinj ection, or by modulating the voltage to inject different charges for affixed injection volume, the final charge on the monodispersed droplets could be adjusted, to produce monodispersed droplets with a different charge. These would then be deflected by different amounts in the electric field region, allowing them to be sorted into different containers.

Flow cytometry (FC) may be utilized as an alternative to on-chip monodispersed droplet sorting in any of the methods described herein. Such a method, along with devices which may be utilized in the practice of the method, are described in Lim and Abate, Lab Chip, 2013, 13, 4563-4572; the disclosure of which is incorporated herein by reference in its entirety and for all purposes. Briefly, monodispersed droplets may be formed and manipulated, e.g., using techniques like splitting and picoinjection as described herein, resulting in single emulsions. These single emulsions may then be double emulsified, e.g., to provide multiple-emulsion droplets as described herein, e.g., using one or more devices as described herein or in Lim and Abate, Lab Chip, 2013, 13, 4563-4572. The double emulsions may then be analyzed via FC, e.g., FACS.

Droplets, e.g., monodispersed single-emulsion droplets or double-emulsion droplets, generated using the methods as described herein can be used to conduct a variety of encapsulated chemical and biological reactions including, for example, reactions involving enzymes, such as PCR. In many instances, the result of the reaction may be a product that may be of interest to detect. In addition, it may be of interest to recover monodispersed single-emulsion droplets or multiple-emulsion droplets that have different levels of the product, or a combination of multiple products. This can be accomplished using the invention in a variety of ways. For example, reactions can be partitioned into the monodispersed single-emulsion droplet or multiple-emulsion droplet reactors such that different monodispersed single-emulsion droplets or multiple-emulsion droplets react to different levels and have different final product concentrations. The monodispersed single-emulsion droplets or multiple-emulsion droplets can then be interrogated using, for example, spectrographic techniques, such as optical or fluorescent imaging, flow cytometry, Raman spectroscopy, mass-spectrometry, etc. These methods, or combinations thereof, can be used to determine the concentrations of different compounds in the monodispersed single-emulsion droplets or multiple-emulsion droplets. These methods can be combined with a mechanism for sorting monodispersed single-emulsion droplets or multiple-emulsion droplets using, for example, microfluidic based sorting or flow cytometry in the case of double emulsions. The contents of the positively and negatively sorted monodispersed single-emulsion droplets or multiple-emulsion droplets can be analyzed to identify different properties of these sorted pools.

Additionally, in some instances, it may be desirable to load individual positively sorted droplets into isolated wells for further study enabling, for example, additional, detailed individual analysis of each positively sorted droplet. As a non-limiting example, the methods and devices as described herein can be used to interrogate viruses containing a specific nucleic acid sequence. Viruses from a heterogeneous population can, for example, be loaded into monodispersed single-emulsion droplets or multiple-emulsion droplets, e.g., double emulsions, with reagents sufficient for lysis and amplification of target nucleic acids. The monodispersed single-emulsion droplets or multiple-emulsion droplets can then be analyzed and sorted, e.g., with flow cytometry for double emulsions, to detect and recover all droplets that underwent amplification of the target nucleic acids. These droplets can be sorted into a single positive pool or sorted individually into wells on a well plate array, for example. They may even be loaded in specific groups, if desired, so that each well on the array has a desired combination of positive events, which may all be the same or exhibit different amplification targets. The sorted droplets can then be subjected to additional analysis such as, for example, mass spectrometry or next generation sequencing.

In the pooled analysis case, the nucleic acids from all cells loaded into the positive container will be mixed together and analyzed as a whole. However, by loading single droplets into wells, the contents of each well can be analyzed individually such as, for example, by barcoding the nucleic acids in each well before pooling and sequencing. This permits, for example, the lysis of single viral genomes of the target species to not only detect the target species but recover individual genomes so that comparisons between different members of the same species can be obtained. Such an analysis is useful for a variety of applications such as metagenomics or for studying viral diversity.

In some embodiments of the invention, it is desirable to amplify the target molecules in addition to the amplification that is used for detection to enable, for example, additional analyses on sorted target nucleic acids. For example, in some applications, the target will include nucleic acids desirable for sequencing, but the quantity of nucleic acids provided by the target will be too small to enable sequencing. In these instances, an amplification procedure, such as a specific PCR and/or non-specific multiple displacement amplification can be applied, before or after sorting of the monodispersed single-emulsion droplets or multiple-emulsion droplets. For example, in the case of a virus with a relatively small, linear genome, such as polio or HIV, a PCR can be performed prior to or post sorting to provide sufficient copies of each genome after sorting to enable sequencing analysis. For example individual genomes may be encapsulated in droplets and subjected to amplification of the whole or a portion of the genome. Simultaneous with or following this reaction, an additional amplification can be performed to identify the genome in the monodispersed single-emulsion droplets or multiple-emulsion droplets and the monodispersed single-emulsion droplets or multiple-emulsion droplets sorted based on this information. These sorted single or multiple emulsions, now containing a large number of copies of the target nucleic acid, may then be more easily subjected to follow-on analyses.

Alternatively, individual genomes can be encapsulated and subjected to the detection amplification such that, for instance, each positive monodispersed single-emulsion droplets or multiple-emulsion monodispersed droplet contains just one copy of the full length target nucleic acid and a large number of the small detection region amplicons. Based on these amplicons, the monodispersed single-emulsion droplets or multiple-emulsion droplets can be recovered as a pool, providing for each positive sorting event one full length copy of the target genome. To prepare a sequencing library, these positive genomes can then be amplified using a PCR that is specific and has primers that flank the regions desired or, alternatively, a non-specific method to amplify the entirety of the genome, such as multiple displacement amplification (MDA) or multiple annealing and looping based amplification cycles (MALBAC). In addition, if the positive monodispersed single-emulsion droplets or multiple-emulsion droplets are not pooled, for example, if the positive monodispersed single-emulsion droplets or multiple-emulsion droplets are sorted into a well plate array, and then subjected to amplification using a PCR that is specific and has primers that flank the region desired, the resulting individual amplicons can be used directly as material for Sanger sequencing.

A powerful advantage of the disclosed methods and devices is its ability to perform a large number of independent, isolated reactions and then apply a variety of spectrographic techniques to detect reaction products and sort to recover specific reactors that underwent a desired reaction. A challenge that may arise in the performance of the disclosed methods is that, in some instances, positive events that are desired for further analysis might be very rare. For example, if the disclosed methods are used to detect a specific virus in a large, diverse pool of viruses, in which the desired virus is present at a very low level, then a large number of individual viruses might need to be analyzed in order to recover the specific virus. And, if it is desirable to recover multiple instances of the species, then an even larger number of total viruses might need to be analyzed. Since the number of reactions that can be performed and sorted with the disclosed methods is finite, there may be instances in which the target is too rare to detect reliably.

In certain instances, the methods as described herein can be used in a tiered sorting process to recover extremely rare events, each sorting round providing an enrichment factor. By performing the sorting on the sample repeatedly, the sample can be enriched for targets so that the total enrichment becomes the multiplicative product of all of the individual enrichments. For example, suppose that a system as described herein is capable of generating, analyzing, and sorting at most 1 million monodispersed single-emulsion droplets or multiple-emulsion droplets. Under ideal conditions, this means that an event that is present at, for example, 1 in a billion is unlikely to be detected with a straightforward usage of the system. However, by performing tiered sorting and enriching the target at each sorting round, such rare events can be recovered.

For example, in a first round, 10 billion entities for testing can be isolated in the million monodispersed single-emulsion droplets or multiple-emulsion droplets such that each droplet contains about 10,000 entities. If the target entity is present at 1 in 1 billion, then in such a sample there will be at most 10 monodispersed single-emulsion droplets or multiple-emulsion droplets that contain the target and are thus positive. These will be sorted, each providing 10,000 entities, yielding a total number of 100,000 entities in which the 10 desired are mixed. In some instances, this enrichment may be sufficient, but in others, it may be desirable to enrich further, even to 100% purity. In this case, the tiered sorting approach can be used, loading the 100,000 entities into 1 million droplets such that, for example, 1 in 10 droplets contains 1 entity, loading in accordance with a Poisson distribution. In this instance, the majority of droplets that are determined to be positive for the target will contain only that target entity, although due to the random nature of Poisson loading, some will also contain negative off-target entities that happened to be co-encapsulated with a positive.

When the 1 million droplets are analyzed and sorted, 10 will again be determined to contain the target entity and will be recovered with sorting, providing a highly enriched population that is almost completely pure for the target. To enrich further, additional round of sorting can be performed. The power of tiered sorting is that in this instance the final enrichment is the multiplicative product of the individual enrichments. For example, if the method is able to enrich a maximum of 10\hat{ }3 in one round, then by performing the sorting twice on the same sample the final enrichment will become 10\hat{ }3×10\hat{ }3=10\hat{ }6, while another round will provide a final enrichment of, for example, 10\hat{ }9. Additionally, the enrichments can be similar in each round or different, depending on the desires of the user. For example, a first round with a small number of relations can be used to provide an enrichment of, for instance, 10\hat{ }3, and then a more intensive round can be used to perform an enrichment of 10\hat{ }6, yielding again a 10\hat{ }9 final enrichment. These values can be adjusted as needed to optimize for the particular application but the tiered sorting methods generally provide the very powerful advantage of being able to enrich extremely rare events out of massive populations even with finite enrichment power.

When using the disclosed methods to enrich with PCR activated sorting, special considerations may need to be taken to ensure that each enrichment is successful and increases the concentration of the target in the solution. For example, if the goal is to detect a very rare virus in a large population, then in the first round, amplification primers can be generated against a specific sequence in the viral genome. These will yield many copies of that region which will be collected into the sorted chamber. If this same region is used in additional sorting rounds, then the product amplicons of earlier rounds will be detected and sorted, leading to a large number of positive events that will erode the power of the method for achieving large enrichments. In this instance, the primers in later rounds can be modified so as to not detect amplification products from earlier rounds. This can be achieved in a number of ways including, for example, using a nested PCR approach in which the primers in later rounds amplify from beyond the region that is used in the early rounds so that products from early rounds cannot be amplified in later rounds. Alternatively, completely distinct regions can be targeted in later rounds, such as different portions of the same gene or different genes altogether. Combinations of these methods can also be used to achieve highly enriched samples.

Suitable Subjects and/or Samples

The subject methods may be applied to biological samples taken from a variety of different subjects. In many embodiments the subjects are “mammals” or “mammalian”, where these terms are used broadly to describe organisms which are within the class mammalia, including the orders carnivore (e.g., dogs and cats), rodentia (e.g., mice, guinea pigs, and rats), and primates (e.g., humans, chimpanzees, and monkeys). In many embodiments, the subjects are humans. The subject methods may be applied to human subjects of both genders and at any stage of development (i.e., neonates, infant, juvenile, adolescent, adult), where in certain embodiments the human subject is a juvenile, adolescent or adult. While the present invention may be applied to a human subject, it is to be understood that the subject methods may also be carried-out on other animal subjects (that is, in “non-human subjects”) such as, but not limited to, birds, mice, rats, dogs, cats, livestock and horses. Accordingly, it is to be understood that any subject in need of assessment as described herein is suitable.

Moreover, suitable subjects include those who have and those who have not been diagnosed with a condition, such as cancer. Suitable subjects include those that are and are not displaying clinical presentations of one or more cancers. In certain aspects, a subject may one that may be at risk of developing cancer, due to one or more factors such as family history, chemical and/or environmental exposure, genetic mutation(s) (e.g., BRCA1 and/or BRCA2 mutation), hormones, infectious agents, radiation exposure, lifestyle (e.g., diet and/or smoking), presence of one or more other disease conditions, and the like.

As described more fully above, a variety of different types of biological samples may be obtained from such subjects. In certain embodiments, whole blood is extracted from a subject. When desired, whole blood may be treated prior to practicing the subject methods, such as by centrifugation, fractionation, purification, and the like. The volume of the whole blood sample that is extracted from a subject may be 100 mL or less, e.g., about 100 mL or less, about 50 mL or less, about 30 mL or less, about 15 mL or less, about 10 mL or less, about 5 mL or less, or about 1 mL or less.

The subject methods and devices as described herein are compatible with both fixed and live cells. In certain embodiments, the subject methods and devices are practiced with live cells. In other embodiments, the subject methods and devices are practiced with fixed cells. Fixing a cellular sample allows for the sample to be washed to extract small molecules and lipids that may interfere with downstream analysis. Further, fixing and permeabilizing cells allows the cells to be stained with antibodies for surface proteins as well as intracellular proteins. Combined with the nucleic amplification methods as described herein, such staining can be used to achieve high levels of multiplexing because the antibodies are localized to the cell sample, while the nucleic amplification products are free within a monodispersed single-emulsion droplet or multiple-emulsion monodispersed droplet,. Such a configuration allows for dyes of the same color to be used for antibodies and for amplicons produced by nucleic acid amplification. Any suitable method can be used to fix cells, including but not limited to, fixing using formaldehyde, methanol and/or acetone.

Detecting Proteins or DNA with Enzyme-Linked Probes

The methods and devices as described herein can be used in a variety of ways for detecting and sorting entities in a heterogeneous solution. Some embodiments described thus far accomplish this using nucleic acid amplification performed in monodispersed single-emulsion droplets or multiple-emulsion droplets, e.g., double emulsions, but other methods are also enabled as described herein. When the disclosed methods and devices are used to detect nucleic acids, this can be accomplished by, for example, encapsulating individual nucleic acid entities in the monodispersed single-emulsion droplets or multiple-emulsion droplets and then subjecting them to amplification with primers specific for target nucleic acids, detecting the target amplicons, and then sorting based on amplification. However, other detectable signals can be generated using other means, such as by binding affinity reagents to the targets. For example, if the target is a nucleic acid, probes specific to the target can be synthesized that can hybridize to the target when present; these probes may be labeled with dyes or, in some cases, catalysts, such as enzyme based or non-enzyme based catalysts. The targets, now bound by their probes, can be subjected to purification to remove unbound probes and, the remaining material can be encapsulated in the droplets using the methods as described herein.

In the case of a catalyst-linked probe, the substrate for the catalyst may also be included in the monodispersed single-emulsion droplets or multiple-emulsion droplets. In this instance, monodispersed single emulsions or multiple emulsions that contain targets will be bound with probes and, thus, will include catalysts, resulting in catalysis of the substrate and the generation of a product, which may, for example, be fluorescent. Over time, this will cause the monodispersed single-emulsion droplets or multiple-emulsion droplets to fill with fluorescent product. By contrast, monodispersed single-emulsion droplets or multiple-emulsion droplets that are empty or that contain off-target molecules will not contain catalysts, resulting in no product generation and, hence no detectable signal. The result of such an approach is a large collection of monodispersed single-emulsion droplets or multiple-emulsion droplets some of which are fluorescent and others dim, enabling recovery of the targets by sorting the encapsulating fluorescent monodispersed single-emulsion droplets or multiple-emulsion droplets. This procedure can also be applied to other kinds of targets, such as biomolecules, viruses, cells, etc., that can be bound with affinity reagents, such as antibodies. In this case, affinity reagents would, for example, be bound with a catalyst, and the procedure would be performed as described above for nucleic acid targets bound by nucleic acid probes.

In both of these examples, washing may be implemented to remove unbound catalysts, which would otherwise be encapsulated in monodispersed single-emulsion droplets or multiple-emulsion droplets and yield false positives. However, if washing to remove unbound catalysts is not desirable or possible, then an alternative approach would be to use a multiplexed assay in which, for example, the localization of two signals is used to identify a positive event. For example, if the goal is to detect a nucleic acid target that is in a solution, the probes for two different sequences on the target can be synthesized, each bound with a different catalyst that performs, for example, a reaction that yields a fluorescent product. In one embodiment, the fluorescent products for the distinct catalysts can be different colors, for example one yielding a green fluorescent product and the other a red fluorescent product. The probes can be bound to the targets, as normal. In this instance, while there will be many unbound probes in solution, in the majority of instances, the probes corresponding to the first type of catalyst will not be physical bound to the second probe with a different catalyst unless they are both bound to the same target nucleic acid.

The solutions can also be diluted as necessary to perform the hybridization at a high concentration. The concentration can then be reduced such that any given droplet-equivalent volume of solution will contain just one probe or a target with both bound probes. This solution can then be encapsulated with the substrates for the catalysts, incubated, detected, and sorted. In this embodiment, many monodispersed single-emulsion droplets or multiple-emulsion droplets will contain just a red or green catalyst, but others will contain both a red and a green—the ones that are bound to the target. This will allow droplets containing the target nucleic acid to be differentiated from those that just contain catalysts by detecting the droplets that emit fluorescence at both wavelengths, without the need to wash.

Again, a false positive may occur when unbound probes of both catalysts happen to be co-encapsulated in the same droplet, but this can be mitigated by diluting the solution sufficiently to ensure that this event is substantially rarer than the presence of the targets, so that the double-positive monodispersed single-emulsion droplets or multiple-emulsion droplets identified can most often be associated with the presence of a target. Similar techniques can be applied to other kinds of targets like cells or proteins using different kinds of affinity reagents, such as binding molecules like antibodies, which can again be bound with catalysts of different reactivity, etc.

### Detecting Cancer

Methods as described herein also involve methods for detecting cancer. Such methods may include encapsulating in a monodispersed single-emulsion droplet or multiple-emulsion droplet oligonucleotides obtained from a biological sample from the subject, wherein at least one oligonucleotide is present in the monodispersed single-emulsion droplet or multiple-emulsion droplet; introducing polymerase chain reaction (PCR) reagents, a detection component, and a plurality of PCR primers into the monodispersed single-emulsion droplet or multiple-emulsion droplet and incubating the monodispersed single-emulsion droplet or multiple-emulsion droplet under conditions allowing for PCR amplification to produce PCR amplification products, wherein the plurality of PCR primers include one or more primers that each hybridize to one or more oncogenes; and detecting the presence or absence of the PCR amplification products by detection of the detection component, wherein detection of the detection component indicates the presence of the PCR amplification products.

Detection of one or more PCR amplification products corresponding to one or more oncogenes may be indicative that the subject has cancer. The specific oncogenes that are added to the droplet may vary. In certain aspects, the oncogene(s) may be specific for a particular type of cancer, e.g., breast cancer, colon cancer, and the like.

Moreover, in practicing the subject methods the biological sample from which the components are to be detected may vary, and may be based at least in part on the particular type of cancer for which detection is sought. For instance, breast tissue may be used as the biological sample in certain instances, if it is desired to determine whether the subject has breast cancer, and the like. In practicing the methods for detecting cancer, any variants to the general steps described herein, such as the number of primers that may be added, the manner in which reagents are added, suitable subjects, and the like, may be made. The above method may also be performed using single-emulsion droplets in place of multiple-emulsion droplets.

Systems

As summarized above, the present disclosure provides a system for generating monodispersed droplets, including a microfluidic device comprising a first channel, a second channel, a third channel and a fourth channel, wherein a first fluid is flowed from the first channel into the second channel through a junction of the first, second, third, and fourth channels, into a second fluid under stable jetting conditions to provide a jet of the first fluid in the second fluid, wherein the first fluid is immiscible with the second fluid, wherein the second fluid is introduced into the junction via the third and fourth channels, and wherein a plurality of particles is introduced into the jet of the first fluid thereby triggering break-up of the jet of the first fluid and encapsulation of the plurality of particles in a plurality of monodispersed droplets of the first fluid in the second fluid. In some embodiments, the first channel has a cross-sectional area that is within 10% of that of a particle of the plurality of particles. In some embodiments, the cross-sectional area of the second channel is greater than that of the first channel. In some other embodiments, the microfluidic device described herein further includes a fifth channel and a sixth channel which form a junction with the first channel upstream of the junction of the first, second, third and fourth channels. In such embodiments, a third fluid may be flowed into the first fluid from the fifth and sixth channels prior to flowing the first fluid into the second fluid, wherein the third fluid is miscible with the first fluid. Exemplary embodiments are depicted in FIGS. 1D, 1E, 2D, 2E, 4A and 4B.

In some embodiments, the plurality of particles is introduced into the jet of the first fluid in an un-packed configuration. In other embodiments, the plurality of particles is introduced into the jet of the first fluid in a packed configuration. In certain aspects, the plurality of particles includes rigid particles. In other aspects, the plurality of particles includes a hydrogel. In some other aspects, the plurality of particles includes elastic particles.

In an exemplary system as described herein, the plurality of particles is encapsulated at a rate of from about 1 Hz to about 100 kHz, e.g., at a rate of about 10,000/sec or more, about 15,000/sec or more or about 20,000/sec or more. One or more sorting steps may also be employed.

Materials and Methods for Preparing Microfluidic Devices

Methods and materials which may be used in the preparation of the microfluidic devices described herein are provided.

Substrate: Substrates used in microfluidic systems are the supports in which the necessary elements for fluid transport are provided. The basic structure may be monolithic, laminated, or otherwise sectioned. Commonly, substrates include one or more microchannels serving as conduits for fluid flow. They may also include input ports, output ports, and/or features to assist in flow control.

In certain embodiments, the substrate choice may be dependent on the application and design of the device. Substrate materials are generally chosen for their compatibility with a variety of operating conditions. Limitations in microfabrication processes for a given material are also relevant considerations in choosing a suitable substrate. Useful substrate materials include, e.g., glass, polymers, silicon, metal, and ceramics.

Polymers are standard materials for microfluidic devices because they are amenable to both cost effective and high volume production. Polymers can be classified into three categories according to their molding behavior: thermoplastic polymers, elastomeric polymers and duroplastic polymers. Thermoplastic polymers can be molded into shapes above the glass transition temperature, and will retain these shapes after cooling below the glass transition temperature. Elastomeric polymers can be stretched upon application of an external force, but will go back to original state once the external force is removed. Elastomers do not melt before reaching their decomposition temperatures. Duroplastic polymers have to be cast into their final shape because they soften a little before the temperature reaches their decomposition temperature.

Polymers that may be used in the disclosed devices include, e.g., polyamide (PA), polybutylenterephthalate (PBT), polycarbonate (PC), polyethylene (PE), polymethylmethacrylate (PMMA), polyoxymethylene (POM), polypropylene (PP), polyphenylenether (PPE), polystyrene (PS), polysulphone (PSU), and polydimethylsiloxane (PDMS).

Glass, which may also be used as the substrate material, has specific advantages under certain operating conditions. Since glass is chemically inert to most liquids and gases, it is particularly appropriate for applications employing certain solvents that have a tendency to dissolve plastics. Additionally, its transparent properties make glass particularly useful for optical or UV detection.

Surface Treatments and Coatings: Surface modification may be useful for controlling the functional mechanics (e.g., flow control) of a microfluidic device. For example, it may be advantageous to keep fluidic species from adsorbing to channel walls.

Polymer devices in particular tend to be hydrophobic, and thus loading of the channels may be difficult. The hydrophobic nature of polymer surfaces also make it difficult to control electroosmotic flow (EOF). One technique for coating polymer surface is the application of polyelectrolyte multilayers (PEM) to channel surfaces. PEM involves filling the channel successively with alternating solutions of positive and negative polyelectrolytes allowing for multilayers to form electrostatic bonds. Although the layers typically do not bond to the channel surfaces, they may completely cover the channels even after long-term storage. Another technique for applying a hydrophilic layer on polymer surfaces involves the UV grafting of polymers to the surface of the channels. First grafting sites, radicals, are created at the surface by exposing the surface to UV irradiation while simultaneously exposing the device to a monomer solution. The monomers react to form a polymer covalently bonded at the reaction site.

Glass channels generally have high levels of surface charge. In some situations, it may be advantageous to apply a polydimethylsiloxane (PDMS) and/or surfactant coating to the glass channels. Other polymers that may be employed to retard surface adsorption include polyacrylamide, glycol groups, polysiloxanes, glyceroglycidoxypropyl, poly(ethyleneglycol) and hydroxyethylated poly(ethyleneimine). Furthermore, for electroosmotic devices it is advantageous to have a coating bearing a charge that is adjustable in magnitude by manipulating conditions inside of the device (e.g. pH). The direction of the flow can also be selected based on the coating since the coating can either be positively or negatively charged.

Specialized coatings can also be applied to immobilize certain species on the channel surface—this process is known by those skilled in the art as “functionalizing the surface.” For example, a polymethylmethacrylate (PMMA) surface may be coated with amines to facilitate attachment of a variety of functional groups or targets. Alternatively, PMMA surfaces can be rendered hydrophilic through an oxygen plasma treatment process.

Methods of Fabrication: Microfabrication processes differ depending on the type of materials used in the substrate and the desired production volume. For small volume production or prototypes, fabrication techniques include LIGA, powder blasting, laser ablation, mechanical machining, electrical discharge machining, photoforming, etc. Technologies for mass production of microfluidic devices may use either lithographic or master-based replication processes. Lithographic processes for fabricating substrates from silicon/glass include both wet and dry etching techniques commonly used in fabrication of semiconductor devices. Injection molding and hot embossing typically are used for mass production of plastic substrates.

Glass, Silicon and Other “Hard” Materials (Lithography, Etching, Deposition): The combination of lithography, etching and deposition techniques may be used to make microcanals and microcavities out of glass, silicon and other “hard” materials. Technologies based on the above techniques are commonly applied in for fabrication of devices in the scale of 0.1-500 micrometers.

Microfabrication techniques based on current semiconductor fabrication processes are generally carried out in a clean room. The quality of the clean room is classified by the number of particles <4 μm in size in a cubic inch. Typical clean room classes for MEMS microfabrication are 1000 to 10000.

In certain embodiments, photolithography may be used in microfabrication. In photolithography, a photoresist that has been deposited on a substrate is exposed to a light source through an optical mask. Conventional photoresist methods allow structural heights of up to 10-40 μm. If higher structures are needed, thicker photoresists such as SU-8, or polyimide, which results in heights of up to 1 mm, can be used.

After transferring the pattern on the mask to the photoresist-covered substrate, the substrate is then etched using either a wet or dry process. In wet etching, the substrate—area not protected by the mask—is subjected to chemical attack in the liquid phase. The liquid reagent used in the etching process depends on whether the etching is isotropic or anisotropic. Isotropic etching generally uses an acid to form three-dimensional structures such as spherical cavities in glass or silicon. Anisotropic etching forms flat surfaces such as wells and canals using a highly basic solvent. Wet anisotropic etching on silicon creates an oblique channel profile.

Dry etching involves attacking the substrate by ions in either a gaseous or plasma phase. Dry etching techniques can be used to create rectangular channel cross-sections and arbitrary channel pathways. Various types of dry etching that may be employed including physical, chemical, physico-chemical (e.g., RIE), and physico-chemical with inhibitor. Physical etching uses ions accelerated through an electric field to bombard the substrate's surface to “etch” the structures. Chemical etching may employ an electric field to migrate chemical species to the substrate's surface. The chemical species then reacts with the substrate's surface to produce voids and a volatile species.

In certain embodiments, deposition is used in microfabrication. Deposition techniques can be used to create layers of metals, insulators, semiconductors, polymers, proteins and other organic substances. Most deposition techniques fall into one of two main categories: physical vapor deposition (PVD) and chemical vapor deposition (CVD). In one approach to PVD, a substrate target is contacted with a holding gas (which may be produced by evaporation for example). Certain species in the gas adsorb to the target's surface, forming a layer constituting the deposit. In another approach commonly used in the microelectronics fabrication industry, a target containing the material to be deposited is sputtered with using an argon ion beam or other appropriately energetic source. The sputtered material then deposits on the surface of the microfluidic device. In CVD, species in contact with the target react with the surface, forming components that are chemically bonded to the object. Other deposition techniques include: spin coating, plasma spraying, plasma polymerization, dip coating, casting and Langmuir-Blodgett film deposition. In plasma spraying, a fine powder containing particles of up to 100 um in diameter is suspended in a carrier gas. The mixture containing the particles is accelerated through a plasma jet and heated. Molten particles splatter onto a substrate and freeze to form a dense coating. Plasma polymerization produces polymer films (e.g. PMMA) from plasma containing organic vapors.

Once the microchannels, microcavities and other features have been etched into the glass or silicon substrate, the etched features are usually sealed to ensure that the microfluidic device is “watertight.” When sealing, adhesion can be applied on all surfaces brought into contact with one another. The sealing process may involve fusion techniques such as those developed for bonding between glass-silicon, glass-glass, or silicon-silicon.

Anodic bonding can be used for bonding glass to silicon. A voltage is applied between the glass and silicon and the temperature of the system is elevated to induce the sealing of the surfaces. The electric field and elevated temperature induces the migration of sodium ions in the glass to the glass-silicon interface. The sodium ions in the glass-silicon interface are highly reactive with the silicon surface forming a solid chemical bond between the surfaces. The type of glass used should ideally have a thermal expansion coefficient near that of silicon (e.g. Pyrex Corning 7740).

Fusion bonding can be used for glass-glass or silicon-silicon sealing. The substrates are first forced and aligned together by applying a high contact force. Once in contact, atomic attraction forces (primarily van der Waals forces) hold the substrates together so they can be placed into a furnace and annealed at high temperatures. Depending on the material, temperatures used ranges between about 600 and 1100° C.

Polymers/Plastics: A number of techniques may be employed for micromachining plastic substrates in accordance with embodiments of the present disclosure. Among these are laser ablation, stereolithography, oxygen plasma etching, particle jet ablation, and microelectro-erosion. Some of these techniques can be used to shape other materials (glass, silicon, ceramics, etc.) as well.

To produce multiple copies of a microfluidic device, replication techniques are employed. Such techniques involve first fabricating a master or mold insert containing the pattern to be replicated. The master is then used to mass-produce polymer substrates through polymer replication processes.

In the replication process, the master pattern contained in a mold is replicated onto the polymer structure. In certain embodiments, a polymer and curing agent mix is poured onto a mold under high temperatures. After cooling the mix, the polymer contains the pattern of the mold, and is then removed from the mold. Alternatively, the plastic can be injected into a structure containing a mold insert. In microinjection, plastic heated to a liquid state is injected into a mold. After separation and cooling, the plastic retains the mold's shape.

PDMS (polydimethylsiloxane), a silicon-based organic polymer, may be employed in the molding process to form microfluidic structures. Because of its elastic character, PDMS is well suited for microchannels between about 5 and 500 μm. Specific properties of PDMS make it particularly suitable for microfluidic purposes:
1) It is optically clear which allows for visualization of the flows;
2) PDMS when mixed with a proper amount of reticulating agent has elastomeric qualities that facilitates keeping microfluidic connections “watertight;”
3) Valves and pumps using membranes can be made with PDMS because of its elasticity;
4) Untreated PDMS is hydrophobic, and becomes temporarily hydrophilic after oxidation of surface by oxygen plasma or after immersion in strong base; oxidized PDMS adheres by itself to glass, silicon, or polyethylene, as long as those surfaces were themselves exposed to an oxygen plasma.
5) PDMS is permeable to gas. Filling of the channel with liquids is facilitated even when there are air bubbles in the canal because the air bubbles are forced out of the material. But it's also permeable to non-polar-organic solvents.

Microinjection can be used to form plastic substrates employed in a wide range of microfluidic designs. In this process, a liquid plastic material is first injected into a mold under vacuum and pressure, at a temperature greater than the glass transition temperature of the plastic. The plastic is then cooled below the glass transition temperature. After removing the mold, the resulting plastic structure is the negative of the mold's pattern.

Yet another replicating technique is hot embossing, in which a polymer substrate and a master are heated above the polymer's glass transition temperature, Tg (which for PMMA or PC is around 100-180° C.). The embossing master is then pressed against the substrate with a preset compression force. The system is then cooled below Tg and the mold and substrate are then separated.

Typically, the polymer is subjected to the highest physical forces upon separation from the mold tool, particularly when the microstructure contains high aspect ratios and vertical walls. To avoid damage to the polymer microstructure, material properties of the substrate and the mold tool may be taken into consideration. These properties include: sidewall roughness, sidewall angles, chemical interface between embossing master and substrate and temperature coefficients. High sidewall roughness of the embossing tool can damage the polymer microstructure since roughness contributes to frictional forces between the tool and the structure during the separation process. The microstructure may be destroyed if frictional forces are larger than the local tensile strength of the polymer. Friction between the tool and the substrate may be important in microstructures with vertical walls. The chemical interface between the master and substrate could also be of concern. Because the embossing process subjects the system to elevated temperatures, chemical bonds could form in the master-substrate interface. These interfacial bonds could interfere with the separation process. Differences in the thermal expansion coefficients of the tool and the substrate could create addition frictional forces.

Various techniques can be employed to form molds, embossing masters, and other masters containing patterns used to replicate plastic structures through the replication processes mentioned above. Examples of such techniques include LIGA (described below), ablation techniques, and various other mechanical machining techniques. Similar techniques can also be used for creating masks, prototypes and microfluidic structures in small volumes. Materials used for the mold tool include metals, metal alloys, silicon and other hard materials.

Laser ablation may be employed to form microstructures either directly on the substrate or through the use of a mask. This technique uses a precision-guided laser, typically with wavelength between infrared and ultraviolet. Laser ablation may be performed on glass and metal substrates, as well as on polymer substrates. Laser ablation can be performed either through moving the substrate surface relative to a fixed laser beam, or moving the beam relative to a fixed substrate. Various micro-wells, canals, and high aspect structures can be made with laser ablation.

Certain materials such as stainless steel make very durable mold inserts and can be micromachined to form structures down to the 10-μm range. Various other micromachining techniques for microfabrication exist including μ-Electro Discharge Machining (μ-EDM), μ-milling, focused ion beam milling. μ-EDM allows the fabrication of 3-dimensional structures in conducting materials. In μ-EDM, material is removed by high-frequency electric discharge generated between an electrode (cathode tool) and a workpiece (anode). Both the workpiece and the tool are submerged in a dielectric fluid. This technique produces a comparatively rougher surface but offers flexibility in terms of materials and geometries.

Electroplating may be employed for making a replication mold tool/master out of, e.g., a nickel alloy. The process starts with a photolithography step where a photoresist is used to defined structures for electroplating. Areas to be electroplated are free of resist. For structures with high aspect ratios and low roughness requirements, LIGA can be used to produce electroplating forms. LIGA is a German acronym for Lithographic (Lithography), Galvanoformung (electroplating), Abformung (molding). In one approach to LIGA, thick PMMA layers are exposed to x-rays from a synchrotron source. Surfaces created by LIGA have low roughness (around 10 nm RMS) and the resulting nickel tool has good surface chemistry for most polymers.

As with glass and silicon devices, polymeric microfluidic devices must be closed up before they can become functional. Common problems in the bonding process for microfluidic devices include the blocking of channels and changes in the physical parameters of the channels. Lamination is one method used to seal plastic microfluidic devices. In one lamination process, a PET foil (about 30 μm) coated with a melting adhesive layer (typically 5-10 μm) is rolled with a heated roller, onto the microstructure. Through this process, the lid foil is sealed onto the channel plate. Several research groups have reported a bonding by polymerization at interfaces, whereby the structures are heated and force is applied on opposite sides to close the channel. But excessive force applied may damage the microstructures. Both reversible and irreversible bonding techniques exist for plastic-plastic and plastic-glass interfaces. One method of reversible sealing involves first thoroughly rinsing a PDMS substrate and a glass plate (or a second piece of PDMS) with methanol and bringing the surfaces into contact with one another prior to drying. The microstructure is then dried in an oven at 65° C. for 10 min. No clean room is required for this process. Irreversible sealing is accomplished by first thoroughly rinsing the pieces with methanol and then drying them separately with a nitrogen stream. The two pieces are then placed in an air plasma cleaner and oxidized at high power for about 45 seconds. The substrates are then brought into contact with each other and an irreversible seal forms spontaneously.

Other available techniques include laser and ultrasonic welding. In laser welding, polymers are joined together through laser-generated heat. Ultrasonic welding is another bonding technique that may be employed in some applications.

Examples of Non-Limiting Aspects of the Disclosure

Aspects, including embodiments, of the present subject matter described above may be beneficial alone or in combination, with one or more other aspects or embodiments. Without limiting the foregoing description, certain non-limiting aspects of the disclosure numbered 1-100 are provided below. As will be apparent to those of skill in the art upon reading this disclosure, each of the individually numbered aspects may be used or combined with any of the preceding or following individually numbered aspects. This is intended to provide support for all such combinations of aspects and is not limited to combinations of aspects explicitly provided below:

1. A method for generating monodispersed droplets, comprising:
flowing in a channel of a microfluidic device a first fluid into a second fluid under stable jetting conditions to provide a jet of the first fluid in the second fluid, wherein the first fluid is immiscible with the second fluid; and
introducing a plurality of particles into the jet of the first fluid triggering break-up of the jet of the first fluid and encapsulation of the plurality of particles in a plurality of monodispersed droplets of the first fluid in the second fluid.
2. The method of 1, wherein the plurality of particles is introduced into the jet of the first fluid in a disordered configuration.
3. The method of 1 or 2, wherein the plurality of particles comprises rigid particles.
4. The method of 1 or 3, wherein the plurality of particles is introduced into the jet of the first fluid in an ordered configuration.
5. The method of 4, wherein the plurality of particles is introduced into the jet of the first fluid in a packed configuration.
6. The method of any one of 1, 2, 4, and 5, wherein the plurality of particles comprise elastic particles.
7. The method of any one of 4-6, wherein the plurality of particles is ordered via inertial ordering.
8. The method of any one of 1-7, wherein the plurality of particles comprises a hydrogel.
9. The method of 8, wherein the hydrogel is selected from agarose, alginate, a polyethylene glycol (PEG), a polyacrylamide (PAA), and combinations thereof.
10. The method of any one of 1-9, wherein each droplet of the plurality of monodispersed droplets comprises one, and not more than one, particle.
11. The method of any one of 1-10, wherein the first fluid comprises an aqueous phase fluid.
12. The method of any one of 1-11, wherein the viscosity of the first fluid and the viscosity of the second fluid are within 100× of each other.
13. The method of 12, wherein the viscosity of the first fluid and the viscosity of the second fluid are within 50× of each other.
14. The method of 13, wherein the viscosity of the first fluid and the viscosity of the second fluid are within 10× of each other.
15. The method of 14, wherein the viscosity of the first fluid and the viscosity of the second fluid are within 5× of each other.
16. The method of any one of 1-15, wherein the second fluid comprises an oil.
17. The method of 16, wherein the oil comprises a fluorocarbon oil, a hydrocarbon oil, or a combination thereof.
18. The method of 17, wherein the oil comprises a fluorocarbon oil.
19. The method of any one of 1-18, comprising flowing a third fluid into the first fluid prior to flowing the first fluid into the second fluid, wherein the third fluid is miscible with the first fluid.
20. The method of any one of 1-19, wherein the first fluid or the third fluid comprises a polymerizable component.
21. The method of 20, comprising exposing the monodispersed droplets to conditions sufficient to polymerize the polymerizable component.
22. The method of any one of 19-21, wherein the third fluid comprises a plurality of cells.
23. The method of any one of 19-22, wherein the third fluid comprises one or more reagents.
24. The method of any one of 1-23, comprising merging one or more droplets with the jet prior to break-up of the jet.
25. The method of 24, wherein the one or more droplets comprise one or more cells.
26. The method of any one of 1-23, wherein the plurality of particles is encapsulated at a rate of 1 Hz to 100 kHz.
27. The method of 26, wherein the plurality of particles is encapsulated at a rate of >15,000/sec.
28. The method of 27, wherein the plurality of particles is encapsulated at a rate of >20,000/sec.
29. The method of any one of 1-28, comprising sorting the monodispersed droplets.
30. The method of 29, wherein the sorting is performed by size-based sorting, dielectrophoretic deflection, selective coalescence, fluorescence activated cell sorting (FACS), electrophoresis, acoustic separation, magnetic activated cell sorting (MACS), flow control, or other stimulus used to selectively deflect monodispersed droplets.
31. The method of any one of 1-30, wherein the particles are cells.
32. The method of any one of 1-30, wherein the particles are beads.
33. The method of any one of 1-3 and 6-32, wherein the plurality of particles is introduced into the jet of the first fluid in a disordered configuration, resulting in a polydispersed emulsion comprising a population of monodispersed-particle containing droplets, and wherein the method comprises sorting the monodispersed-particle containing droplets to separate them from other droplets in the polydispersed emulsion.
34. The method of 33, wherein the monodispersed-particle containing droplets are separated based on size.
35. The method of 34, wherein the first fluid comprises a polymer, and the sorting comprises filtering the monodispersed-particle containing droplets to separate them from other droplets in the polydispersed emulsion.
36. The method of 35, wherein the second fluid is removed prior to filtering.
37. A system for generating monodispersed droplets, comprising:
   a microfluidic device comprising a first channel, a second channel, a third channel and a fourth channel,
   wherein a first fluid is flowed from the first channel into the second channel through a junction of the first, second, third, and fourth channels, into a second fluid under stable jetting conditions to provide a jet of the first fluid in the second fluid,
   wherein the first fluid is immiscible with the second fluid,
   wherein the second fluid is introduced into the junction via the third and fourth channels, and
   wherein a plurality of particles is introduced into the jet of the first fluid thereby triggering break-up of the jet of the first fluid and encapsulation of the plurality of particles in a plurality of monodispersed droplets of the first fluid in the second fluid.
38. The system of 37, wherein the plurality of particles is introduced into the jet of the first fluid in a disordered configuration.
39. The system of 37 or 38, wherein the plurality of particles comprises rigid particles.
40. The system of 37 or 39, wherein the plurality of particles is introduced into the jet of the first fluid in an ordered configuration.
41. The system of 40, wherein the plurality of particles is introduced into the jet of the first fluid in a packed configuration.
42. The system of any one of 37, 38, 40 and 41, wherein the plurality of particles comprise elastic particles.
43. The system of any one of 40-42, wherein the plurality of particles is ordered via inertial ordering.
44. The system of any one of 37, wherein the plurality of particles comprises a hydrogel.
45. The system of 44, wherein the hydrogel is selected from agarose, alginate, a polyethylene glycol (PEG), a polyacrylamide (PAA), and combinations thereof.
46. The system of any one of 37-45, wherein each droplet of the plurality of monodispersed droplets comprises one, and not more than one, particle.
47. The system of any one of 37-46, wherein the first channel has a cross-sectional area that is within 10% of that of a particle of the plurality of particles.
48. The system of any one of 37-46, wherein the cross-sectional area of the second channel is greater than that of the first channel.
49. The system of any one of 37-48, wherein the first fluid comprises an aqueous phase fluid.
50. The system of any one of 34-49, wherein the viscosity of the first fluid and the viscosity of the second fluid are within 100× of each other.
51. The system of 50, wherein the viscosity of the first fluid and the viscosity of the second fluid are within 50× of each other.
52. The system of 51, wherein the viscosity of the first fluid and the viscosity of the second fluid are within 10× of each other.
53. The system of 52, wherein the viscosity of the first fluid and the viscosity of the second fluid are within 5× of each other.
54. The system of any one of 37-49, wherein the second fluid comprises an oil.
55. The system of 54, wherein the oil comprises a fluorocarbon oil, a hydrocarbon oil, or a combination thereof.
56. The system of 55, wherein the oil comprises a fluorocarbon oil.
57. The system of any one of 37-56, wherein the microfluidic device comprises a fifth channel and a sixth channel which form a junction with the first channel upstream of the junction of the first, second, third and fourth channels.
58. The system of 57, wherein a third fluid is flowed into the first fluid from the fifth and sixth channels prior to flowing the first fluid into the second fluid, wherein the third fluid is miscible with the first fluid.
59. The system of any one of 34-58, wherein the first fluid or the third fluid comprises a polymerizable component.
60. The system of 59, wherein the polymerizable component is polymerized.
61. The system of 57, wherein the third fluid comprises a plurality of cells.
62. The system of 56 or 57, wherein the third fluid comprises one or more reagents.
63. The system of any one of 37-62, wherein one or more droplets are merged with the jet prior to break-up of the jet.
64. The system of 63, wherein the one or more droplets comprise one or more cells.
65. The system of any one of 37-64, wherein the plurality of particles is encapsulated at a rate of 1 Hz to 100 kHz.
66. The system of 65, wherein the plurality of particles is encapsulated at a rate of >15,000/sec.
67. The system of 66, wherein the plurality of particles is encapsulated at a rate of >20,000/sec.
68. The system of any one of 37-67, wherein the monodispersed droplets are sorted.
69. The system of 68, wherein the sorting is performed by size-based sorting, dielectrophoretic deflection, selective coalescence, fluorescence activated cell sorting (FACS), electrophoresis, acoustic separation, magnetic activated cell sorting (MACS), flow control, or other stimulus used to selectively deflect monodispersed droplets.
70. The system of any one of 34-69, wherein the particles are cells.
71. The system of any one of 34-69, wherein the particles are beads.
72. The system of any one of 34-39 and 44-71, wherein the plurality of particles is introduced into the jet of the first fluid in a disordered configuration, resulting in a polydispersed emulsion comprising a population of monodispersed-particle containing droplets, and wherein the method comprises sorting the monodispersed-particle containing droplets to separate them from other droplets in the polydispersed emulsion.
73. The system of 72, wherein the monodispersed-particle containing droplets are separated based on size.
74. A method for merging reagents with particle-containing droplets, comprising:
   flowing in a channel of a microfluidic device a first fluid into a second fluid under stable jetting conditions to provide a jet of the first fluid in the second fluid, wherein the first fluid is immiscible with the second fluid and comprises one or more reagents;
   merging a plurality of particle-containing droplets into the jet of the first fluid triggering break-up of the jet of the first fluid and encapsulation of the plurality of particles in a plurality of merged monodispersed particle-containing droplets of the first fluid in the second fluid.
75. A method for merging reagents with droplets, comprising:
   flowing in a channel of a microfluidic device a first fluid into a second fluid under stable jetting conditions to provide a jet of the first fluid in the second fluid, wherein the first fluid comprises a plurality of particles, and wherein the first fluid is immiscible with the second fluid and comprises one or more reagents;
   merging a plurality of droplets into the first fluid either upstream or downstream of jet formation, wherein the plurality of particles triggers break-up of the jet of the first fluid and encapsulation of the plurality of particles in a plurality of monodispersed particle-containing droplets of the first fluid in the second fluid.
76. The method of 74, wherein the plurality of particle-containing droplets comprises rigid particles.
77. The method of 74, wherein the plurality of particle-containing droplets comprise elastic particles.
78. The method of any one of 74-76, wherein the plurality of particle-containing droplets comprises a hydrogel.
79. The method of 77, wherein the hydrogel is selected from agarose, alginate, a polyethylene glycol (PEG), a polyacrylamide (PAA), and combinations thereof.
80. The method of any one of 74-78, wherein each droplet of the plurality of merged monodispersed particle-containing droplets comprises one, and not more than one, particle.
81. The method of any one of 74, and 75-80, wherein the first fluid comprises an aqueous phase fluid.
82. The method of any one of 74, and 75-81, wherein the viscosity of the first fluid and the viscosity of the second fluid are within 100× of each other.
83. The method of 82, wherein the viscosity of the first fluid and the viscosity of the second fluid are within 50× of each other.
84. The method of 83, wherein the viscosity of the first fluid and the viscosity of the second fluid are within 10× of each other.
85. The method of 84, wherein the viscosity of the first fluid and the viscosity of the second fluid are within 5× of each other.
86. The method of any one of 74-85, wherein the second fluid comprises an oil.
87. The method of 86, wherein the oil comprises a fluorocarbon oil, a hydrocarbon oil, or a combination thereof.
88. The method of 87, wherein the oil comprises a fluorocarbon oil.
89. The method of any one of 74-87, comprising flowing a third fluid into the first fluid prior to flowing the first fluid into the second fluid, wherein the third fluid is miscible with the first fluid.
90. The method of any one of 74-89, wherein the first fluid or the third fluid comprises a polymerizable component.
91. The method of 90, comprising exposing the merged monodispersed particle-containing droplets to conditions sufficient to polymerize the polymerizable component.
92. The method of any one of 89-91, wherein the third fluid comprises a plurality of cells.
93. The method of any one of 89-92, wherein the third fluid comprises one or more reagents.
94. The method of any one of 74-93, wherein the plurality of merged monodispersed particle-containing droplets are formed at a rate of 1 Hz to 100 kHz.
95. The method of 94, wherein the plurality of the plurality of merged monodispersed particle-containing droplets are formed at a rate of >15,000/sec.
96. The method of 94, wherein the plurality of the plurality of merged monodispersed particle-containing droplets are formed at a rate of >20,000/sec.
97. The method of any one of 74-96, comprising sorting the monodispersed droplets.
98. The method of 97, wherein the sorting is performed by size-based sorting, dielectrophoretic deflection, selective coalescence, fluorescence activated cell sorting (FACS), electrophoresis, acoustic separation, magnetic activated cell sorting (MACS), flow control, or other stimulus used to selectively deflect monodispersed droplets.
99. The method of any one of 74-98, wherein the particles are cells.
100. The method of any one of 74-98, wherein the particles are beads.

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Celsius, and pressure is at or near atmospheric. Standard abbreviations may be used, e.g., bp, base pair(s); kb, kilobase(s); pl, picoliter(s); or sec, second(s); min, minute(s); h or hr, hour(s); aa, amino acid(s); kb, kilobase(s); bp, base pair(s); nt, nucleotide(s); i .m., intramuscular(ly); i .p., intrap eritoneal (1y); s.c., sub cutaneous(ly); and the like.

### Materials and Methods

The following materials and methods generally apply to the results presented in the Examples described herein except where noted otherwise.

Device fabrication

SU-8 2025 photoresist (MicroChem, Westborough, Mass., USA) was used to make master structures on a 3-inch silicon wafer using standard photolithography techniques. Curing agent and PDMS prepolymer (Momentive, Waterford, N.Y., USA; RTV 615) were mixed 1:10, degassed in a vacuum chamber, poured onto the master mold in a petri dish, further degassed until no bubbles were present, and baked at 65° C. for 4 hours. PDMS replicas were removed from the master, punched with a 0.75-mm biopsy punch (Ted Pella, Inc., Redding, Calif., USA; Harris Uni-Core 0.75), bonded to glass slides (75×50×1.0 mm, 12-550 C, Fisher Scientific) using a plasma bonder (Technics Plasma etcher), and placed at 150° C. for ten minutes to strengthen bonds. Devices were treated with Aquapel with a five-minute contact time and purged with air, rendering them hydrophobic. Devices were baked for at least 30 minutes to evaporate any remaining Aquapel.

### Rigid Bead Encapsulation

Rigid 20-40 μm beads made from hydroxylated methacrylic polymer (Toyopearl HW-65S, Tosoh Bioscience) were used to demonstrate the formation of monodispersed bead-containing droplets at limiting dilution. Beads were suspended in 68% OptiPrep Density Gradient Medium (Sigma-Aldrich), and co-flowed with 2% agarose (Ultra-low Gelling Temperature Agarose, Type IX-A, Sigma-Aldrich) in 1× PBS. The device, identical to one previously described in Macosko et al., was fabricated at a height of 100 μm. Flow rates were 2000 μl/hr for bead-containing solution, 2000 μl/hr for agarose, and 40,000 μl/hr for 2% ionic Krytox, prepared as previously described in DeJournette et al.

### Droplet Cytometry

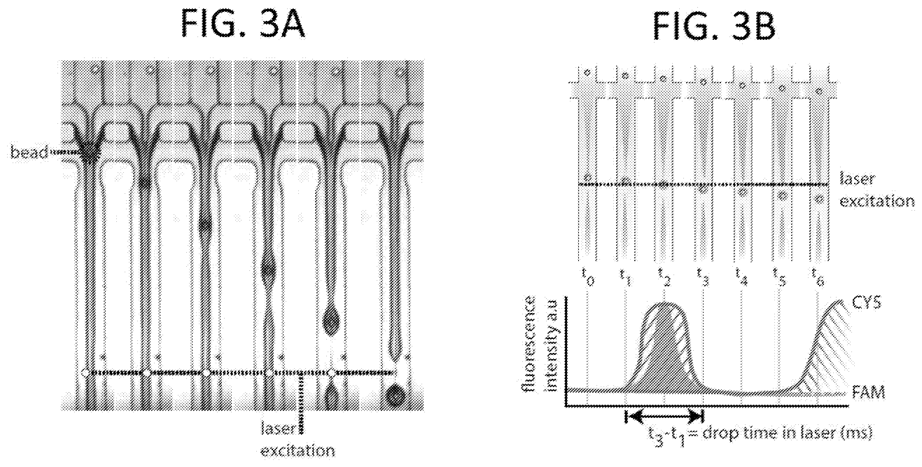

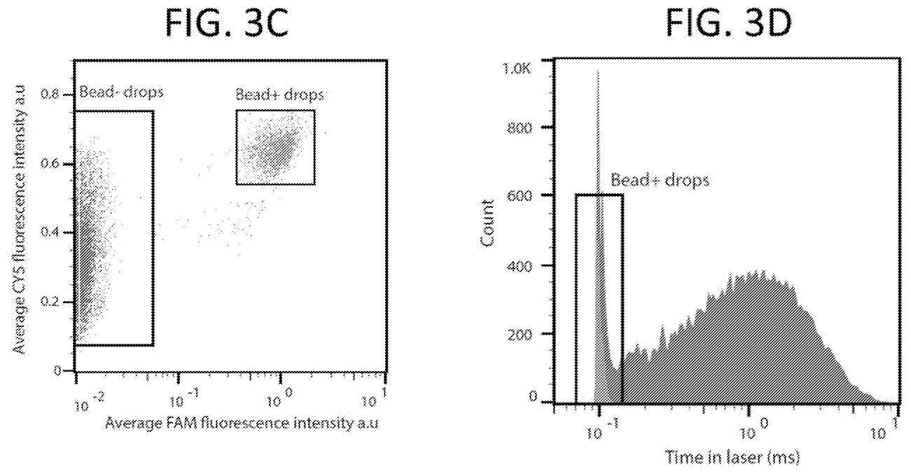

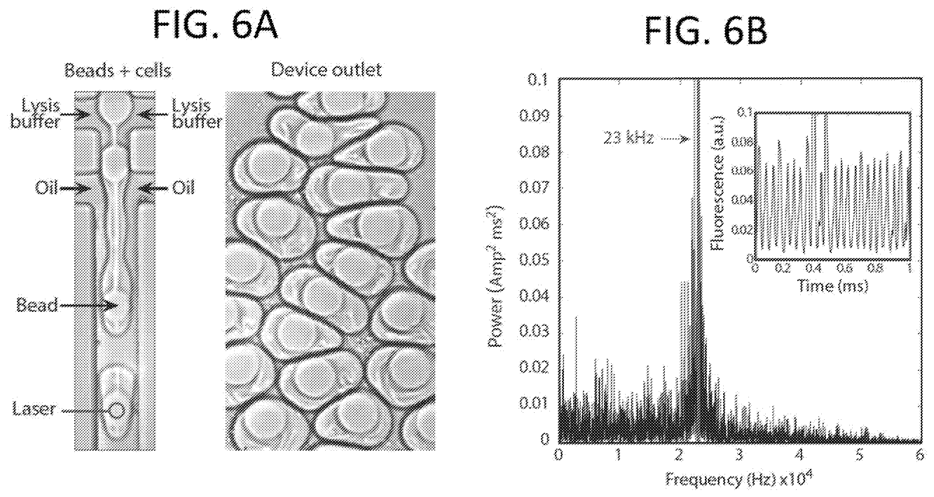

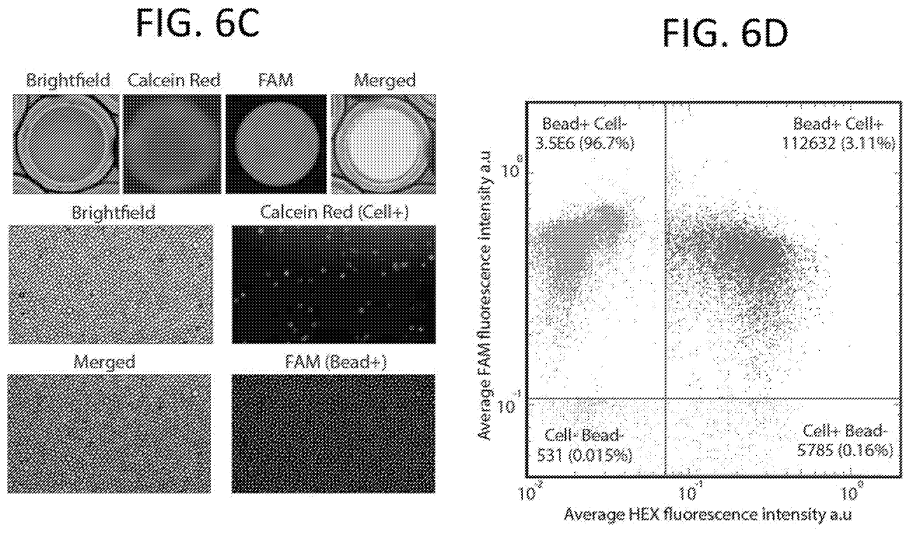

The custom microfluidic cytometer was designed as previously described in Mazutis et al. The system was equipped with three lasers (473 nm, 532 nm, 638 nm). EVA green (1×) stained Toyopearl HW-65S beads were detected with the 473 nm laser (FIGS. 3A-3D). BSA conjugated with Cy5 was used to measure drop size with the 638 nm laser (FIGS. 3A-3D). Calcein Red-Orange was used to detect cells with the 532 nm laser (FIGS. 6A-6D). Acrydited primers containing FAM were polymerized during droplet polyacrylamide formation and detected with the 473 nm laser (FIGS. 6A-6D). Drop fluorescence was calculated as the integral of peak intensity divided by the drop size. Drop length was measured as the time (ms) that a drop spends in the laser excitation window. Results were exported and analyzed in FlowJo.

### Hydrogel Synthesis

Elastic hydrogels for bead-packing experiments were made microfluidically using a bubble-trigger device as in Yan et al. A solution containing 8% Acrylamide with crosslinker (40% Acrylamide/Bis Solution, 19:1, Biorad), 200 mM TRIS pH 8.3, and 0.3% ammonium persulfate in water was used as the dispersed phase. The continuous phase consisted of 2% ionic krytox with 1% N,N,N′,N′-tetramethylethylenediamine (ThermoFisher). Solidification occurred for 1 hour at room temperature.

### Packed Bead Encapsulation

Prior to use, solidified polyacrylamide beads were filtered using a 70 μm cell strainer (Corning Falcon Cell Strainer) to remove large beads and prevent device clogging. Beads were packed in a syringe by centrifugation (Sorvall ST4OR) at 4700 rpm for 10 minutes using a custom 3D printed syringe adapter. Supernatant was removed and beads were injected onto microfluidic devices. Without intending to be bound by any particular theory, it is proposed that high speeds compressed beads and resulted in higher levels of bead jamming and bursting than under dripping conditions. This was improved using PE/5 tubing instead of PE/2 tubing (Scientific Commodities). In the dripping regime, the flow rate was 200 μl/hr for 1× PBS with 0.1% Tween, 200 μl/hr for packed polyacrylamide beads, and 600 μl/hr for oil. In the jetting regime, the flow rate was 4000 μl/hr for 1× PBS with 0.1%Tween, 4000 μl/hr for packed polyacrylamide beads and 6000 μl/hr for oil. For packed bead encapsulation without a co-flow, varying flow rates of beads and oil were used. Capillary number was calculated using the continuous phase flow rate, viscosity of the continuous phase (HFE-7500, 1.24×10⁻³ kg m⁻¹s⁻¹) and interfacial tension (4 mN m⁻¹), assuming a square channel cross-section of 55 μm by 55 μm.

### Cell-Bead Pairing

Cells were stained using Calcein (25 μM Calcein Red-Orange, AM, C34851, ThermoFisher) in 1× PBS, and incubated on ice for 30 min. Cells were washed twice (HBSS, no calcium, no magnesium, 14170112, ThermoFisher) and re-suspended in 18% OptiPrep Density Gradient Medium (Sigma-Aldrich) in HBSS. Polyacrylamide beads were polymerized with 10 μM Acyridited oligonucleotides (IDT) containing a FAM labeled 3′ end. The flow rate was 4000 μl/hr for 45 μm beads, 4000 μl/hr for lysis buffer (0.1% LiDS, 1 mM EDTA, 20 mM TRIS 8.3, 500 mM LiC1), and 8000 μl/hr for oil (Biorad Droplet Generation Oil for EvaGreen #1864005). To quickly find conditions to generate monodispersed bead-triggered drops, a jet was formed in the absence of beads. Drops were collected into a 10 mL syringe for later re-injection and detection. To calculate the speed of drop generation, timetrace data of fluorescence intensity was collected for flowing droplets and analyzed in Matlab using the fast fourier transform (fft) function. The power spectrum was calculated as the square of the absolute value of fft divided by the number of samples.

### Example 1: Droplet Generation in the Dripping and Letting Flow Regimes Using Bead-Triggering

### Results

Water and oil co-flowed in a hydrophobic microfluidic channel produced water-in-oil droplets in a Capillary number (Ca) dependent manner. Such devices formed droplets in different regimes. In the absence of a perturbation, the jet remained stable and drops were not formed in the main channel (FIG. 2B). Introduction of a bead caused an internal perturbation that triggered jet breakup, and drop formation (FIGS. 2C-2E). At low Ca, drops formed through a quasistatic plugging and squeezing mechanism, while at moderate Ca, shearing of the continuous phase against the droplet phase became important (FIG. 2A). In particular, FIG. 2A depicts drop formation in the dripping regime without beads. At higher Ca, the dispersed phase flowed as a stable jet without breaking up. Specifically, FIG. 2B depicts stable jet formation at high Capillary number without beads. If cells, particles, or beads were introduced into the jet, they could seed Rayleigh-Plateau instabilities, breaking it into drops (FIG. 2C); however, since these discrete entities were dispersed randomly in the droplet phase, the breakup was irregular, yielding a polydispersed emulsion. In particular, FIG. 2C depicts drop formation using unpacked rigid beads at limiting dilution to trigger breakup of the dispersed phase. To produce a monodispersed emulsion, uniformly periodic perturbations were applied to the jet, which could be achieved by introducing air bubbles. This concept was extended to packed elastic beads which, like air bubbles, flowed with regular periodicity, and thus broke the jet into monodispersed drops containing single beads (FIG. 2D). Specifically, FIG. 2D depicts drop formation using packed beads to trigger breakup without additional co-flow. Additional aqueous solutions could be introduced via side channels to independently adjust droplet volume in the triggering regime (FIG. 2E). In particular, FIG. 2E depicts drop formation using packed beads to trigger breakup of a co-flowed dispersed phase.

### Example 2: Formation of Monodispersed Bead-Containing Droplets in a Polydispersed Emulsion

### Results

For rigid beads that could not be packed due to clogging, the sample was diluted, yielding less than 1 in 10 drops containing a bead. When paired with diluted cells, less than 1 in 100 drops contained a bead-cell pair, making the process wasteful and limiting overall throughput since all the empty drops must still be produced. Bead-triggering ran the device under jetting conditions, increasing throughput by ten-fold. To demonstrate this, a stable jet was formed by co-flowing 2% agarose and 1× PBS containing rigid beads (Toyopearl HW-65S). The jet, unperturbed, did not breakup in the channel (FIG. 3A). The rigid bead disrupted the streamlines within the jet, perturbing the oil-water interface, and seeding a Rayleigh-Plateau instability that breaks the jet (FIG. 3A). In particular, FIG. 3A depicts frames from a video of device operation depicting stable jet formation and bead-induced jet breakup. For jets of similar state, the breakup process was reproducible, yielding drops that were substantially larger than the particles, and uniform. The resultant emulsion consisted of large polydispersed empty drops, and a second population of small monodispersed bead-containing drops.

To characterize the efficiency and uniformity of bead-triggered droplets, a laser-induced fluorescence was used to accumulate statistics on thousands of bead-encapsulation events. Hydroxylated methacrylic polymer beads (Toyopearl HW-65S) stained with Eva Green and visible on the FAM channel were co-flowed with an aqueous solution containing BSA conjugated CY5. Drops traveled through a laser to excite the dyes (FIG. 3B). In particular, FIG. 3B depicts a cartoon representation of the experimental setup used to measure drop size and the presence of bead containing drops. Drop size was calculated as the time a drop spends in the excitation window (t₃-t₁). Emitted light passed through a series of filters and was collected using photomultiplier tubes. Timetraces of fluorescent intensity were collected, drops were detected by the presence of a peak, and the average peak fluorescence was determined for each channel. This allowed us to determine which drops contained a bead (FIG. 3C). Droplet cytometry analysis of drop formation identified empty drops and drops containing beads. The time that a drop spent flowing through the laser was proportional to its length, providing a measure drop size distributions during bead-triggering. Bead containing drops showed a tight size distribution and were smaller than drops resulting from random un-triggered breakup of the jet, as depicted in the histogram of drop size in FIG. 3D. Blue represented bead-containing drops identified in FIG. 3C. Red represented non-bead containing drops identified in FIG. 3C. The results in FIG. 3D demonstrated that while the overall emulsion was polydispersed, a monodispersed population of droplets containing beads was generated. These droplets could potentially be recovered by filtration or flow fractionation.

An additional benefit of jet triggering was that it created drop sizes that were smaller than the nozzle, and therefore smaller than could be produced in a normal dripping regime. This prevented clogging of the device, which was especially important when using rigid beads that easily clogged channels. Without intending to be bound by any particular theory, it is proposed that generating monodispersed bead-containing drops within a polydispersed emulsion means that biochemical reactions involving beads remain uniform with respect to reagents and products. For single-device workflows, bead-triggered drop formation was therefore equivalent to operating in the dripping regime, with at least the added benefit of increased speed.

### Example 3: High Throughput Encapsulation of Packed Elastic Beads

### Results

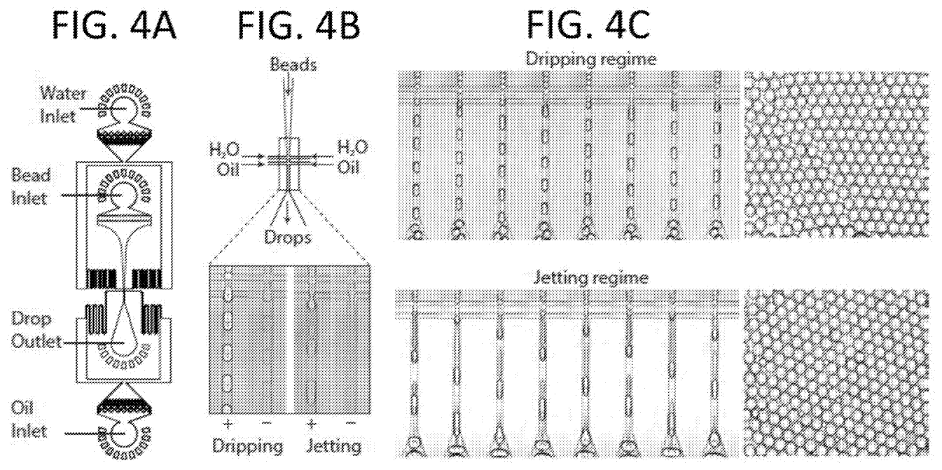

To generate a monodispersed emulsion of bead-containing drops, elastic beads were packed as described in Abate et al. This allowed beads to be injected at regular intervals, preventing uneven spacing between beads, which would result in empty drops. During packed bead loading in a dripping regime, droplet generation occurred independently of the presence of a bead (FIG. 4B). Single bead-per-drop loading was achieved by tuning flow rates to synchronize bead injection with drop formation (FIG. 4B). As a result, the loading of elastic microspheres was limited by the ability to operate in a dripping regime, which constrained the throughput of bead-based workflows. Combining bead packing with jet triggering exploited periodic bead injection to trigger regular jet breakup and monodispersed droplet formation.

Co-flowing an additional aqueous allowed for reagent addition and independent control of drop size, as shown in the device schematic with fluid inlets and outlets in FIG. 4A. Without intending to be bound by any particular theory, it is proposed that co-flowing may be important in cases where bulk addition of reagents was not experimentally feasible. For example, cells and lysis buffer, enzymes and their substrates, and components of chemical reactions may be co-flowed on-chip to prevent mixing outside of droplets. FIG. 4B shows device operation in the dripping and jetting regimes with and without beads. In the absence of a bead, the aqueous co-flow formed a stable jet that does not break in the microfluidic channel. Introduction of the bead induced drop formation (FIG. 4B). High-speed video frames captured the elongation of the fluid jet and subsequent bead-dependent drop formation (FIG. 4C, bottom). Operation in this regime produced bead-containing drops of similar percent loading and size uniformity to a typical dripping regime (FIG. 4C). In particular, FIG. 4C depicts frames from a video of device operation in the dripping (top) and jetting (bottom) regimes. The resultant emulsions are shown to the right of the time lapse images.

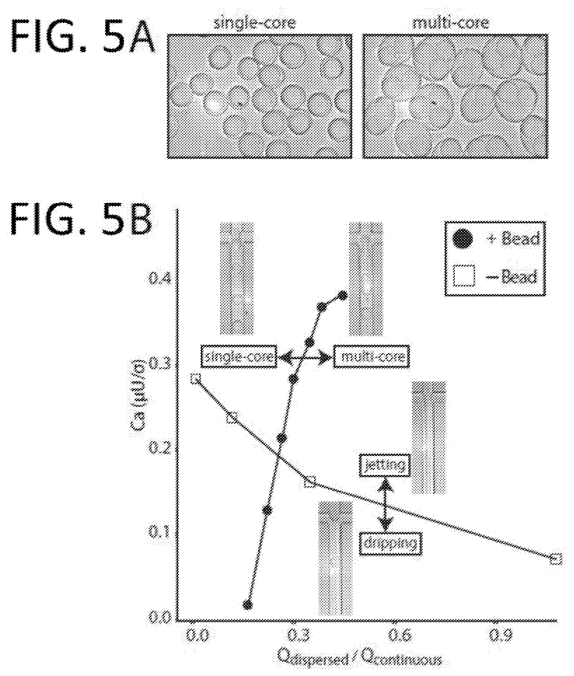

If the beads were hydrogels, reagents could be soaked into pores and an aqueous co-flow was not necessary. In this case, bead-triggering occurred even without co-flow, but was difficult to visualize because packing removed excess aqueous phase and no jet forms. The dispersed phase was made entirely of beads with interstitial fluid. In this scenario, packed beads triggered drop formation and the flow rate could be increased well into a typical aqueous jetting regime. The point at which a dispersed water phase transitioned from dripping into jetting was compared to the point at which tightly packed beads transitioned from single into multi-core drops. FIG. 5A depicts microscope images of single-bead and multi-bead containing drops. Compared to non-bead droplet generation, bead-triggering operated efficiently at higher Capillary numbers, and high dispersed phase flow rates (6000 μl/hr) (FIG. 5B). In particular, FIG. 5B depicts phase diagram of the transition from single- to multi-bead drops as a function of Capillary number and flow rate ratio. Images of devices show operation in particular regions.

### Example 4: Bead-Cell Pairing Above 1 kHz

### Results

Producing millions of bead-containing drops is slow when operating in the dripping regime. A utility of bead-triggered drop formation is that it enables an increase in throughput with minimal reduction in emulsion quality. Such a theory was demonstrated by encapsulating 45 μm polyacrylamide beads in monodispersed droplets at high speeds. The drop maker was run with the two aqueous streams at 4000 μl/hr each and the oil at 8000 μl/hr, corresponding to a predicted encapsulation frequency of approximately 23 kHz (FIG. 6A). In particular, FIG. 6A depicts the device operation and the resultant droplets in the outlet. To measure the frequency of drop making, the fluorescent time trace data of flowing droplets was recorded (FIG. 6B, inset) and the power spectrum of the intensity was computed (FIG. 6B). The peak of this spectrum agreed with the estimates of drop-making frequency based on flow rate and demonstrates an order of magnitude increase in throughput compared to running in the dripping regime. Bead-triggering generated monodispersed droplets at more than 20 kHz, allowing for rapid generation of bead-containing droplets.

Cells were paired with beads at high speed. Cells were diluted to achieve one cell per 20 drops and these cells were paired with beads at 23 kHz, easily achieving 1 kHz pairing. This allowed pairing of 100,000 cells with single beads in minutes, or 10 million cells in several hours. Cells were stained with Calcein Red and beads were polymerized with a fluorescent oligonucleotide so that each could be detected on the FAM and HEX channels, respectively (FIG. 6C). FIG. 6C depicts fluorescence microscopy of FAM-stained beads and Calcein Red cells demonstrated bead loading and cell-bead pairing. Upon on-chip mixing with lysis buffer, cells released the Calcein Red dye and the entire drop became fluorescent. Analysis of drop fluorescence using microscopy demonstrated the precise loading of one-bead per drop, as well as pairing of cells with beads (FIG. 6C). To accurately measure the throughput of this approach, millions of bead-containing droplets and hundreds of thousands of bead-cell pairings were analyzed using a droplet cytometer. In the 3.5 million drops analyzed, 99.8% contained a fluorescent bead, and 3.1% contain a bead-cell pair, close to the 5% cell loading predicted based on the cell concentration used. These results demonstrate that bead-triggered encapsulation and pairing functioned with a speed and accuracy capable of processing millions of cells.

The methods described herein provided a mechanism to pair 10⁵ Human T cells with polyacrylamide beads ten times faster than methods operating in the dripping regime. Such methods improved the throughput of bead-based droplet workflows, and enabled the analysis of large populations and detection of rare events.

### Example 5: High-Speed Bead Coating

### Results

It is often important to coat beads with hydrogel, which allows for subsequent bead packing, capture of genomes, etc. Agarose-coated particles were generated within a population of large agarose drops (FIG. 7). Using bead-triggering, beads were easily coated with a uniform shell. Rigid beads were coated with hydrogel and separated by size. Non-bead containing drops were large (or could be made small) and filtered based on size (FIG. 7).

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

### REFERENCES

1. E. Z. Macosko, A. Basu, R. Satija, J. Nemesh, K. Shekhar, M. Goldman, I. Tirosh, A. R. Bialas, N. Kamitaki, E. M. Marter-steck, J. J. Trombetta, D. A. Weitz, J. R. Sanes, A. K. Shalek, A. Regev and S. A. McCarroll, Cell, 2015, 161, 1202-1214.
2. D. Dressman, H. Yan, G. Traverso, K. W. Kinzler and B. Vo-gelstein, Proceedings of the National Academy of Sciences of the United States of America, 2003, 100, 8817-8822.
3. A. Sepp, D. S. Tawfik and A. D. Griffiths, FEBS letters, 2002, 532, 455-458.
4. R. Novak, Y. Zeng, J. Shuga, G. Venugopalan, D. A. Fletcher, M. T. Smith and R. A.

Mathies, Angewandte Chemie, 2010, 123, 410-415.
5. A. M. Klein, L. Mazutis, I. Akartuna, N. Tallapragada, A. Veres, V. Li, L. Peshkin, D. A. Weitz and M. W. Kirschner, Cell, 2015, 161, 1187-1201.
6. H. Zhang, G. Jenkins, Y. Zou, Z. Zhu and C. J. Yang, Analytical Chemistry, 2012, 84, 3599-3606.
7. F. Diehl, M. Li, Y. He, K. W. Kinzler, B. Vogelstein and D. Dress-man, Nature Methods, 2006, 3, 551-559.
8. E. Borgström, D. Redin, S. Lundin, E. Berglund, A. F. An-dersson and A. Ahmadian, Nature Communications, 2015, 6, 7173.
9. L. Mazutis, J. Gilbert, W. L. Ung, D. A. Weitz, A. D. Griffiths and J. A. Heyman, Nature Protocols, 2013, 8, 870-891.
10. T. Konry, M. Dominguez-Villar, C. Baecher-Allan, D. A. Hafler and M. L. Yarmush, Biosensors and Bioelectronics, 2011, 26, 2707-2710.
11. V. Chokkalingam, J. Tel, F. Wimmers, X. Liu, S. Semenov, J. Thiele, C. G. Figdor and W. T. S. Huck, Lab on a Chip, 2013, 13, 4740-4744.
12. S. J. Spencer, M. V. Tamminen, S. P. Preheim, M. T. Guo, A. W. Briggs, I. L. Brito, D. A Weitz, L. K. Pitkanen, F. Vigneault, M. P. Juhani Virta and E. J. Alm, The ISME journal, 2016, 10, 427-436.
13. F. Lan, J. R. Haliburton, A. Yuan and A. R. Abate, Nature Com-munications, 2016, 7, 11784.
14. A. R. Abate, C.-H. Chen, J. J. Agresti and D. A. Weitz, Lab on a Chip, 2009, 9, 2628-2631.
15. M. Chabert and J. L. Viovy, Proceedings of the National Academy of Sciences of the United States of America, 2008, 105, 3191-3196.
16. I. Cohen, H. Li, J. L. Hougland, M. Mrksich and S. R. Nagel, Science, 2001, 292, 265-267.
17. A. R. Abate and D. A. Weitz, Lab on a Chip, 2011, 11, 1713-1716.
18. Z. Yan, I. C. Clark and A. R. Abate, Macromolecular Chemistry and Physics, 2016, 218, 1600297.
19. C. J. DeJournette, J. Kim, H. Medlen, X. Li, L. J. Vincent and C. J. Easley, Analytical Chemistry, 2013, 85, 10556-10564.
20. J. F. Edd, D. Di Carlo, K. J. Humphry, S. Koster, D. Irimia, D. A. Weitz, and M. Toner. (2008) Controlled encapsulation of single-cells into monodisperse picolitre drops. Lab Chip 8: 1262-1264.
21. S. C. Hur, H. T. K. Tse, and D. Di Carlo. (2010) Sheathless inertial cell ordering for extreme throughput flow cytometry. Lab Chip 10: 274-280.
22. A. S. Utada, A. Fernandez-Nieves, H. A. Stone, and D. A. Weitz. (2007) Dripping to jetting transitions in coflowing liquid streams. Phys Rev Lett 99: 094502

What is claimed is:

1. A method for generating monodispersed droplets, comprising:
flowing in a channel of a microfluidic device a first fluid into a second fluid under stable jetting conditions to provide a jet of the first fluid in the second fluid, wherein the first fluid is immiscible with the second fluid; and
introducing a plurality of particles into the jet of the first fluid triggering break-up of the jet of the first fluid and encapsulation of the plurality of particles in a plurality of monodispersed droplets of the first fluid in the second fluid.

2. The method of claim 1, wherein the plurality of particles is introduced into the jet of the first fluid in a disordered configuration.

3. The method of claim 1 or 2, wherein the plurality of particles comprises rigid particles.

4. The method of claim 1 or 3, wherein the plurality of particles is introduced into the jet of the first fluid in an ordered configuration.

5. The method of claim 4, wherein the plurality of particles is introduced into the jet of the first fluid in a packed configuration.

6. The method of any one of claims 1, 2, 4, and 5, wherein the plurality of particles comprise elastic particles.

7. The method of any one of claims 4-6, wherein the plurality of particles is ordered via inertial ordering.

8. The method of any one of claims 1-7, wherein the plurality of particles comprises a hydrogel.

9. The method of claim 8, wherein the hydrogel is selected from agarose, alginate, a polyethylene glycol (PEG), a polyacrylamide (PAA), and combinations thereof.

10. The method of any one of claims 1-9, wherein each droplet of the plurality of monodispersed droplets comprises one, and not more than one, particle.

11. The method of any one of claims 1-10, wherein the first fluid comprises an aqueous phase fluid.

12. The method of any one of claims 1-11, wherein the viscosity of the first fluid and the viscosity of the second fluid are within 100× of each other.

13. The method of claim 12, wherein the viscosity of the first fluid and the viscosity of the second fluid are within 50× of each other.

14. The method of claim 13, wherein the viscosity of the first fluid and the viscosity of the second fluid are within 10× of each other.

15. The method of claim 14, wherein the viscosity of the first fluid and the viscosity of the second fluid are within 5× of each other.

16. The method of any one of claims 1-15, wherein the second fluid comprises an oil.

17. The method of claim 16, wherein the oil comprises a fluorocarbon oil, a hydrocarbon oil, or a combination thereof.

18. The method of claim 17, wherein the oil comprises a fluorocarbon oil.

19. The method of any one of claims 1-18, comprising flowing a third fluid into the first fluid prior to flowing the first fluid into the second fluid, wherein the third fluid is miscible with the first fluid.

20. The method of any one of claims 1-19, wherein the first fluid or the third fluid comprises a polymerizable component.

21. The method of claim 20, comprising exposing the monodispersed droplets to conditions sufficient to polymerize the polymerizable component.

22. The method of any one of claims 19-21, wherein the third fluid comprises a plurality of cells.

23. The method of any one of claim 19-22, wherein the third fluid comprises one or more reagents.

24. The method of any one of claims 1-23, comprising merging one or more droplets with the jet prior to break-up of the jet.

25. The method of claim 24, wherein the one or more droplets comprise one or more cells.

26. The method of any one of claims 1-23, wherein the plurality of particles is encapsulated at a rate of 1 Hz to 100 kHz.

27. The method of claim 26, wherein the plurality of particles is encapsulated at a rate of >15,000/sec.

28. The method of claim 27, wherein the plurality of particles is encapsulated at a rate of >20,000/sec.

29. The method of any one of claims 1-28, comprising sorting the monodispersed droplets.

30. The method of claim 29, wherein the sorting is performed by size-based sorting, dielectrophoretic deflection, selective coalescence, fluorescence activated cell sorting (FACS), electrophoresis, acoustic separation, magnetic activated cell sorting (MACS), flow control, or other stimulus used to selectively deflect monodispersed droplets.

31. The method of any one of claims 1-30, wherein the particles are cells.

32. The method of any one of claims 1-30, wherein the particles are beads.

33. The method of any one of claims 1-3 and 6-32, wherein the plurality of particles is introduced into the jet of the first fluid in a disordered configuration, resulting in a polydispersed emulsion comprising a population of monodispersed-particle containing droplets, and wherein the method comprises sorting the monodispersed-particle containing droplets to separate them from other droplets in the polydispersed emulsion.

34. The method of claim 33, wherein the monodispersed-particle containing droplets are separated based on size.

35. The method of claim 34, wherein the first fluid comprises a polymer, and the sorting comprises filtering the monodispersed-particle containing droplets to separate them from other droplets in the polydispersed emulsion.

36. The method of claim 35, wherein the second fluid is removed prior to filtering.

37. A system for generating monodispersed droplets, comprising:
a microfluidic device comprising a first channel, a second channel, a third channel and a fourth channel,
wherein a first fluid is flowed from the first channel into the second channel through a junction of the first, second, third, and fourth channels, into a second fluid under stable jetting conditions to provide a jet of the first fluid in the second fluid,
wherein the first fluid is immiscible with the second fluid,
wherein the second fluid is introduced into the junction via the third and fourth channels, and
wherein a plurality of particles is introduced into the jet of the first fluid thereby triggering break-up of the jet of the first fluid and encapsulation of the plurality of particles in a plurality of monodispersed droplets of the first fluid in the second fluid.

38. The system of claim 37, wherein the plurality of particles is introduced into the jet of the first fluid in a disordered configuration.

39. The system of claim 37 or 38, wherein the plurality of particles comprises rigid particles.

40. The system of claim 37 or 39, wherein the plurality of particles is introduced into the jet of the first fluid in an ordered configuration.

41. The system of claim 40, wherein the plurality of particles is introduced into the jet of the first fluid in a packed configuration.

42. The system of any one of claims 37, 38, 40 and 41, wherein the plurality of particles comprise elastic particles.

43. The system of any one of claims 40-42, wherein the plurality of particles is ordered via inertial ordering.

44. The system of any one of claims 37, wherein the plurality of particles comprises a hydrogel.

45. The system of claim 44, wherein the hydrogel is selected from agarose, alginate, a polyethylene glycol (PEG), a polyacrylamide (PAA), and combinations thereof.

46. The system of any one of claims 37-45, wherein each droplet of the plurality of monodispersed droplets comprises one, and not more than one, particle.

47. The system of any one of claims 37-46, wherein the first channel has a cross-sectional area that is within 10% of that of a particle of the plurality of particles.

48. The system of any one of claims 37-46, wherein the cross-sectional area of the second channel is greater than that of the first channel.

49. The system of any one of claims 37-48, wherein the first fluid comprises an aqueous phase fluid.

50. The system of any one of claims 34-49, wherein the viscosity of the first fluid and the viscosity of the second fluid are within 100× of each other.

51. The system of claim 50, wherein the viscosity of the first fluid and the viscosity of the second fluid are within 50× of each other.

52. The system of claim 51, wherein the viscosity of the first fluid and the viscosity of the second fluid are within 10× of each other.

53. The system of claim 52, wherein the viscosity of the first fluid and the viscosity of the second fluid are within 5× of each other.

54. The system of any one of claims 37-49, wherein the second fluid comprises an oil.

55. The system of claim 54, wherein the oil comprises a fluorocarbon oil, a hydrocarbon oil, or a combination thereof.

56. The system of claim 55, wherein the oil comprises a fluorocarbon oil.

57. The system of any one of claims 37-56, wherein the microfluidic device comprises a fifth channel and a sixth channel which form a junction with the first channel upstream of the junction of the first, second, third and fourth channels.

58. The system of claim 57, wherein a third fluid is flowed into the first fluid from the fifth and sixth channels prior to flowing the first fluid into the second fluid, wherein the third fluid is miscible with the first fluid.

59. The system of any one of claims 34-58, wherein the first fluid or the third fluid comprises a polymerizable component.

60. The system of claim 59, wherein the polymerizable component is polymerized.

61. The system of claim 57, wherein the third fluid comprises a plurality of cells.

62. The system of claim 56 or 57, wherein the third fluid comprises one or more reagents.

63. The system of any one of claims 37-62, wherein one or more droplets are merged with the jet prior to break-up of the jet.

64. The system of claim 63, wherein the one or more droplets comprise one or more cells.

65. The system of any one of claims 37-64, wherein the plurality of particles is encapsulated at a rate of 1 Hz to 100 kHz.

66. The system of claim 65, wherein the plurality of particles is encapsulated at a rate of >15,000/sec.

67. The system of claim 66, wherein the plurality of particles is encapsulated at a rate of >20,000/sec.

68. The system of any one of claims 37-67, wherein the monodispersed droplets are sorted.

69. The system of claim 68, wherein the sorting is performed by size-based sorting, dielectrophoretic deflection, selective coalescence, fluorescence activated cell sorting (FACS), electrophoresis, acoustic separation, magnetic activated cell sorting (MACS), flow control, or other stimulus used to selectively deflect monodispersed droplets.

70. The system of any one of claims 34-69, wherein the particles are cells.

71. The system of any one of claims 34-69, wherein the particles are beads.

72. The system of any one of claims 34-39 and 44-71, wherein the plurality of particles is introduced into the jet of the first fluid in a disordered configuration, resulting in a polydispersed emulsion comprising a population of monodispersed-particle containing droplets, and wherein the method comprises sorting the monodispersed-particle containing droplets to separate them from other droplets in the polydispersed emulsion.

73. The system of claim 72, wherein the monodispersed-particle containing droplets are separated based on size.

74. A method for merging reagents with particle-containing droplets, comprising:
flowing in a channel of a microfluidic device a first fluid into a second fluid under stable jetting conditions to provide a jet of the first fluid in the second fluid, wherein the first fluid is immiscible with the second fluid and comprises one or more reagents;
merging a plurality of particle-containing droplets into the jet of the first fluid triggering break-up of the jet of the first fluid and encapsulation of the plurality of particles in a plurality of merged monodispersed particle-containing droplets of the first fluid in the second fluid.

75. A method for merging reagents with droplets, comprising:
flowing in a channel of a microfluidic device a first fluid into a second fluid under stable jetting conditions to provide a jet of the first fluid in the second fluid, wherein the first fluid comprises a plurality of particles, and wherein the first fluid is immiscible with the second fluid and comprises one or more reagents;
merging a plurality of droplets into the first fluid either upstream or downstream of jet formation, wherein the plurality of particles triggers break-up of the jet of the first fluid and encapsulation of the plurality of particles in a plurality of monodispersed particle-containing droplets of the first fluid in the second fluid.

76. The method of claim 74, wherein the plurality of particle-containing droplets comprises rigid particles.

77. The method of claim 74, wherein the plurality of particle-containing droplets comprise elastic particles.

78. The method of any one of claims 74-76, wherein the plurality of particle-containing droplets comprises a hydrogel.

79. The method of claim 77, wherein the hydrogel is selected from agarose, alginate, a polyethylene glycol (PEG), a polyacrylamide (PAA), and combinations thereof.

80. The method of any one of claims 74-78, wherein each droplet of the plurality of merged monodispersed particle-containing droplets comprises one, and not more than one, particle.

81. The method of any one of claims 74, and 75-80, wherein the first fluid comprises an aqueous phase fluid.

82. The method of any one of claims 74, and 75-81, wherein the viscosity of the first fluid and the viscosity of the second fluid are within 100× of each other.

83. The method of claim 82, wherein the viscosity of the first fluid and the viscosity of the second fluid are within 50× of each other.

84. The method of claim 83, wherein the viscosity of the first fluid and the viscosity of the second fluid are within 10× of each other.

85. The method of claim 84, wherein the viscosity of the first fluid and the viscosity of the second fluid are within 5× of each other.

86. The method of any one of claims 74-85, wherein the second fluid comprises an oil.

87. The method of claim 86, wherein the oil comprises a fluorocarbon oil, a hydrocarbon oil, or a combination thereof.

88. The method of claim 87, wherein the oil comprises a fluorocarbon oil.

89. The method of any one of claims 74-87, comprising flowing a third fluid into the first fluid prior to flowing the first fluid into the second fluid, wherein the third fluid is miscible with the first fluid.

90. The method of any one of claims 74-89, wherein the first fluid or the third fluid comprises a polymerizable component.

91. The method of claim 90, comprising exposing the merged monodispersed particle-containing droplets to conditions sufficient to polymerize the polymerizable component.

92. The method of claim any one of claims 89-91, wherein the third fluid comprises a plurality of cells.

93. The method of claim any one of claims 89-92, wherein the third fluid comprises one or more reagents.

94. The method of any one of claims 74-93, wherein the plurality of merged monodispersed particle-containing droplets are formed at a rate of 1 Hz to 100 kHz.

95. The method of claim 94, wherein the plurality of the plurality of merged monodispersed particle-containing droplets are formed at a rate of >15,000/sec.

96. The method of claim 94, wherein the plurality of the plurality of merged monodispersed particle-containing droplets are formed at a rate of >20,000/sec.

97. The method of any one of claims 74-96, comprising sorting the monodispersed droplets.

98. The method of claim 97, wherein the sorting is performed by size-based sorting, dielectrophoretic deflection, selective coalescence, fluorescence activated cell sorting (FACS), electrophoresis, acoustic separation, magnetic activated cell sorting (MACS), flow control, or other stimulus used to selectively deflect monodispersed droplets.

99. The method of any one of claims 74-98, wherein the particles are cells.

100. The method of any one of claims 74-98, wherein the particles are beads.
